(19) United States
(12) Patent Application Publication
(10) Pub. No.: US 2025/0294174 A1
(43) Pub. Date: Sep. 18, 2025

(54) ENCODING METHOD, DECODING METHOD AND STORAGE MEDIUM

(71) Applicant: GUANGDONG OPPO MOBILE TELECOMMUNICATIONS CORP., LTD., Dongguan (CN)

(72) Inventors: Junyan Huo, Dongguan (CN); Yanzhuo Ma, Dongguan (CN); Fuzheng Yang, Dongguan (CN); Xue Hao, Dongguan (CN); Ming Li, Dongguan (CN)

(73) Assignee: GUANGDONG OPPO MOBILE TELECOMMUNICATIONS CORP., LTD., Dongguan (CN)

(21) Appl. No.: 19/227,234

(22) Filed: Jun. 3, 2025

Related U.S. Application Data
(63) Continuation of application No. PCT/CN2022/138223, filed on Dec. 9, 2022.

(51) Int. Cl. H04N 19/176; H04N 19/11; H04N 19/159; H04N 19/52

(52) U.S. Cl. CPC H04N 19/176; H04N 19/11; H04N 19/159; H04N 19/52

(57) ABSTRACT

Disclosed in the embodiments of the present application are an encoding method, a decoding method and a storage medium. The decoding method includes: determining a first color component block of the current block; when a prediction mode of the first color component block meets a first condition, determining a target block vector parameter of the current block, and determining a target symmetric relation according to the target block vector parameter of the current block; performing prediction processing on a second color component of the current block according to the target block vector parameter, so as to determine a predicted value of the second color component of the current block; and determining a reconstructed value of the second color component of the current block according to the predicted value of the second color component of the current block and the target symmetric relation.

### CROSS-REFERENCE TO RELATED APPLICATION

The present application is a continuation of International Application No. PCT/CN2022/138223 filed on Dec. 9, 2022, the disclosure of which is hereby incorporated by reference in its entirety.

### TECHNICAL FIELD

The disclosure relates to the technical field of video encoding and decoding, and in particular to an encoding method, a decoding method and a storage medium.

### BACKGROUND

As people's requirements on display quality of videos increase, new video applications such as High Definition (HD) videos, Ultra High Definition (UHD) videos or the like have emerged. The Joint Video Exploration Team (JVET) of the International Standard Organization (ISO)/the International Electrotechnical Commission (IEC) and the International Telecommunication Union—Telecommunication Standardization Sector (ITU-T) has developed a video coding standard H.266/Versatile Video Coding (VVC). Intra Block Copy (IBC) is a block-level coding mode provided for video sequences with screen content types in VVC.

In the related art, with respect to a Direct Mode (DM), if an IBC mode is used for a luma block, a chroma prediction mode in this case is not set reasonably, resulting in an inaccurate prediction of chroma for a current block, and losing coding efficiency.

### SUMMARY

The disclosure provides an encoding method, a decoding method and a storage medium.

In a first aspect, embodiments of the disclosure provide a decoding method, the method is applied to a decoder, and the method includes the following operations.

A first color component block for a current block is determined.

When a prediction mode for the first color component block meets a first condition, a target Block Vector (BV) parameter of the current block is determined, and a target symmetric relationship is determined according to the target BV parameter of the current block.

A second color component of the current block is predicted according to the target BV parameter, to determine a predicted value of the second color component of the current block.

A reconstructed value of the second color component of the current block is determined according to the predicted value of the second color component of the current block and the target symmetric relationship.

In a second aspect, embodiments of the disclosure provide an encoding method, the method is applied to an encoder, and the method includes the following operations.

A first color component block for a current block is determined.

When a prediction mode for the first color component block meets a first condition, a target BV parameter of the current block is determined, and a target symmetric relationship is determined according to the target BV parameter of the current block.

A second color component of the current block is predicted according to the target BV parameter, to determine a predicted value of the second color component of the current block.

A residual value of the second color component of the current block is determined according to the predicted value of the second color component of the current block and the target symmetric relationship.

In a third aspect, embodiments of the disclosure provide a non-transitory computer-readable storage medium, the computer-readable storage medium stores bitstream, the bitstream is generated by an encoder performing the encoding method as described in the second aspect.

### BRIEF DESCRIPTION OF THE DRAWINGS

FIG. 1 is a schematic flowchart of acquiring reconstructed samples based on an IBC mode.

FIG. 2 is a schematic diagram of position distribution of adjacent blocks according to embodiments of the disclosure.

FIG. 3 is a schematic diagram of a relationship between a position of a luma block and a position of a chroma block according to embodiments of the disclosure.

FIG. 4A is a schematic block diagram of an encoder according to embodiments of the disclosure.

FIG. 4B is a schematic block diagram of a decoder according to embodiments of the disclosure.

FIG. 5 is a schematic diagram of a network architecture of an encoding and decoding system according to embodiments of the disclosure.

FIG. 6 is a schematic flowchart of a decoding method according to embodiments of the disclosure.

FIG. 7 is a schematic diagram of another relationship between a position of a luma block and a position of a chroma block according to embodiments of the disclosure.

FIG. 8 is a schematic diagram of yet another relationship between a position of a luma block and a position of a chroma block according to embodiments of the disclosure.

FIG. 9 is a schematic diagram of still another relationship between a position of a luma block and a position of a chroma block according to embodiments of the disclosure.

FIG. 10 is a schematic structural diagram showing whether an offset position does not cover a current block according to embodiments of the disclosure.

FIG. 11 is a schematic structural diagram showing whether an offset position exceeds an available area according to embodiments of the disclosure.

FIG. 12 is a schematic structural diagram for determining an optimal chroma BV parameter according to embodiments of the disclosure.

FIG. 13 is a schematic diagram of positions of a current chroma block and a corresponding co-located luma area according to embodiments of the disclosure.

FIG. 14 is a schematic diagram of a position of a reference chroma block at an offset position corresponding to a chroma BV according to embodiments of the disclosure.

FIG. 15A is a schematic diagram of no symmetry within blocks according to embodiments of the disclosure.

FIG. 15B is a schematic diagram of horizontal symmetry of samples within blocks according to embodiments of the disclosure.

FIG. 15C is a schematic diagram of vertical symmetry of samples within blocks according to embodiments of the disclosure.

FIG. 16 is a schematic diagram of templates for a current chroma block and a reference chroma block according to embodiments of the disclosure.

FIG. 17 is a schematic structural diagram of performing block copy based on a DBV mode according to embodiments of the disclosure.

FIG. 18 is a schematic flowchart of an encoding method according to embodiments of the disclosure.

FIG. 19 is a detailed schematic flowchart of an encoding method according to embodiments of the disclosure.

FIG. 20 is a detailed schematic flowchart of another encoding method according to embodiments of the disclosure.

FIG. 21 is a detailed schematic flowchart of a decoding method according to embodiments of the disclosure.

FIG. 22 is a detailed schematic flowchart of another decoding method according to embodiments of the disclosure.

FIG. 23 is a schematic flowchart of another decoding method according to embodiments of the disclosure.

FIG. 24 is a schematic flowchart of another encoding method according to embodiments of the disclosure.

FIG. 25 is a detailed schematic flowchart of yet another encoding/decoding method according to embodiments of the disclosure.

FIG. 26 is a detailed schematic flowchart of yet another encoding/decoding method according to embodiments of the disclosure.

FIG. 27 is a detailed schematic flowchart of yet another encoding/decoding method according to embodiments of the disclosure.

FIG. 28 is a schematic structural diagram showing whether an offset position does not cover a current chroma sub-area according to embodiments of the disclosure.

FIG. 29 is a detailed schematic flowchart of yet another encoding/decoding method according to embodiments of the disclosure.

FIG. 30 is a schematic structural diagram of an encoder according to embodiments of the disclosure.

FIG. 31 is a schematic diagram of specific hardware structures of an encoder according to embodiments of the disclosure.

FIG. 32 is a schematic structural diagram of a decoder according to embodiments of the disclosure.

FIG. 33 is a schematic diagram of specific hardware structures of a decoder according to embodiments of the disclosure.

FIG. 34 is a schematic structural diagram of an encoding and decoding system according to embodiments of the disclosure.

### DETAILED DESCRIPTION

In order to enable understanding of characteristics and technical contents of embodiments of the disclosure in more details, implementations of the embodiments of the disclosure are described in detail below with reference to the drawings. The drawings are used for reference and explanations only, and are not intended to limit the embodiments of the disclosure.

Unless otherwise defined, all the technical and scientific terms used here have the same meaning as that usually understood by technicians in the technical field to which the disclosure belongs. The terms used here are only for the purpose of describing the embodiments of the disclosure, and are not intended to limit the disclosure.

In the following descriptions, reference is made to “some embodiments” which describe a subset of all the possible embodiments; however, it may be understood that “some embodiments” may be the same or different subsets of all the possible embodiments, and may be combined with each other without conflict. It should also be pointed out that terms “first\second\third” involved in the embodiments of the disclosure are only intended to distinguish similar objects, and do not represent a specific order of the objects. It may be understood that specific orders or sequences of “first\second\third” may be interchanged if allowable, such that the embodiments of the disclosure described here may be implemented in an order besides that shown or described here.

Before the embodiments of the disclosure are further described in detail, nouns and terms involved in the embodiments of the disclosure are described first. The nouns and terms involved in the embodiments of the disclosure are applicable to the following explanations:
Coding Block (CB);
Intra block copy (IBC);
Screen Content Coding (SCC);
Block Matching (BM);
Coding Unit (CU);
Coding Tree Unit (CTU);
Block Vector (BV);
Motion Vector (MV);
Direct Block Vector (DBV);
IBC Advanced Motion Vector Prediction (AMVP);
Cross-Component Linear Model prediction (CCLM);
MERGE Mode;
PLANAR Mode;
Discrete Cosine Transform (DCT);
Low-Frequency Non-Separable Transform (LFNST);
Enhanced Compression Model (ECM);
H.266/Versatile Video Coding (VVC);
VVC Test Model (VTM).

It may be understood that in pictures of a video, a CB is usually characterized by using a first color component, a second color component, and a third color component. The three color components are a luma component, a blue chroma component, and a red chroma component respectively. Specifically, the luma component is usually represented by a symbol Y, the blue chroma component is usually represented by a symbol Cb or U, and the red chroma component is usually represented by a symbol Cr or V. In this way, the video picture may be represented in a YCbCr format or a YUV format.

It may also be understood that IBC is an extended tool for coding video sequences with screen content types in VVC, which significantly improves encoding efficiency of screen content sequences. Specifically, the IBC is a block-level coding mode, which is similar to an inter-frame technology. At an encoding side, motion search is performed. Specifically, an optimum BV, which may also be referred to as a MV, is found for each CB through BM. A BV is a vector pointing from a current block to a reference block. What different from the inter-frame technology is that the optimum BV for the IBC is obtained by searching a reconstruction area in a picture where a current CB is located (that is, a current coding picture), while an inter-frame MV is obtained by searching a reference picture adjacent to the current coding picture in a time domain.

In H.266/VVC, a specific process of acquiring reconstructed samples of the current block in an IBC mode may include that: a BV is derived, a predicted sample is derived by using the BV, a residual sample is derived, and a reconstructed sample is derived by using the predicted sample and the residual sample.

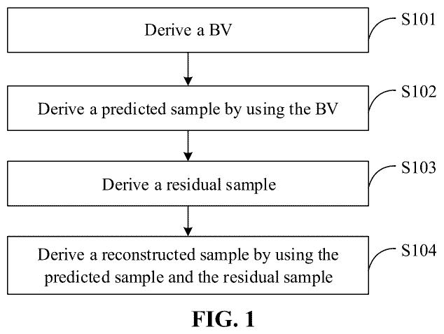

In a specific implementation, a process of acquiring the reconstructed samples in the IBC mode is shown in FIG. 1, and may include the following operations S101 to S104.

In operation S101, a BV is derived.

For the luma component, inputs include: a luma position (xCb, yCb), which specifies a position of a top-left sample of the current block relative to a top-left luma sample of a current picture; a variable cbWidth, which specifies a width of the current block in the luma samples; a variable cbHeight, which specifies a height of the current block in the luma samples. Output includes: a Block Vector Luma (bvL). It should be noted that the current block including the luma samples may also be referred to as a “luma block”.

Here, the IBC mode includes an IBC MERGE mode and an IBC AMVP mode. When the bvL is derived, both need to establish an IBC BV candidate list bvCandList. An establishment process of an IBC MERGE list will be introduced in detail below. An establishment process of an IBC AMVP list is consistent with that of the IBC MERGE list, however, a maximum number of candidates for the two processes is inconsistent.

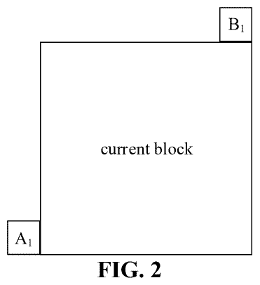

First step: when IsGt4by4 is equal to TRUE (a variable IsGt4by4 is TRUE when a product by multiplying a width of the luma block and a height of the luma block is greater than 16), a derivation process of a spatial BV candidate from an adjacent CU specified in a decoding specification is called by using the luma block position (xCb, yCb), the width cbWidth and the height cbHeight of the luma block as inputs, and outputs are availability flags availableFlagA1, availableFlagB1 and BVs bvA₁, bvB₁. Positions of adjacent blocks where A₁ and B₁ are located relative to the current block are shown in FIG. 2.

Second step: when IsGt4by4 is equal to TRUE, pseudo codes for constructing the BV candidate list bvCandList are as follows:

```
i=0
if( availableFlagA₁ )
  bvCandList[i++] = bvA₁
if( availableFlagB₁ )
  bvCandList[i++] = bvB₁
```

Third step: a derivation process of a variable numCurrCand (a number of candidates obtained currently) is as follows.

If IsGt4by4 is equal to TRUE, the numCurrCand is set to be equal to a number of candidates in the bvCandList; otherwise, the numCurrCand is set to 0.

Fourth step: when the numCurrCand is less than MaxNumIbcMergeCand (a maximum number of candidates in a MERGE mode) and NumHmvpIbcCand (a maximum number of candidates for a historical optimal BV Hmvp in the IBC mode) is greater than 0, a derivation process of a history-based IBC BV candidate specified in the decoding specification is called by using the bvCandList and the numCurrCand as inputs, and using a modified bvCandList and a modified numCurrCand as outputs.

Fifth step: when the numCurrCand is less than the MaxNumIbcMergeCand, the following contents are applied until the numCurrCand is equal to the MaxNumIbcMergeCand:
bvCandList[numCurrCand][0] is set to be equal to 0 (a horizontal component of the BV);
bvCandList[numCurrCand][1] is set to be equal to 0 (a vertical component of the BV);
the numCurrCand increases by 1.

In this way, the BV candidate list bvCandList is established, and a candidate index bvIdx is derived as follows. general_merge_flag indicates whether it is the IBC MERGE mode:

bvIdx=general_merge_flag[xCb][yCb]?merge_idx[xCb][yCb]:mvp_l0_flag[xCb][yCb]

In this way, a specific bvL may be obtained according to the index bvIdx and the BV candidate list bvCandList:

bvL[0]=bvCandList[bvIdx][0];

bvL[1]=bvCandList[bvIdx][1].

For the IBC AMVP mode, a specific bvL which may be obtained by using the index bvIdx and the BV candidate list bvCandList is a predicted bvL, and it also needs to add a Block Vector Difference (BVD) to obtain a real bvL, a specific process thereof is as follows.

First step: horizontal and vertical components of the BVD are obtained. MvdL0 is a forward MV difference. The horizontal component of the BVD is represented by bvd[0], and the vertical component of the BVD is represented by bvd[1], details are as follows:

bvd[0]=MvdL0[xCb][yCb][0];

bvd[1]=MvdL0[xCb][yCb][1].

Second step: a rounding operation is performed on the above-obtained predicted bvL. A right shift parameter AmvrShift is used to perform rounding, and a left shift parameter AmvrShift is used to improve resolution. Details are as follows:

$$Offset = ( AmvrShift == 0 ) ? 0 : ( ( 1 << ( AmvrShift - 1 ) ) - 1 ) ;$$

$$bvL [ 0 ] = Sign ( bvL [ 0 ] ) * ( ( ( Abs ( bvL [ 0 ] ) + offset ) >> AmvrShift ) << AmvrShift ) ;$$

$$bvL [ 1 ] = Sign ( bvL [ 1 ] ) * ( ( ( Abs ( bvL [ 1 ] ) + offset ) >> AmvrShift ) << AmvrShift ) .$$

Third step: for the real bvL, its range needs to be controlled between −2¹⁷ and 2¹⁷−1. A specific derivation process is as follows:

$$u [ 0 ] = ( b v L [ 0 ] + b v d [ 0 ] + {2}^{18} ) \% {2}^{18} ;$$

$$bvL [ 0 ] = ( u [ 0 ] >= {2}^{17} ) ? ( u [ 0 ] - {2}^{18} ) : u [ 0 ] ;$$

$$u [ 1 ] = ( b v L [ 1 ] + b v d [ 1 ] + {2}^{18} ) \% {2}^{18} ;$$

$$bvL [ 1 ] = ( u [ 1 ] >= {2}^{17} ) ? ( u [ 1 ] - {2}^{18} \text{):} u [ 1 ] .$$

For the chroma component, if it is a dual-tree partition, the chroma component does not use the IBC mode; if it is a single-tree partition, the BV of the chroma component needs to be derived.

Input includes: a luma bvL (in a 1/16 pixel accuracy). Output includes: a Block Vector Chroma (bvC) (in a 1/32 pixel accuracy). A specific derivation process is as follows:

$$bvC [ 0 ] = ( ( bv L [ 0 ] >> ( 3 + SubWidthC ) ) ⋆ 32 ) ;$$

$$bvC [ 1 ] = ( ( bv L [ 1 ] >> ( 3 + SubHeightC ) ) ⋆ 32 ) .$$

In operation S102, a predicted sample is derived by using the BV.

Here, inputs include: a luma position (xCb, yCb), which specifies a position of a top-left sample of the current block relative to a top-left luma sample of a current picture; a variable cbWidth, which specifies a width of the current block in the luma samples; a variable cbHeight, which specifies a height of the current block in the luma samples; a BV; and a variable cIdx, which specifies an index of a color component of the current block. Output includes: an array of predicted samples predSamples.

For the predicted sample, a specific derivation process is as follows.

When the cIdx is equal to 0, that is, it is the luma component, for x=xCb . . . xCb+cbWidth−1 and y=yCb . . . yCb+cbHeight−1:

$$xVb = ( x + ( bv [ 0 ] >> 4 ) ) \& ( IbcBufWidthY − 1 ) ;$$

$$yVb = ( y + ( bv [ 1 ] >> 4 ) ) \& ( CtbSizeY − 1 ) ;$$

$$predSamples [ x ] [ y ] = ibcVirBuf [ 0 ] [ xVb ] [ yVb ] .$$

The IbcBufWidthY is a width of a luma pixel in a reconstructed buffer stored for the IBC, the CtbSizeY is a size of a CTU, and the ibcVirBuf is a reconstructed pixel stored for the IBC.

When the cIdx is not equal to 0, that is, it is the chroma component, for x=xCb/SubWidthC . . . xCb/SubWidthC+cbWidth/SubWidthC−1 and y=yCb/SubHeightC . . . yCb/SubHeightC+cbHeight/SubHeightC−1:

$$xVb = ( x + ( bv [ 0 ] >> 5 ) ) \& ( IbcBufWidthC − 1 ) ;$$

$$yVb = ( y + ( bv [ 1 ] >> 5 ) ) \& ( CtbSizeY / subHeightC ) − 1 ) ;$$

$$predSamples [ x ] [ y ] = ibcVirBuf [ cIdx ] [ xVb ] [ yVb ] .$$

Variables SubWidthC and SubHeightC specifically depend on a chroma sampling format specified by sps_chroma_format_idc, and specific correspondences are shown in Table 1.

TABLE 1

| | color sampling | | |
|---|---|---|---|
| sps_chroma_format_idc | format | SubWidthC | SubHeightC |
| 0 | monochrome | 1 | 1 |
| 1 | 4:2:0 | 2 | 2 |
| 2 | 4:2:2 | 2 | 1 |
| 3 | 4:4:4 | 1 | 1 |

In operation S103, a residual sample is derived.

For the residual sample, a residual decoding process specified in the decoding specification may be called.

In operation S104, a reconstructed sample is derived by using the predicted sample and the residual sample.

For the reconstructed sample (that is, a reconstructed pixel value), a picture reconstruction process of a specified color component specified in the decoding specification may be called.

In another specific implementation, for a derivation process of a chroma prediction mode in H.266/VVC, inputs include: a luma position (xCb, yCb), which specifies a position of a top-left sample of the current block relative to a top-left luma sample of a current picture; a variable cbWidth, which specifies a width of the current block in the luma samples; a variable cbHeight, which specifies a height of the current block in the luma samples; a variable treeType, which specifies whether a single-tree partition or a dual-tree partition is used. Outputs include: a chroma intra prediction mode IntraPredModeC[xCb][yCb] and a Matrix-weighted Intra Prediction (MIP) chroma Direct Mode (DM) flag MipChromaDirectFlag[xCb][yCb].

If the treeType is equal to SINGLE_TREE, that is, in case of the single-tree partition, the sps_chroma_format_idc is equal to 3, that is, a 4:4:4 format, intra_chroma_pred_mode is equal to 4, and IntraMipFlag[xCb][yCb] is equal to 1, that is, a prediction mode for a corresponding co-located luma center block is a MIP mode, then:
<1> The MIP chroma DM flag MipChromaDirectFlag[xCb][yCb] is set to be equal to 1, that is, a MIP mode for the luma is used for the chroma.
<2> The chroma intra prediction mode IntraPredModeC[xCb][yCb] is set to be equal to IntraPredModeY[xCb][yCb].

Otherwise:
<1> The MIP chroma DM flag MipChromaDirectFlag[xCb][yCb] is set to be equal to 0.
<2> A corresponding luma intra prediction mode lumaIntraPredMode is derived as follows.

If IntraMipFlag[xCb+cbWidth/2][yCb+cbHeight/2] is equal to 1, the lumaIntraPredMode is set to be equal to INTRA_PLANAR.

Otherwise, if CuPredMode[0][xCb+cbWidth/2][yCb+cbHeight/2] is equal to MODE_IBC or MODE_PLT, the lumaIntraPredMode is set to be equal to INTRA_DC.

It should be noted that an Intra Template Matching Prediction (IntraTMP) mode is newly introduced in an ECM. If CuPredMode[0][xCb+cbWidth/2][yCb+cbHeight/2] is equal to MODE_INTRA and it is the IntraTmp mode, the lumaIntraPredMode is set to be equal to INTRA_PLANAR.

Otherwise, the lumaIntraPredMode is set to be equal to IntraPredModeY[xCb+cbWidth/2][yCb+cbHeight/2].

<3> The chroma intra prediction mode IntraPredModeC[xCb][yCb] is derived as follows.

If cu_act_enabled_flag[xCb][yCb] is equal to 1, the chroma intra prediction mode IntraPredModeC[xCb][yCb] is set to be equal to the lumaIntraPredMode.

### Otherwise:

If BdpcmFlag[xCb][yCb][1] is equal to 1, the IntraPredModeC[xCb][yCb] is set to be equal to BdpcmDir[xCb][yCb][1]?INTRA_ANGULAR50: INTRA_ANGULAR18.

Otherwise, the cu_act_enabled_flag[xCb][yCb] is equal to 0 and the BdpcmFlag[xCb][yCb][1] is equal to 0, the chroma intra prediction mode IntraPredModeC[xCb][yCb] uses cclm_mode_flag, cclm_mode_idx, intra_chroma_pred_mode, and lumaIntraPredMode as specified in Table 2.

TABLE 2

| | | | lumaIntraPredMode | | | | |
|---|---|---|---|---|---|---|---|
| cclm_{—} | cclm_{—} | intra_chroma_{—} | | | | | X(0 <= |
| mode_flag | mode_idx | pred_mode | 0 | 50 | 18 | 1 | X <= 66) |
| 0 | — | 0 | 66 | 0 | 0 | 0 | 0 |
| 0 | — | 1 | 50 | 66 | 50 | 50 | 50 |
| 0 | — | 2 | 18 | 18 | 66 | 18 | 18 |
| 0 | — | 3 | 1 | 1 | 1 | 66 | 1 |
| 0 | — | 4 | 0 | 50 | 18 | 1 | X |
| 1 | 0 | — | 81 | 81 | 81 | 81 | 81 |
| 1 | 1 | — | 82 | 82 | 82 | 82 | 82 |
| 1 | 2 | — | 83 | 83 | 83 | 83 | 83 |

When the sps_chroma_format_idc is equal to 2, a chroma intra prediction mode Y may be derived by using the chroma intra prediction mode X in Table 2, which specifically refers to a mapping process specification of the mode X to the mode Y shown in Table 3, and then the chroma intra prediction mode X is set to be equal to the chroma intra prediction mode Y.

TABLE 3

| | mode X | | | | | | | | | | | | | | | | |
|---|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 | 16 |
| mode Y | 0 | 1 | 61 | 62 | 63 | 64 | 65 | 66 | 2 | 3 | 5 | 6 | 8 | 10 | 12 | 13 | 14 |
| | mode X | | | | | | | | | | | | | | | | |
| | 18 | 19 | 20 | 21 | 22 | 23 | 24 | 25 | 26 | 27 | 28 | 29 | 30 | 31 | 32 | 33 | 34 |
| mode Y | 18 | 20 | 22 | 23 | 24 | 26 | 28 | 30 | 31 | 33 | 34 | 35 | 36 | 37 | 38 | 39 | 40 |
| | mode X | | | | | | | | | | | | | | | | |
| | 36 | 37 | 38 | 39 | 40 | 41 | 41 | 43 | 44 | 45 | 46 | 47 | 48 | 49 | 50 | 51 | 52 |
| mode Y | 41 | 42 | 43 | 43 | 44 | 44 | 45 | 45 | 46 | 47 | 48 | 48 | 49 | 49 | 50 | 51 | 51 |

| | mode X | | | | | | | | | | | | |
|---|---|---|---|---|---|---|---|---|---|---|---|---|---|
| | 54 | 55 | 56 | 57 | 58 | 59 | 60 | 61 | 62 | 63 | 64 | 65 | 66 |
| mode Y | 52 | 53 | 54 | 55 | 55 | 56 | 56 | 57 | 57 | 58 | 59 | 59 | 60 |

In yet another specific implementation, for a DM mode which refers to directly using information of a luma prediction mode at a corresponding position:

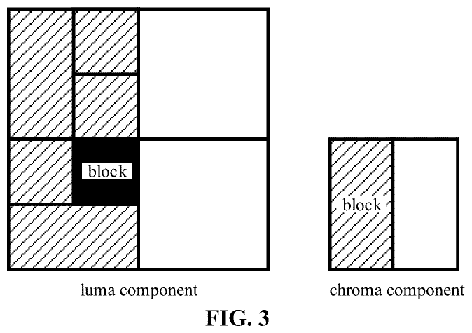

When the dual-tree partition is used for an I frame, independent block partitioning structures, such as a Dual Tree mode in H.266/VVC, are allowed to be used for the luma component and the chroma component. At this time, a luma component at a position corresponding to a chroma CB may include multiple luma CBs, as shown in FIG. 3. In H.266/VVC, when a value of the intra_chroma_pred_mode is equal to 4, it indicates that a current chroma block is decoded by using the DM mode.

An intra prediction mode for a chroma block is determined according to an intra prediction mode for a luma block at a center position of a co-located luma area corresponding to the chroma block. Determination methods may be directly using an intra prediction mode for the luma block or an intra prediction mode obtained by performing a further derivation.

In an actual application, the intra prediction mode for the chroma block may be determined by using a coordinate at the center position of the co-located luma area corresponding to the chroma block as a reference point, according to the intra prediction mode for the luma block including the reference point. Determination methods may be directly using an intra prediction mode for the luma block or an intra prediction mode obtained by performing a further derivation.

Positions of CBs taken for the DM mode are specifically described as follows.

A position of the current chroma block, that is, a position of a top-left chroma sample of the current chroma block relative to a top-left chroma sample of the current picture, chromaPos=(x, y) is acquired; the chromaPos is scaled according to the chroma sampling format, to obtain a position of a co-located luma area corresponding to the current chroma block, lumaPos=(xCb, yCb). Table 4 shows an example of scaling the chromaPos according to the chroma sampling format.

TABLE 4

| | color sampling | | |
|---|---|---|---|
| sps_chroma_format_idc | format | xCb | yCb |
| 0 | monochrome | — | — |
| 1 | 4:2:0 | x<<1 | y<<1 |
| 2 | 4:2:2 | x<<1 | y |
| 3 | 4:4:4 | x | y |

The luma position (xCb, yCb) specifies a position of a top-left luma sample of a luma area corresponding to the current chroma block relative to a top-left luma sample of the current picture, a variable cbWidth specifies a width of the current CB in the luma samples, a variable cbHeight specifies a height of the current CB in the luma samples.

A relationship between a position of the current chroma block and a position of the luma area corresponding thereto is shown in FIG. 3. A central luma pixel position of the luma area corresponding to the current chroma block is described as follows, here xCenter represents a horizontal coordinate position, yCenter represents a vertical coordinate position, and the CB including the pixel position is a block at a center position of the luma block corresponding to the chroma block:

$$xCenter = xCb + cbWidth >> 1 ;$$

$$yCenter = yCb + cbHeight >> 1.$$

It should also be noted that in the embodiments of the disclosure, unless otherwise specified particularly, the block mentioned in the disclosure may be a CU, or a sub-block, or a transform block, or the like, which is not limited in any way.

In yet another specific implementation, for a bitstream organization method for chroma prediction in H.266/VVC, syntax elements related thereto are shown in Table 5. Furthermore, for a value of a syntax element “Value of intra_chroma_pred_mode” a binarization mapping table corresponding thereto is shown in Table 6; for different syntax elements (such as cclm_mode_flag, cclm_mode_idx, intra_chroma_pred_mode, etc.), an encoding method used for each coded bit is specifically shown in Table 7.

TABLE 5

| | |
|---|---|
| if(!cu_act_enabled_flag){ | |
| if(cbWidth/SubWidthC<=MaxTsSize&&cbHeight/SubHeightC<= | |
| MaxTsSize&&sps_bdpcm_enabled_flag) | |
| intra_bdpcm_chroma_flag | ae(v) |
| if(intra_bdpcm_chroma_flag) | |
| intra_bdpcm_chroma_dir_flag | ae(v) |
| else{ | |
| if(CclmEnabled) | |
| cclm_mode_flag | ae(v) |
| if(cclm_mode_flag) | |
| cclm_mode_idx | ae(v) |
| else | |
| intra_chroma_pred_mode | ae(v) |
| } | |
| } | |

TABLE 6

| Value of intra_chroma_pred_mode | Bin string |
|---|---|
| 0 | 100 |
| 1 | 101 |
| 2 | 110 |
| 3 | 111 |
| 4 | 0 |

TABLE 7

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

binIdx indicates a number of bits. If binIdx=0, it indicates a 0th bit; if binIdx=1, it indicates a 1st bit. Furthermore, bypass indicates a bypass mode, and na indicates no processing.

In the related art, in the dual-tree partition, for the DM mode, if a corresponding luma block is in the IBC mode, an acquired chroma prediction mode is a DC mode, which loses coding efficiency at this time. Furthermore, in an original DBV prediction process, operations of chroma IBC prediction are to locate a reference chroma block and simply perform a block copy process, which cannot achieve a good prediction, and results in an inaccurate chroma prediction for the current block, thereby losing coding efficiency.

Based on this, the embodiments of the disclosure further provide an encoding method and a decoding method, which may effectively and accurately predict the chroma block. On one hand, available information such as reconstructed luma, BV or the like are fully considered, and chroma is predicted according to these information, which improves singleness of chroma prediction. Further, the symmetric relationship is considered, and the predicted value is processed in more detail. This not only improves accuracy of the chroma prediction and saves the bit rate is saved, but also improves encoding and decoding performance, and improves encoding efficiency effectively. On the other hand, by dividing the current block into sub-area for prediction, multiple options can be adaptively provided according to different contents and luma prediction information, making DBV prediction more effective and further improving the coding efficiency.

The embodiments of the disclosure will be described in detail below with reference to the drawings.

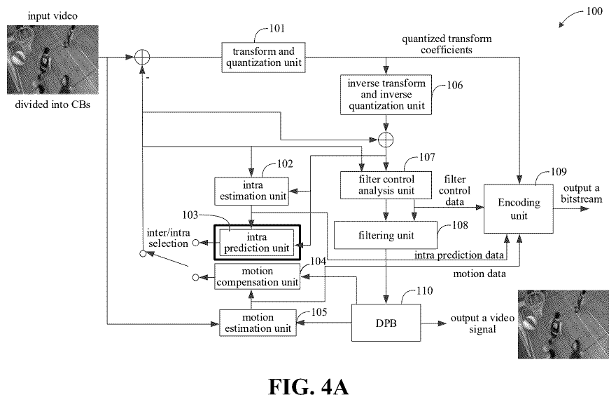

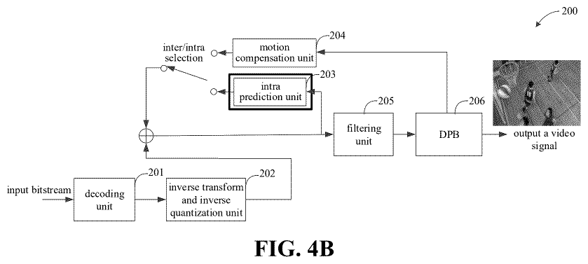

With reference to FIG. 4A, a schematic block diagram of an encoder according to embodiments of the disclosure is shown. As shown in FIG. 4A, the encoder (specifically, “a video encoder”) 100 may include a transform and quantization unit 101, an intra estimation unit 102, an intra prediction unit 103, a motion compensation unit 104, a motion estimation unit 105, an inverse transform and inverse quantization unit 106, a filter control analysis unit 107, a filtering unit 108, an encoding unit 109, a decoded picture buffer (DPB) 110, etc. The filtering unit 108 may implement de-blocking filtering and Sample Adaptive Offset (SAO) filtering, and the encoding unit 109 may implement header information coding and Context-based Adaptive Binary Arithmetic Coding (CABAC). For an input original video signal, a video coding block may be obtained by dividing coding tree units (CTUs), and then residual pixel information obtained after intra or inter prediction is transmitted to the transform and quantization unit 101 to transform the video coding block, which includes transforming the residual information from a pixel domain to a transform domain, and quantizing obtained transform coefficients, to further reduce the bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used to code the video coding block. The motion compensation unit 104 and the motion estimation unit 105 are configured to perform inter prediction coding of the received video coding block relative to one or more blocks in one or more reference frames, to provide temporal prediction information. Motion estimation performed by the motion estimation unit 105 is a process of generating a MV which may be used to estimate motion of the video coding block. Then the motion compensation unit 104 performs motion compensation based on the MV determined by the motion estimation unit 105. After determining the intra prediction mode, the intra prediction unit 103 is further configured to provide selected intra prediction data to the encoding unit 109, and the motion estimation unit 105 also transmits calculated and determined MV data to the encoding unit 109. Furthermore, the inverse transform and inverse quantization unit 106 is used for reconstruction of the video coding block, to reconstruct a residual block in the pixel domain. A block effect artifact is removed from the reconstructed residual block by the filter control analysis unit 107 and the filtering unit 108, and then the reconstructed residual block is added to a predictive block in a frame in the DPB 110, to generate a reconstructed video coding block. The encoding unit 109 is configured to code various coding parameters and quantized transform coefficients. In a CABAC-based coding algorithm, a context content may be based on adjacent coding blocks, and the encoding unit 109 may be configured to code information indicating a determined intra prediction mode and output a bitstream for the video signal. The DPB 110 is configured to store the reconstructed video coding block, to be used as a reference of prediction. As coding of the video pictures proceeds, new reconstructed video coding blocks will be continuously generated, and all of these reconstructed video coding blocks will be stored in the DPB 110.

With reference to FIG. 4B, a schematic block diagram of a decoder according to embodiments of the disclosure is shown. As shown in FIG. 4B, the decoder (specifically, “a video decoder”) 200 includes a decoding unit 201, an inverse transform and inverse quantization unit 202, an intra prediction unit 203, a motion compensation unit 204, a filtering unit 205, a DPB 206, etc. The decoding unit 201 may implement header information decoding and CABAC decoding. The filtering unit 205 may implement de-blocking filtering and SAO filtering. After the input video signal is coded as shown in FIG. 4A, a bitstream for the video signal is output. The bitstream is input to the decoder 200 and passes through the decoding unit 201 first, to obtain decoded transform coefficients. The transform coefficients are processed by the inverse transform and inverse quantization unit 202, to generate a residual block in the pixel domain. The intra prediction unit 203 may be configured to generate prediction data for a current video decoding block based on the determined intra prediction mode and data from a previously decoded block of a current frame or picture. The motion compensation unit 204 is configured to determine prediction information for the video decoding block by analyzing the MV and other associated syntax elements, and use the prediction information to generate a predictive block of the video decoding block being decoded. A decoded video block is formed by summing the residual block from the inverse transform and inverse quantization unit 202 and a corresponding predictive block generated by the intra prediction unit 203 or the motion compensation unit 204. The decoded video signal passes through the filtering unit 205 to remove the block effect artifact, which may improve quality of the video. Then, the decoded video block is stored in the DPB 206 which stores a reference picture used for subsequent intra prediction or motion compensation, and is also used for output of the video signal, that is, a restored original video signal is obtained.

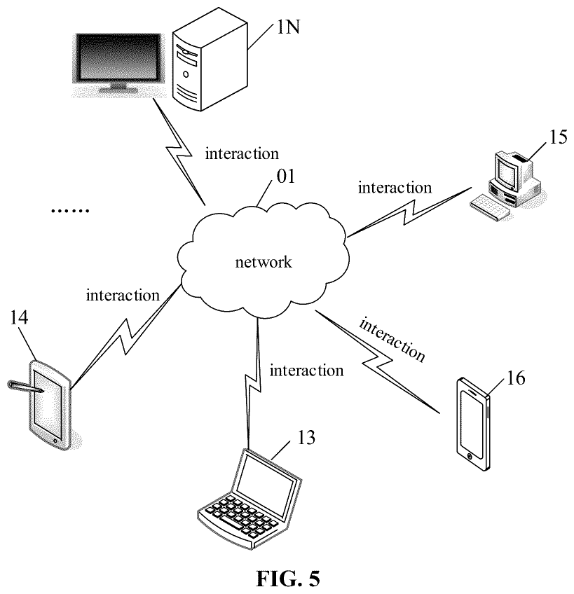

Further, embodiments of the disclosure further provide a network architecture of an encoding and decoding system including an encoder and a decoder. FIG. 5 shows a schematic diagram of a network architecture of an encoding and decoding system according to embodiments of the disclosure. As shown in FIG. 5, the network architecture includes one or more electronic devices 13 to 1N and a communication network 01. The electronic devices 13 to 1N may perform video interaction through the communication network 01. During implementation, the electronic devices may be various types of devices with video encoding and decoding functions, for example, the electronic devices may include a smart phone, a tablet computer, a personal computer, a personal digital assistant, a navigator, a digital phone, a video phone, a television, a sensor device, a server, etc., which is not specifically limited in the embodiments of the disclosure. Here, the decoder or the encoder described in the embodiments of the disclosure may be the above electronic devices.

It should be noted that the methods of the embodiments of the disclosure are mainly applied to a part of the intra prediction unit 103 shown in FIG. 4A and a part of the intra prediction unit 203 shown in FIG. 4B. That is, the embodiments of the disclosure may be applied to the encoder, or may be applied to the decoder, or may even be applied to both the encoder and the decoder, which is not specifically limited in the embodiments of the disclosure.

It should also be noted that when they are applied to the part of the intra prediction unit 103, “current block” specifically refers to a coding block to be intra predicted currently; and when they are applied to the part of the intra prediction unit 203, “current block” specifically refers to a decoding block to be intra predicted currently.

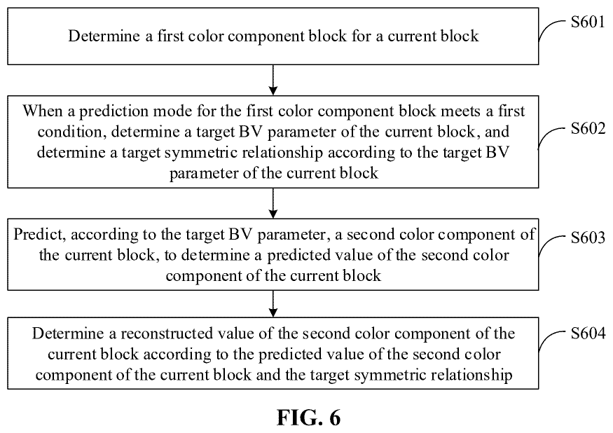

In embodiments of the disclosure, with reference to FIG. 6, a schematic flowchart of a decoding method according to embodiments of the disclosure is shown. As shown in FIG. 6, the method may include the following operations S601 to S604.

In operation S601, a first color component block for a current block is determined.

It should be noted that the decoding method of the embodiments of the disclosure is applied to a decoder. Furthermore, the decoding method may specifically refer to an intra prediction method, and more specifically, refer to a method of performing prediction by using a DBV mode. A video picture may be divided into multiple decoding blocks, each of the decoding blocks may include a first color component, a second color component and a third color component, and the current block in the embodiments of the disclosure refers to a decoding block to be intra predicted currently in the video picture.

Here, when the first color component needs to be predicted, a to-be-predicted component is the first color component; when the second color component needs to be predicted, the to-be-predicted component is the second color component; when the third color component needs to be predicted, the to-be-predicted component is the third color component. Furthermore, it is assumed that prediction of the first color component is performed for the current block, and the first color component is a luma component, that is, a to-be-predicted component is the luma component, then the current block may also be referred to as a luma block. Or, it is assumed that prediction of the second color component is performed for the current block, and the second color component is a chroma component, that is, a to-be-predicted component is the chroma component, then the current block may also be referred to as a chroma block.

It should also be noted that in the dual-tree partition, for the DM mode, when a prediction mode for a co-located luma block meets a first condition, in the embodiments of the disclosure, BV parameters applied to chroma may be derived according to BV parameters of the co-located luma block, thereby improving the coding efficiency.

In some embodiments, the operation of determining the first color component block for the current block may include that: a first co-located area corresponding to the current block is determined; and the first color component block for the current block is determined from multiple blocks divided from the first co-located area.

It should be noted that in the embodiments of the disclosure, the first co-located area may refer to a first color component area located at the same position as the current block. For example, if the current block is the chroma component, the first co-located area refers to a co-located luma area corresponding to the current block. For the current block, in the first co-located area, block division may be performed on the first co-located area, for example, by using a binary tree structure, a ternary tree structure, a quadtree structure, or the like, to obtain multiple blocks. Each of the blocks may be considered as a CU, a sub-block, or a transform block, or the like. Then the first color component block for the current block is determined from these multiple blocks.

Exemplarily, taking FIG. 3 as an example, an area filled with oblique lines represents the co-located luma area corresponding to the chroma component. In the co-located luma area, multiple blocks may be divided; a block at the center position may be selected from these blocks as a corresponding luma block of the current block. For example, a block filled with black in FIG. 3 is the corresponding luma block of the current block.

Further, in some embodiments, the operation of determining the first color component block for the current block from these multiple blocks divided from the first co-located area may include that: a target block is selected from these multiple blocks divided from the first co-located area, and the target block is taken as the first color component block for the current block.

The target block may be a block at any position. In a specific embodiment, a block at a center position of the first color component area is selected as the target block; or a block at a top-left position of the first color component area is selected as the target block; or a block at a lower-right position of the first color component area is selected as the target block.

Further, in some embodiments, the operation of determining the first color component block for the current block may include that: position information of the current block is determined; the position information of the current block is scaled according to a preset sampling format, to obtain position information of a co-located area corresponding to the current block; and target position information is determined according to the position information of the co-located area, and a target block including the target position information is taken as the first color component block for the current block.

Further, in some embodiments, the operation of determining the target position information according to the position information of the co-located area may include that: a center position is calculated according to the position information of the co-located area, and information of an obtained center position is taken as the target position information; or a top-left position is calculated according to the position information of the co-located area, and information of an obtained top-left position is taken as the target position information; or a lower-right position is calculated according to the position information of the co-located area, and information of an obtained lower-right position is taken as the target position information.

In the embodiments of the disclosure, the preset sampling format may be a chroma sampling format (or, referred to as a color sampling format). Exemplarily, a mapping relationship between a position (x, y) of the current block and a position (xCb, yCb) of the co-located area is shown in Table 8.

TABLE 8

| | color sampling | | |
|---|---|---|---|
| sps_chroma_format_idc | format | xCb | yCb |
| 0 | monochrome | — | — |
| 1 | 4:2:0 | x<<1 | y<<1 |
| 2 | 4:2:2 | x<<1 | y |
| 3 | 4:4:4 | x | y |

In a possible implementation, a position of the current chroma block, that is, a position of the top-left chroma sample of the current chroma block relative to the top-left chroma sample of the current picture, chromaPos=(x, y) is acquired; the chromaPos is scaled according to the chroma sampling format shown in Table 8, to obtain a position of the co-located luma area corresponding to the current chroma block, lumaPos=(xCb, yCb).

Here, it is assumed that a position of the co-located luma pixel corresponding to the top-left corner of the current chroma block relative to the top-left luma pixel of the picture is (xCb, yCb), a width of the co-located luma area corresponding to the current chroma block (that is, an entire area filled with oblique lines of the luma component in FIG. 3) is cbWidth, and a height of the co-located luma area is cbHeight; then the block at the center position (the block at the center position of the luma area) is the luma block including information of the center position (xCb+cbWidth>>1, yCb+cbHeight>>1), which is the block filled with black in FIG. 3.

In another possible implementation, a position of the current chroma block, that is, a position of the top-left chroma sample of the current chroma block relative to the top-left chroma sample of the current picture, chromaPos=(x, y) is acquired; the chromaPos is scaled according to the chroma sampling format shown in Table 8, to obtain a position of the co-located luma area corresponding to the current chroma block, lumaPos=(xCb, yCb).

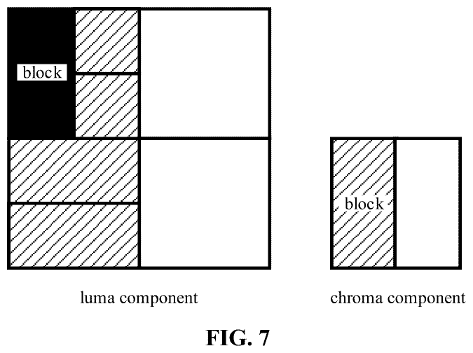

Here, it is assumed that a position of the co-located luma pixel corresponding to the top-left of the current chroma block relative to the top-left luma pixel of the picture is (xCb, yCb), a width of the co-located luma area corresponding to the current chroma block (that is, an entire area filled with oblique lines of the luma component in FIG. 7) is cbWidth, and a height of the co-located luma area is cbHeight; then the block at the top-left position (The top-left block of the luma area) is the luma block including the position coordinate (xCb, yCb), which is the block filled with black in FIG. 7.

In yet another possible implementation, a position of the current chroma block, that is, a position of the top-left chroma sample of the current chroma block relative to the top-left chroma sample of the current picture, chromaPos=(x, y) is acquired; the chromaPos is scaled according to the chroma sampling format shown in Table 8, to obtain a position of the co-located luma area corresponding to the current chroma block, lumaPos=(xCb, yCb).

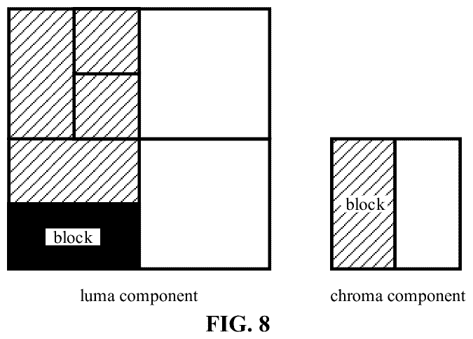

Here, it is assumed that a position of the co-located luma pixel corresponding to the top-left of the current chroma block relative to the top-left luma pixel of the picture is (xCb, yCb), a width of the co-located luma area corresponding to the current chroma block (that is, an entire area filled with oblique lines of the luma component in FIG. 8) is cbWidth, and a height of the co-located luma area is cbHeight; then the block at the lower-right position (The lower-right block of the luma area) is the luma block including the position coordinate (xCb+cbWidth−1, yCb+cbHeight−1), which is the block filled with black in FIG. 8.

That is, in the embodiments of the disclosure, the target block of the first color component block may be a block at any position in these multiple blocks shown in FIG. 3. For example, it may be the block at the center position of the co-located luma area (the block filled with black) shown in FIG. 3, the block at the top-left position of the co-located luma area (the block filled with black) shown in FIG. 7, the block at the lower-right position of the co-located luma area (the block filled with black) shown in FIG. 8, or may even be a block at a top-right position of the co-located luma area, a block at a lower-left position of the co-located luma area, or may even be a block at a center position of a top-left area, or the like, which is not specifically limited here.

Further, in some embodiments, the operation of determining, from these multiple blocks divided from the first co-located area, the first color component block for the current block may include that: at least one candidate block at a preset position is determined from these multiple blocks divided from the first co-located area; and a target candidate block meeting a preset determination condition is determined from the at least one candidate block, and the target candidate block is taken as the first color component block for the current block.

In a specific embodiment, whether the candidate block meets the preset determination condition may include that: at least one candidate block is sequentially acquired according to a preset order, and a mode determination is performed; if a prediction mode for a first candidate block is determined to meet a first condition, the first candidate block is used as the first color component block for the current block.

In another specific embodiment, whether the candidate block meets the preset determination condition may include that: if a prediction mode for a first candidate block is determined to meet a first condition, a first BV parameter of the first candidate block is determined; it is determined whether the first BV parameter of the first candidate block meets an availability condition; if the first BV parameter of the first candidate block meets the availability condition, the first candidate block is taken as the first color component block for the current block; if the first BV parameter of the first candidate block does not meet the availability condition, the mode determination is continuously performed on a next candidate block, until a target candidate block of which a prediction mode meets the first condition and a corresponding first BV parameter meets the availability condition is determined, and the target candidate block is taken as the first color component block for the current block.

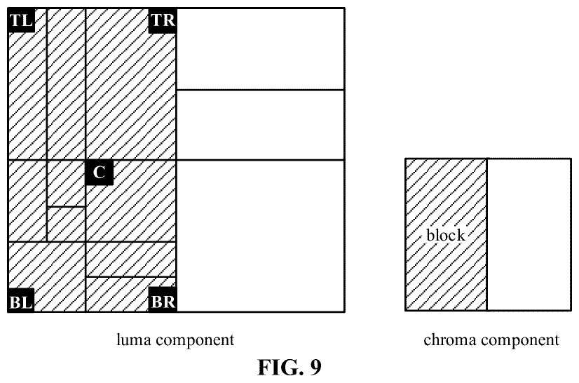

In the embodiments of the disclosure, the first color component block may also be determined by performing the mode determination on at least one candidate block at the preset position. For example, as shown in FIG. 9, there are included CUs at five luma pixel positions, which are specifically C, TL, TR, BL and BR. However, the embodiments of the disclosure is not limited to five positions, there may be multiple different positions; and the embodiments of the disclosure is not limited to the five positions shown in FIG. 9 either, which is not specifically limited.

In yet another possible implementation, taking blocks at five luma pixel positions shown in FIG. 9 as an example, they may be acquired sequentially in a preset order, until a block obtained by performing determination is predictively coded in a mode with BV information, that is, a first block which is predictively coded in the mode with BV information is found from the luma pixel positions, and preset orders for sequential acquisition include but are not limited to the following order: C->TL->TR->BL->BR.

For a detailed derivation process of positions of C, TL, TR, BL and BR, a position of the current chroma block, that is, a position of the top-left chroma sample of the current chroma block relative to the top-left chroma sample of the current picture, chromaPos=(x, y) is acquired; the chromaPos is scaled according to the chroma sampling format shown in Table 8, to obtain a position of the co-located luma area corresponding to the current chroma block, lumaPos=(xCb, yCb).

Here, it is assumed that a position of the co-located luma pixel corresponding to the top-left corner of the current chroma block relative to the top-left luma pixel of the picture (that is, the position of the luma pixel TL) is (xCb, yCb), a width of the co-located luma area corresponding to the current chroma block (that is, an entire area filled with oblique lines of the luma component in FIG. 9) is cbWidth, and a height of the co-located luma area is cbHeight.

A coordinate at the position of the luma pixel C is (xCb+cbWidth/2, yCb+cbHeight/2);
A coordinate at the position of the luma pixel TL is (xCb, yCb);
A coordinate at the position of the luma pixel TR is (xCb+cbWidth−1, yCb);
A coordinate at the position of the luma pixel BL is (xCb, yCb+cbHeight−1);
A coordinate at the position of the luma pixel BR is (xCb+cbWidth−1, yCb+cbHeight−1).

In this way, for the current block, a corresponding first color component block needs to be determined first. Exemplarily, when the first color component is the luma component, a corresponding luma block of the current block needs to be determined here.

In operation S602, when a prediction mode for the first color component block meets a first condition, a target BV parameter of the current block is determined, and a target symmetric relationship is determined according to the target BV parameter of the current block.

In the embodiments of the disclosure, the prediction mode for the first color component block meeting the first condition may include that: it is determined that the prediction mode for the first color component block is a first prediction mode with BV information.

In the embodiments of the disclosure, the first prediction mode includes at least one of an IBC mode or an IntraTMP mode. No matter it is the IBC mode or the IntraTMP mode, the BV information is required when predictive coding is performed.

In some embodiments, the method may further include that: when the prediction mode for the first color component block does not meet the first condition, an operation of decoding a bitstream to determine a target prediction mode for the current block is not performed.

In the embodiments of the disclosure, the prediction mode for the first color component block not meeting the first condition includes that: it is determined that the prediction mode for the first color component block is a second prediction mode without BV information.

In the embodiments of the disclosure, the second prediction mode does not include an IBC mode and an IntraTMP mode. That is, the second prediction mode may be another mode other than the IBC mode and the IntraTMP mode, such as a PLANAR mode, a DM mode, a DC mode, etc.

In this way, after acquiring a corresponding luma block, it is determined whether the corresponding luma block is coded in the mode with BV information, which includes but is not limited to the IBC mode or the IntraTMP mode; if yes, BV information of the corresponding luma block is continuously acquired; if no, it is unnecessary to parse syntax elements for the prediction mode.

It may be understood that when the prediction mode for the first color component block meets the first condition, the operation of determining the target BV parameter of the current block may include that: a first BV parameter of the first color component block is determined; and the first BV parameter of the first color component block is adjusted, to determine the target BV parameter of the current block.

In the embodiments of the disclosure, if the prediction mode for the first color component block meets the first condition, the first BV parameter of the first color component block may be acquired. The first BV parameter represents a vector pointing from the current block to a reference block, and the reference block is obtained by searching a reconstruction area of a frame where the current block is located (that is, the current picture).

It should also be noted that in the embodiments of the disclosure, if there are multiple first color component blocks, the first BV parameter may also be obtained by calculating an average value of BV information of these multiple first color component blocks. Therefore, in some embodiments, the operation of determining, from these multiple blocks divided from the first color component area, the first color component block for the current block may include that: at least one candidate block at a preset position is determined from these multiple blocks divided from the first color component area, and the at least one candidate block is determined as the first color component block for the current block.

In a possible implementation, the operation of determining the first BV parameter of the first color component block may include that: at least one target block with a prediction mode meeting the first condition is determined from the at least one candidate block, and a first BV parameter of each of the at least one target block is determined; an average value is calculated according to the first BV parameter of each of the at least one target block, and a calculated result is taken as the first BV parameter of the first color component block.

Here, in the embodiments of the disclosure, the first color component block for the current block is not limited to one block, instead, may also be composed of multiple blocks. When the first color component block for the current block is composed of multiple blocks, all of prediction modes for these multiple blocks meet the first condition. Exemplarily, multiple luma blocks in the co-located luma area are acquired, and then an average value of first BV parameters of these multiple luma blocks is calculated as the first BV parameter acquired finally.

In another possible implementation, the first BV parameter acquired finally may also be determined by selecting an optimal BV parameter by a template matching manner. Therefore, in some embodiments, when the prediction mode for the first color component block meets the first condition, the operation of determining the first BV parameter of the first color component block may also include that: at least one target block using the IBC mode is determined from at least one candidate block; the at least one target block is searched according to the template matching manner, to determine the optimal BV parameter, and take the optimal BV parameter as the first BV parameter of the first color component block.

Here, still taking FIG. 9 as an example, for luma blocks at the five positions of C, TL, TR, BL and BR, when all of prediction modes for the five luma blocks meet the first condition, multiple luma blocks in the co-located luma area are acquired, and then the optimal BV parameter is selected by the template matching manner, as the first BV parameter acquired finally. Positions of these multiple luma blocks are not limited to the five positions of C, TL, TR, BL and BR, instead, may also be other positions, which is not specifically limited in the embodiments of the disclosure.

It may also be understood that after determining the first BV parameter of the first color component block, the BV parameter applied to the chroma component, that is, the target BV parameter of the current block may be determined accordingly. The target BV parameter of the current block may be obtained by adjusting the first BV parameter of the first color component block in a manner including but are not limited to the following contents.

In a possible implementation, the operation of adjusting the first BV parameter of the first color component block, to determine the target BV parameter of the current block may include that: the first BV parameter of the first color component block is scaled according to a preset sampling format, to determine the target BV parameter of the current block.

In another possible implementation, the operation of adjusting the first BV parameter of the first color component block, to determine the target BV parameter of the current block may include that: the first BV parameter of the first color component block is scaled according to a preset sampling format, to obtain an initial BV parameter of the current block; and the initial BV parameter of the current block is corrected, to determine the target BV parameter of the current block.

In the embodiments of the disclosure, it is assumed that the first color component is a luma component and the second color component is a chroma component, then after acquiring the first BV parameter (that is, a luma BV parameter), the luma BV parameter may be adjusted to obtain the target BV parameter (that is, a chroma BV parameter) applied to the chroma component. It is assumed that the luma BV parameter is (BVLhor, BVLver) and the chroma BV parameter is (BVChor, BVCver), here the BVLhor represents a horizontal BV of the luma BV parameter, and the BVLver represents a vertical BV of the luma BV parameter; the BVChor represents a horizontal BV of the chroma BV parameter, and the BVCver represents a vertical BV of the chroma BV parameter.

In this way, the luma BV parameter is scaled according to the preset sampling format, and a mapping relationship between the luma BV parameter and the scaled chroma BV parameter is shown in Table 9.

TABLE 9

| | color sampling | | |
|---|---|---|---|
| sps_chroma_format_idc | format | BVCₕₒᵣ | BVCᵥₑᵣ |
| 0 | monochrome | — | — |
| 1 | 4:2:0 | BVLₕₒᵣ>>1 | BVLᵥₑᵣ>>1 |
| 2 | 4:2:2 | BVLₕₒᵣ>>1 | BVLᵥₑᵣ |
| 3 | 4:4:4 | BVLₕₒᵣ | BVLᵥₑᵣ |

The syntax element sps_chroma_format_idc is used to indicate a type of the color sampling format, and the color sampling format here is specifically a chroma sampling format. Here, when types of the chroma sampling format are different, and scaling operations corresponding thereto are also different.

In this way, in the embodiments of the disclosure, after obtaining the chroma BV parameter scaled according to the chroma sampling format, the chroma BV parameter may be used directly, or the chroma BV parameter may be further corrected. The correction here may include but is not limited to the following manners: correction is performed by using the IntraTMP mode, that is, after obtaining the chroma BV parameter, an offset position is found by using the position information of the current block and the obtained chroma BV parameter, and then a fine search is performed in the vicinity of the offset position by using the template matching manner, to determine an optimal chroma BV parameter, and take the optimal chroma BV parameter as the chroma BV parameter obtained finally, that is, the target BV parameter of the current block.

It may also be understood that after obtaining the target BV parameter of the current block, it also needs to determine whether the target BV parameter is available, that is, whether the target BV parameter meets an availability condition. In some embodiments, the method may further include that: after determining the target BV parameter of the current block, whether the target BV parameter meets an availability condition is determined; and when the target BV parameter meets the availability condition, the operation of determining the target symmetric relationship of the current block according to the target BV parameter of the current block is performed.

Further, in some embodiments, whether the target BV parameter meets the availability condition may be determined according to at least the following:
an offset position indicated according to position information of the current block and the target BV parameter does not exceed a picture boundary;
the offset position indicated according to the position information of the current block and the target BV parameter does not cover the current block;
the offset position indicated according to the position information of the current block and the target BV parameter does not exceed a preset available area; and
the offset position indicated according to the position information of the current block and the target BV parameter has been reconstructed.

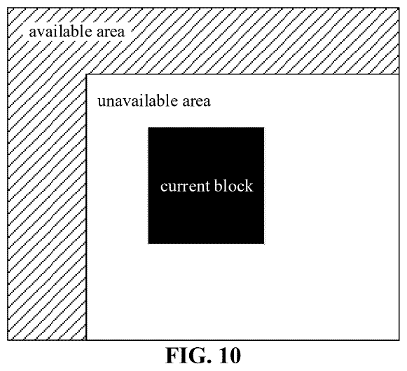

It should be understood that in the embodiments of the disclosure, only in case that all of the above conditions are met, it may be determined that the target BV parameter meets the availability condition, that is, the target BV parameter is available. Exemplarily, FIG. 10 shows a schematic structural diagram showing whether an offset position does not cover a current block according to embodiments of the disclosure. As shown in FIG. 10, a block filled with black represents the current block, an area filled with oblique lines represents an available area, and an unfilled area represents an unavailable area. For the current block, if the offset position indicated by the target BV parameter is in the unavailable area, a situation where the offset position covers the current block may occur.

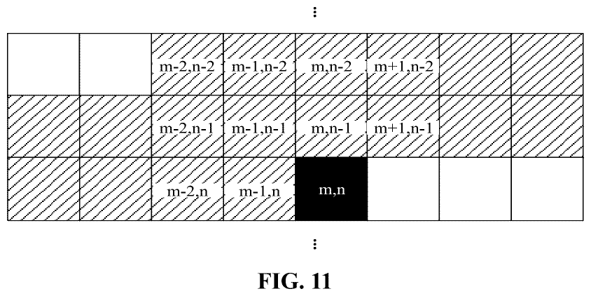

Exemplarily, FIG. 11 shows a schematic structural diagram showing whether an offset position exceeds an available area for the IBC according to embodiments of the disclosure. As shown in FIG. 11, a block filled with black represents the current block, an area filled with oblique lines represents an available area, and reference blocks in the available area have been reconstructed. In the embodiments of the disclosure, storage capacity of a buffer is considered, then in a normal situation, these reference blocks adjacent to the current block (m, n), specifically a reference block (m−2, n−2), a reference block (m−1, n−2), a reference block (m, n−2), a reference block (m+1, n−2), a reference block (m−2, n−1), a reference block (m−1, n−1), a reference block (m, n−1), a reference block (m+1, n−1), a reference block (m−2, n), a reference block (m−1, n), or the like may be taken as the available area for the DBV mode.

It should also be understood that in the embodiments of the disclosure, after the first BV parameter of the first color component block is scaled according to the preset sampling format, the obtained initial BV parameter needs to be further corrected. Before correction, the method may further include that: whether the initial BV parameter meets an availability condition is determined; and when the initial BV parameter meets the availability condition, the initial BV parameter of the current block is corrected, to determine the target BV parameter of the current block; or, when the initial BV parameter does not meet the availability condition, the initial BV parameter of the current block is adjusted, until the adjusted BV parameter meets the availability condition; and then the adjusted BV parameter is corrected, to determine the target BV parameter of the current block.

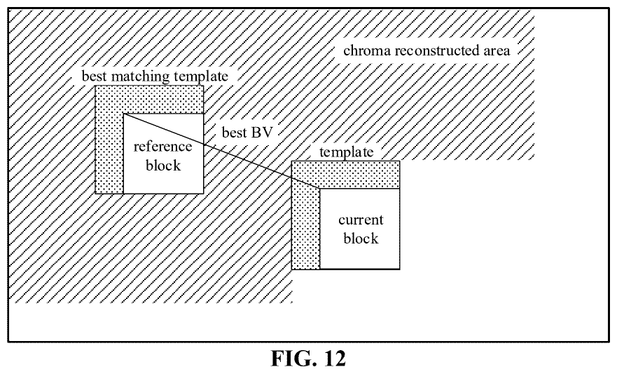

Exemplarily, after obtaining the chroma BV parameter scaled according to the preset sampling format, if the chroma BV parameter meets the availability conditions, the chroma BV parameter is corrected by using template search. That is, after obtaining the corrected chroma BV parameter, an offset position is found by using the position of the current block and the corrected chroma BV parameter, and then a fine search is performed in the vicinity of the offset position by using the template matching manner, to obtain an optimal chroma BV parameter. Next, a reference block at an optimal offset position obtained after the fine search is copied, to obtain a chroma prediction block for the current block. As shown in FIG. 12, an area filled with oblique lines represents a chroma reconstruction area. For the current block, an optimal matching template and a corresponding optimal BV may be found by using the template matching manner, and the reference block at the optimal offset position obtained according to the optimal BV is copied, such that a chroma predicted value of the current block may be determined.

It may also be understood that in the embodiments of the disclosure, it also needs to determine the symmetric relationship. In a possible implementation, the operation of determining the target symmetric relationship according to the target BV parameter of the current block may include that: a first co-located area corresponding to the current block is determined; a reference block is determined according to the target BV parameter, and a second co-located area corresponding to the reference block is determined; error calculation for at least one symmetric relationship is performed according to the first co-located area and the second co-located area, to obtain error values for the at least one symmetric relationship; and the target symmetric relationship is determined from the at least one symmetric relationship according to the error values for the at least one symmetric relationship.

Further, in some embodiments, the operation of performing, according to the first co-located area and the second co-located area, the error calculation for the at least one symmetric relationship, to obtain the at least one error value for the at least one symmetric relationship may include that: transformation about a first symmetric relationship is performed on the second co-located area, to determine a transformed second co-located area; and a symmetric error between the transformed second co-located area and the first co-located area is calculated according to a preset error criterion, to determine an error value for the first symmetric relationship. The first symmetrical relationship is any one of the at least one symmetrical relationship.

In another possible implementation, the operation of determining the target symmetric relationship according to the target BV parameter of the current block may include that: a first adjacent area corresponding to the current block is determined; a reference block is determined according to the target BV parameter, and a second adjacent area corresponding to the reference block is determined; error calculation for at least one symmetric relationship is performed according to the first adjacent area and the second adjacent area, to obtain at least one error value for the at least one symmetric relationship; and the target symmetric relationship is determined from the at least one symmetric relationship according to the at least one error value for the at least one symmetric relationship.

Further, in some embodiments, the operation of performing, according to the first adjacent area and the second adjacent area, the error calculation for the at least one symmetric relationship, to obtain the at least one error value for the at least one symmetric relationship may include that: transformation about a first symmetric relationship is performed on the second adjacent area, to determine a transformed second adjacent area; and a symmetric error between the transformed second adjacent area and the first adjacent area is calculated according to a preset error criterion, to determine an error value for the first symmetric relationship. The first symmetrical relationship is any one of the at least one symmetrical relationship.

It should be understood that in the embodiments of the disclosure, the at least one symmetric relationship includes at least one of no symmetric relationship, a vertical symmetric relationship, or a horizontal symmetric relationship.

It should be understood that in the embodiments of the disclosure, the preset error criterion includes at least one of a Sum of Absolute Differences (SAD), a Sum of Absolute Transformed Differences (SATD), a Sum of Squared Errors (SSE), a Mean Absolute Difference (MAD), a Mean Absolute Error (MAE), a Mean Squared Error (MSE), or a Rate Distortion Optimization function (RDO).

It should also be understood that in the embodiments of the disclosure, the operation of determining the target symmetric relationship from the at least one symmetric relationship according to the at least one error value for the at least one symmetric relationship may include that: a minimum error value is selected from the at least one error value for the at least one symmetric relationship, and a symmetric relationship corresponding to the minimum error value is taken as the target symmetric relationship.

Further, in the embodiments of the disclosure, the method may further include that: the target symmetric relationship is stored in a preset buffer, such that the target symmetric relationship may be directly acquired later, without re-deriving the symmetric relationship. Therefore, in yet another possible implementation, the operation of determining the target symmetric relationship according to the target BV parameter of the current block may include that: a target symmetric relationship of the first color component block is acquired from a preset buffer, to determine the target symmetric relationship. The target symmetric relationship is used to indicate a symmetric relationship between a first co-located area where the first color component block is located and a second co-located area indicated by the target BV parameter.

It should be noted that the symmetric relationship will be described in detail below with reference to three specific embodiments.

In a specific embodiment, the symmetric relationship is derived according to the co-located luma area corresponding to the current chroma block.

<1> The co-located luma area corresponding to the current chroma block is acquired.

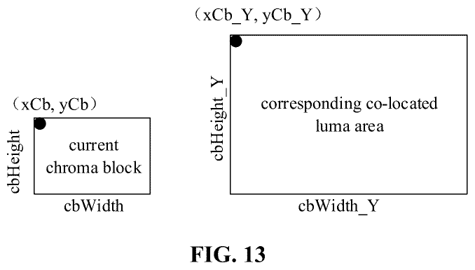

As shown in FIG. 13, the position of the current chroma block chromaPos=(xCb, yCb) is acquired, and the chromaPos is scaled according to the chroma sampling format, to obtain the position of the co-located luma area corresponding to the current chroma block, lumaPos=(xCb_Y, yCb_Y). Table 10 shows an example of scaling the chromaPos according to the chroma sampling format.

TABLE 10

| | color sampling | | |
|---|---|---|---|
| sps_chroma_format_idc | format | xCb_Y | yCb_Y |
| 0 | monochrome | — | — |
| 1 | 4:2:0 | xCb<<1 | yCb<<1 |
| 2 | 4:2:2 | xCb<<1 | yCb |
| 3 | 4:4:4 | xCb | yCb |

A size of the current chroma block chromaSize=(cbWidth, cbHeight) is acquired, and the chromaSize is scaled according to the chroma sampling format, to obtain a size of the co-located luma area corresponding to the current chroma block, lumaSize=(cbWidth_Y, cbHeight_Y). Table 11 shows an example of scaling the chromaPos according to the chroma sampling format.

TABLE 11

| | color sampling | | |
|---|---|---|---|
| sps_chroma_format_idc | format | cbWidth_Y | cbHeight_Y |
| 0 | monochrome | — | — |
| 1 | 4:2:0 | cbWidth<<1 | cbHeight<<1 |
| 2 | 4:2:2 | cbWidth<<1 | cbHeight |
| 3 | 4:4:4 | cbWidth_Y | cbHeight |

<2> A reference chroma block at an offset position corresponding to the chroma BV is acquired.

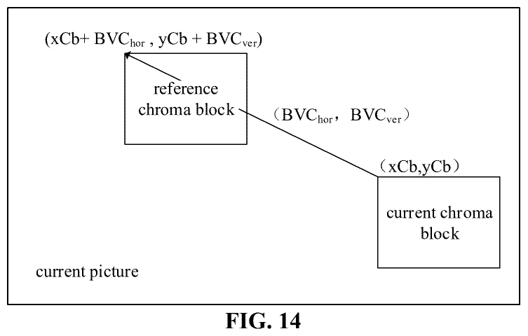

A position (xCb, yCb) of the current chroma block is acquired, a chroma BV=(BVCₕₒᵣ, BVCᵥₑᵣ) is acquired, to find a corresponding offset position (xCb+BVCₕₒᵣ, yCb+BVCᵥₑᵣ), as shown in FIG. 14.

<3> A co-located luma area corresponding to the reference chroma block in <2> is acquired.

The co-located luma area corresponding to the reference chroma block is obtained according to the method for <1>.

<3> The symmetric relationship is derived.

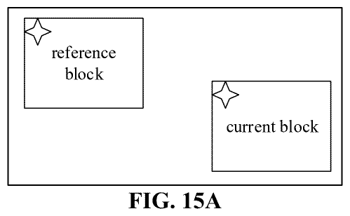

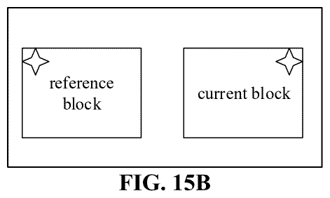

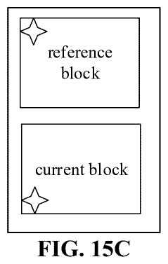

In the embodiments of the disclosure, predefined symmetric relationships include but are not limited to the following symmetric relationships: no symmetry, horizontal symmetry, vertical symmetry, etc. The following figures represent symmetric relationships of samples in different blocks by using a corresponding positional relationship of a four-pointed star. FIG. 15A shows a schematic diagram of no symmetry within blocks, FIG. 15B shows a schematic diagram of horizontal symmetry of samples within blocks, and FIG. 15C shows a schematic diagram of vertical symmetry of samples within blocks.

Errors for the predefined symmetric relationships are calculated for the co-located luma area corresponding to the current chroma block obtained in <1> and the co-located luma area corresponding to the reference chroma block obtained in <3> respectively. Error evaluation criteria includes but are not limited to SAD and MSE or the like. Then a symmetric relationship is derived according to the calculated errors. A specific process is that: transformation about predefined symmetric types is performed on the co-located luma area corresponding to the reference chroma block respectively, then errors relative to the co-located luma area corresponding to the current chroma block are calculated respectively. The symmetric relationship derived here is stored to be used in subsequent processes of the embodiments of the disclosure.

It is assumed that the size of the luma area is lumaSize=(cbWidth_Y, cbHeight_Y), a luma reconstructed sample of the co-located luma area corresponding to the current chroma block is CurLumaSamples[x][y], x=0 . . . cbWidth_Y−1, y=0 . . . cbHeight_Y−1; a luma reconstructed sample of the co-located luma area corresponding to the reference chroma block is RefLumaSamples[x][y], x=0 . . . cbWidth_Y−1, y=0 . . . cbHeight_Y−1. Taking the error evaluation criterion of the SAD as an example: taking the horizontal symmetric relationship as an example, a method for calculating the error is listed as shown in the following formula:

$$SAD = {\sum }_{y} \text{} {\sum }_{x} \text{} \vert CurLmuaSample s [ x ] [ y ] - RefLumaSamples [ cbWidth\_Y - x - 1 ] [ y ] \vert$$

Taking the vertical symmetric relationship as an example, a method for calculating the error is listed as shown in the following equation formula:

$$SAD = {\sum }_{y} \text{} {\sum }_{x} \text{} \vert CurLmuaSample s [ x ] [ y ] - RefLumaSamples [ x ] [ cbHeight\_Y - y - 1 ] \vert$$

In another specific embodiment, the symmetric relationship is derived according to the co-located luma area corresponding to the current chroma block. Here, explanations are made by taking the top-left block of the co-located luma area shown in FIG. 7 as an example.

A symmetric relationship for the luma block at this position is obtained, that is, a symmetric relationship between the luma block area and a reference luma area corresponding to the luma BV=(BVLₕₒᵣ, BVLᵥₑᵣ) acquired above. The symmetric relationship has been stored in advance in a process of a RDO decision of the luma component or the like, that is, in the embodiments of the disclosure, it is unnecessary to re-derive the symmetric relationship at this stage, and the symmetric relationship may be directly acquired. The symmetric relationship is stored to be used in subsequent processes of the embodiments of the disclosure.

In yet another specific embodiment, the symmetric relationship is derived according to a template of the current chroma block (that is, an adjacent area).

<1> A reference chroma block at an offset position corresponding to the chroma BV is acquired.

A position (xCb, yCb) of the current chroma block is acquired, a chroma BV=(BVCₕₒᵣ, BVCᵥₑᵣ) is acquired to found a corresponding offset position (xCb+BVCₕₒᵣ, yCb+BVCᵥₑᵣ).

<2> A template is acquired.

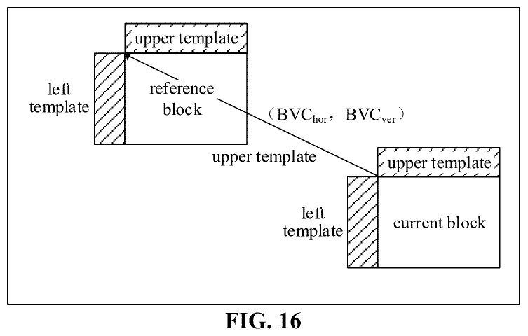

Templates for the current chroma block and the reference chroma block are acquired, and include but are not limited to positions of templates shown in FIG. 16, such as an upper template adjacent to an upper side and a left template adjacent to a left side.

<3> The symmetric relationship is derived.

Errors for the predefined symmetric relationships are calculated for the template of the current chroma block and the template of the reference chroma block obtained in <2> respectively. Error evaluation criteria include but are not limited to SAD and MSE or the like. Then, a symmetric relationship is derived according to the calculated errors. A specific process is that: transformation about predefined symmetric types is performed on a template area corresponding to the reference chroma block respectively, then errors relative to a template area corresponding to the current chroma block are calculated respectively. The symmetric relationship derived here is stored to be used in subsequent processes of the main technical solution.

It is assumed that a chroma size of an upper template area corresponding to the current block is TemplateSize=(tmpWidth, tmpHeight), a chroma sample of the upper template area corresponding to the current block is CurTemplateSamples[x][y], x=0 . . . tmpWidth−1, y=0 . . . tmpHeight−1; a chroma sample of the template area corresponding to the reference block is RefTemplateSamples[x][y], x=0 . . . tmpWidth−1, y=0 . . . tmpHeight−1. Taking the error evaluation criterion of the SAD as an example: taking the horizontal symmetric relationship as an example, a method for calculating the error is listed as shown in the following formula:

$$SAD = {\sum }_{y} {\sum }_{x} \vert CurLmuaSample s [ x ] [ y ] - RefTemplateSamples [ tempWidth - x - 1 ] [ y ] \vert$$

In operation S603, a second color component of the current block is predicted according to the target BV parameter, to determine a predicted value of the second color component of the current block.

It should be noted that in the embodiments of the disclosure, the DBV mode may refer to a prediction mode newly introduced in the embodiments of the disclosure, and may be represented by DBV In this prediction mode, the second color component of the current block is predicted according to the determined target BV parameter, thereby determining the predicted value of the second color component of the current block.

In some embodiments, the operation of predicting, according to the target BV parameter, the second color component of the current block, to determine the predicted value of the second color component of the current block may include that: an offset position of the current block is determined according to the target BV parameter and position information of the current block; block copy is performed according to the offset position of the current block, to obtain a first prediction block; and the predicted value of the second color component of the current block is determined according to the first prediction block.

In some embodiments, the operation of determining the predicted value of the second color component of the current block according to the first prediction block may include that: a correction operation is performed on the first prediction block, to determine the predicted value of the second color component of the current block.

It should be noted that in the embodiments of the disclosure, the correction operation may include a clip operation, a filtering operation, an operation of weighting with predicted values obtained in other prediction modes, or the like, which is not limited in any way.

It should also be noted that in the embodiments of the disclosure, a BV-based chroma prediction includes but is not limited to the following manners.

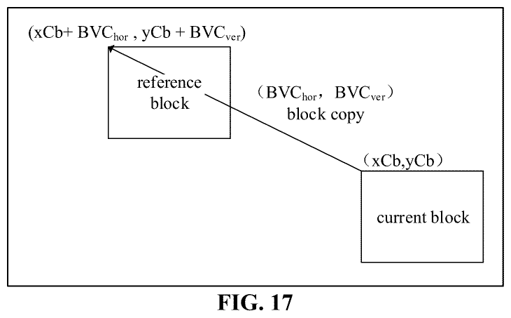

In a possible implementation, a position (xCb, yCb) of the current block is acquired, a chroma BV=(BVCₕₒᵣ, BVCᵥₑᵣ) is acquired, to find a corresponding offset position (xCb+BVCₕₒᵣ, yCb+BVCᵥₑᵣ), and block copy is performed to determine the reference block, which is specifically shown in FIG. 17.

A variable cbWidth specifies a width of the current block in the chroma samples, a variable cbHeight specifies a height of the current coding block in the chroma sample, and a variable cIdx specifies an index of a color component of the current block.

$$For x = xCb … xCb + cbWidth - 1 and y = yCb … yCb + cbHeight - 1 :$$

$$xVb = ( x + {BVC}_{h o r} ) \& ( BufWidthC - 1 )$$

$$yVb = ( y + {BVC}_{v e r} ) \& ( CtbSizeC - 1 )$$

$$predSamples [ cIdx ] [ x ] [ y ] = function ( VirChromaBuf [ cIdx ] [ xVb ] [ yVb ] )$$

Here the BufWidthC is a width of chroma pixels in a stored reconstructed buffer, the CtbSizeC is a size of a chroma pixel of the CTU, and the VirChromaBuf is stored reconstructed chroma pixels. The function( ) is a function for processing pixel values, which may be direct copy, or a shift operation to ensure calculation accuracy, or a filtering operation, etc.

In another possible implementation, a position (xCb, yCb) of the current chroma block is acquired, a chroma BV=(BVCₕₒᵣ, BVCᵥₑᵣ) is acquired, to find a corresponding offset position (xCb+BVCₕₒᵣ, yCb+BVCᵥₑᵣ). Then block copy is performed and the copied value is corrected to obtain a final predicted value. The correction operation includes but is not limited to an operation of performing weighting operation with predicted values obtained in a CCLM-type mode or other modes, etc.

In operation S604, a reconstructed value of the second color component of the current block is determined according to the predicted value of the second color component of the current block and the target symmetric relationship.

In the embodiments of the disclosure, for determination of the reconstructed value, in a possible implementation, the operation of determining the reconstructed value of the second color component of the current block according to the predicted value of the second color component of the current block and the target symmetric relationship may include that: a bitstream is decoded to determine a residual value of the second color component of the current block; an initial reconstructed value of the second color component of the current block is determined according to the predicted value of the second color component of the current block and the residual value of the second color component of the current block; and the initial reconstructed value is transformed according to the target symmetric relationship, to determine the reconstructed value of the second color component of the current block.

It should be noted that a transformed predicted value of the second color component of the current block is obtained by parsing the bitstream. The operation of determining the initial reconstructed value of the second color component of the current block according to the predicted value of the second color component of the current block and the residual value of the second color component of the current block may include that: an addition operation is performed according to the predicted value of the second color component of the current block and the residual value of the second color component of the current block, to determine the initial reconstructed value of the second color component of the current block.

Exemplarily, the predicted value (that is, the predicted sample) and the residual value (that is, the residual sample) obtained above are added together, to obtain the initial reconstructed value (that is, the reconstructed sample), and then the reconstructed sample is processed according to the target symmetric relationship, to obtain a real reconstructed sample. Specific processing includes but is not limited to the following manners.

First manner: residual data in the bitstream is data after a symmetric operation, and it needs to perform the symmetric operation on reconstructed pixels during reconstruction.

If the target symmetric relationship is no symmetry, then:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies predicted samples of the current block; and an array resiSamples, which specifies prediction residual samples of the current block.

Output is: an array of reconstructed samples of the current block, recChromaBuf.

A derivation process is as follows.

$$For x = xCb … xCb + cbWidth - 1 and y = yCb … yCb + cbHeight - 1 :$$

$$xVb = x \& ( recBufWidthC - 1 )$$

$$xVb = y \& ( recBufHeightC - 1 )$$

$$recChromaBuf [ cIdx ] [ xVb ] [ yVb ] = funcAdd ( predSamples [ cIdx ] [ x ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf Processing of special situations such as lumamappingwithchromascaling (LMCS) or the like is considered, then the function funcAdd( ) may perform addition directly, or may perform addition after processing data therein, or may perform further processing after the addition is completed, etc.

If the target symmetric relationship is horizontal symmetry, then:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: an array of reconstructed samples of the current block, recChromaBuf.

A derivation process is as follows.

$$For x = xCb … xCb + cbWidth - 1 , y = yCb … yCb + cbHeight - 1 , and xTemp = xCb + cbWidth - 1 … xCb :$$

$$xVb = xTemp \& ( recBufWidthC - 1 )$$

$$xVb = y \& ( recBufHeightC - 1 )$$

$$recChromaBuf [ cIdx ] [ xVb ] [ yVb ] = funcAdd ( predSamples [ cIdx ] [ x ] [ y ] , resiSamples [ x ] [ y ] )$$

The recChromaBuf is for stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: an array of reconstructed samples of the current block, recChromaBuf.

A derivation process is as follows.

$$For x = xCb … xCb + cbWidth - 1 , y = yCb … yCb + cbHeight - 1 , and y Temp = yCb + cbHeight - 1 … yCb :$$

$$xVb = x \& ( recBufWidthC - 1 )$$

$$xVb = yTemp \& ( recBufHeightC - 1 )$$

$$recChromaBuf [ cIdx ] [ xVb ] [ yVb ] = funcAdd ( predSamples [ cIdx ] [ x ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

Second manner: it needs to perform the symmetric operation on reconstructed values during reconstruction, however, it is divided into two steps.

A two-step transformation is required here. A temporary buffer is used to store reconstructed samples of the current block after symmetry, and then the temporary buffer is written into the reconstructed buffer.

First step: the reconstructed samples are stored in the temporary buffer.

If the target symmetric relationship is no symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: a temporary buffer of reconstructed chroma pixels, tempBuf.

A derivation process is as follows.

$$For x = xCb … xCb + cbWidth - 1 and y = y Cb … yCb + cbHeight - 1 :$$

$$xVb = x \& ( tempBufWidthC - 1 )$$

$$yVb = y \& ( tempBufHeightC - 1 )$$

$$tempBuf [ cIdx ] [ xVb ] [ yVb ] = funcAdd ( predSamples [ cIdx ] [ x ] [ y ] , resiSamples [ x ] [ y ] )$$

The tempBuf is a temporary buffer created to store the reconstructed chroma pixels of the current block. The tempBufWidthC is a width of the tempBuf and the tempBufHeightC is a height of the tempBuf. The function funcAdd( ) may perform addition directly, or may perform addition after processing data therein, or may perform further processing after the addition is completed, etc.

If the target symmetric relationship is horizontal symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: a temporary buffer of reconstructed chroma pixels, tempBuf.

A derivation process is as follows.

$$For x = xCb … xCb + cbWidth - 1 , y = y Cb … yCb + cbHeight - 1 , and xTemp = xCb + cbWidth - 1 … xCb :$$

$$xVb = xTemp \& ( tempBufWidthC - 1 )$$

$$yVb = y \& ( tempBufHeightC - 1 )$$

$$tempBuf [ cIdx ] [ xVb ] [ yVb ] = funcAdd ( predSamples [ cIdx ] [ x ] [ y ] , resiSamples [ x ] [ y ] )$$

The tempBuf is a temporary buffer created to store the reconstructed chroma pixels of the current block. The tempBufWidthC is a width of the tempBuf and the tempBufHeightC is a height of the tempBuf. The function funcAdd( ) may perform addition directly, or may perform addition after processing data therein, or may perform further processing after the addition is completed, etc.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: a temporary buffer of reconstructed chroma pixels, tempBuf.

A derivation process is as follows.

$$For x = xCb ... xCb + cbWidth - 1 , y = yCb ... yCb + cbHeight - 1 , and yTemp = yCb + cbHeight - 1 ... yCb :$$

$$xVb = x \& ( tempBufWidthC - 1 )$$

$$yVb = yTemp \& ( tempBufHeightC - 1 )$$

$$tempBuf [ cIdx ] [ xVb ] [ y Vb ] = func ( predSamples [ cIdx ] [ x ] [ y ] , resiSamples [ x ] [ y ] )$$

The tempBuf is a temporary buffer created to store the reconstructed chroma pixels of the current block. The tempBufWidthC is a width of the tempBuf and the tempBufHeightC is a height of the tempBuf. The function funcAdd( ) may perform addition directly, or may perform addition after processing data therein, or may perform further processing after the addition is completed, etc.

Second step: the temporary buffer is written into the reconstructed buffer.

Inputs are: a variable picWidth, which specifies a width of the current picture in the chroma samples; a variable picHeight, which specifies a height of the current picture in the chroma samples; a variable cIdx, which specifies an index of a color component of the current block; and a temporary buffer of reconstructed chroma pixels, tempBuf.

Output is: an array of reconstructed samples, recPicChromaBuf.

$$For x = 0 ... picWidth - 1 and y = 0 ... picHeight - 1 :$$

$$xVb = x \& ( recBufWidthC - 1 )$$

$$yVb = y \& ( recBufHeightC - 1 )$$

$$recPicChromaBuf [ cIdx ] [ xVb ] [ yVb ] = tempBuf [ cIdx ] [ x ] [ y ]$$

The recPicChromaBuf is stored reconstructed chroma pixels. The recBufWidthC is a width of chroma pixels in a stored reconstructed pixel buffer, that is, a width of the recPicChromaBuf. The recBufHeightC is a height of the chroma pixels in the stored reconstructed pixel buffer, that is, a height of the recPicChromaBuf.

In the embodiments of the disclosure, for determination of the reconstructed value, in another possible implementation, the operation of determining the reconstructed value of the second color component of the current block according to the predicted value of the second color component of the current block and the target symmetric relationship may include that: the predicted value of the second color component of the current block is transformed according to the target symmetric relationship, to determine a transformed predicted value of the second color component of the current block; a bitstream is decoded to determine a residual value of the second color component of the current block; and the reconstructed value of the second color component of the current block is determined according to the transformed predicted value of the second color component of the current block and the residual value of the second color component of the current block.

It should be noted that the transformed predicted value of the second color component of the current block is obtained by parsing the bitstream. The operation of determining the reconstructed value of the second color component of the current block according to the transformed predicted value of the second color component of the current block and the residual value of the second color component of the current block may include that: an addition operation is performed according to the transformed predicted value of the second color component of the current block and the residual value of the second color component of the current block, to determine the reconstructed value of the second color component of the current block.

Exemplarily, the predicted samples are transformed according to the target symmetric relationship and added to the residual samples, to obtain the reconstructed samples.

First manner: the predicted samples after the symmetric operation are acquired, and then the reconstructed samples are acquired.

<1> Transformed predicted samples are acquired.

The transformed predicted samples are obtained according to the target symmetric relationship and the acquired predicted samples in a manner which includes but is not limited to the following manners.

If the target symmetric relationship is no symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and an array of predicted samples of the current block, predSamples.

Output is: an array of transformed predicted samples of the current block, predTrsSamples.

A derivation process is as follows.

$$For x = xCb ... xCb + cbWidth - 1 and y = yCb ... yCb + cbHeight - 1 :$$

$$xVb = x \& ( predSamplesWidthC - 1 )$$

$$yVb = y \& ( predSamplesHeightC - 1 )$$

$$predTrsSamples [ cIdx ] [ x ] [ y ] = predSamples [ cIdx ] [ xVb ] [ yVb ]$$

The predSamples is stored predicted chroma pixels, the predSamplesWidthC is a width of the predSamples, and the predSamplesHeightC is a height of the predSamples.

If the target symmetric relationship is horizontal symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and an array of predicted samples of the current block, predSamples.

Output is: an array of transformed predicted samples of the current block, predTrsSamples.

A derivation process is as follows.

$$For x = xCb ... xCb + cbWidth - 1 , y = yCb ... yCb + cbHeight - 1 , and xTemp = xCb + cbWidth - 1 ... xCb :$$

$$xVb = xTemp \& ( predSamplesWidthC - 1 )$$

$$yVb = y \& ( predSamplesHeightC - 1 )$$

$$predTrsSamples [ cIdx ] [ x ] [ y ] = predSamples [ cIdx ] [ xVb ] [ yVb ]$$

The predSamples is stored predicted chroma pixels, the predSamplesWidthC is a width of the predSamples, and the predSamplesHeightC is a height of the predSamples.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and an array of predicted samples of the current block, predSamples.

Output is: an array of transformed predicted samples of the current block, predTrsSamples.

A derivation process is as follows.

$$For x = xCb … xCb + cbWidth - 1 , y = yCb … yCb + cbHeight - 1 , and yTemp = yCb + c b H e i g h t - 1 … yCb : \\ xVb = x \& ( predSamplesWidthC - 1 ) \\ yVb = yTemp \& ( predSamplesHeightC - 1 ) \\ PredTrs Samples [ cIdx ] [ x ] [ y ] = p r e d S a m p l e s [ cIdx ] [ x V b ] [ y V b ]$$

The predSamples is stored predicted chroma pixels, the predSamplesWidthC is a width of the predSamples, and the predSamplesHeightC is a height of the predSamples.

<2> The reconstructed samples are acquired.

The transformed predicted samples and the residual samples obtained above are added together, to obtain the reconstructed samples recSamples, and then real reconstructed samples recChromaBuf are obtained.

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: an array of reconstructed samples of the current block, recChromaBuf.

A derivation process is as follows.

$$For x = xCb … xCb + c b W i d t h - 1 and y = yCb … yCb + c b H e i g h t - 1 : \\ xVb = x \& ( recBufWidthC - 1 ) \\ yVb = y \& ( recBufHeightC - 1 ) \\ recChromaBuf [ cIdx ] [ x V b ] [ y V b ] = funcAdd ( predSamples [ cIdx ] [ x ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

Second manner: the predicted samples are acquired directly, and then the reconstructed samples are acquired after the symmetric operation.

<1> The predicted samples are acquired.

<2> The reconstructed samples are acquired.

If the target symmetric relationship is no symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: an array of reconstructed samples of the current block, recChromaBuf.

A derivation process is as follows.

$$For x = xCb … xCb + c b W i d t h - 1 and y = yCb … yCb + c b H e i g h t - 1 : \\ xVb = x \& ( recBufWidthC - 1 ) \\ yVb = y \& ( recBufHeightC - 1 ) \\ recChromaBuf [ cIdx ] [ x V b ] [ y V b ] = funcAdd ( predSamples [ cIdx ] [ x ] [ y ] , resiSamples [ x ] [ y ] )$$

The recChromaBuf is stored reconstructed chroma pixels, the recBufWidthC is a width of chroma pixels in a stored reconstructed pixel buffer, that is, a width of the recChromaBuf, and the recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

If the target symmetric relationship is horizontal symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: an array of reconstructed samples of the current block, recChromaBuf.

A derivation process is as follows.

$$For x = xCb … xCb + c b W i d t h - 1 , y = yCb … yCb + c b H e i g h t - 1 , and xTemp = xCb + cbWidth - 1 … xCb : \\ xVb = x \& ( recBufWidthC - 1 ) \\ yVb = y \& ( recBufHeightC - 1 ) \\ recChromaBuf [ cIdx ] [ x V b ] [ y V b ] = funcAdd ( predSamples [ cIdx ] [ xTemp ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; an array predSamples, which specifies reconstructed predicted samples of the current block; and an array resiSamples, which specifies prediction residual samples of the current block.

Output is: an array of reconstructed samples of the current block, recChromaBuf.

A derivation process is as follows.

$$For x = xCb … xCb + c b W i d t h - 1 , y = yCb … yCb + c b H e i g h t - 1 , and yTemp = yCb + c b H e i g h t - 1 … yCb : \\ xVb = x \& ( recBufWidthC - 1 ) \\ yVb = y \& ( recBufHeightC - 1 ) \\ recChromaBuf [ cIdx ] [ x V b ] [ y V b ] = funcAdd ( predSamples [ cIdx ] [ x ] [ yTemp ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

It may also be understood that in the embodiments of the disclosure, the method may further include that: a bitstream is decoded to determine a target prediction mode for the current block; and when the target prediction mode indicates that the second color component of the current block is allowed to use a DBV mode, the operation of determining the target BV parameter of the current block is performed, that is, the operation S602 in FIG. 6 is performed.

In some embodiments, the operation of decoding the bitstream to determine the target prediction mode for the current block may include that: the bitstream is decoded to determine a value of identification information of a first syntax element; if the value of identification information of the first syntax element is a first value, it is determined that the target prediction mode for the current block is the DBV mode; if the value of identification information of the first syntax element is a second value, it is determined that the target prediction mode for the current block is another prediction mode other than the DBV mode.

In the embodiments of the disclosure, the identification information of the first syntax element may be intra_dbv_flag. Furthermore, in the dual-tree partition, in the DM mode, if a corresponding luma area has BV information, the current chroma block is predicted by using the DBV mode. For example:

If CuPredMode[0][xCb+cbWidth/2][yCb+cbHeight/2] is equal to MODE_IBC, intra_dbv_flag=1 is set, then the chroma intra prediction mode IntraPredModeC[xCb][yCb] uses the DBV mode.

If CuPredMode[0][xCb+cbWidth/2][yCb+cbHeight/2] is equal to MODE_INTRA, if IntraTmpFlag[xCb+cbWidth/2][yCb+cbHeight/2] is equal to 1, intra_dbv_flag=1 is set, then the chroma intra prediction mode IntraPredModeC[xCb][yCb] uses the DBV mode.

Further, in the embodiments of the disclosure, the chroma prediction mode is derived as follows.

The chroma intra prediction mode IntraPredModeC[xCb][yCb] uses cclm_mode_flag, cclm_mode_idx, intra_chroma_pred_mode, lumaIntraPredMode and lumaTempPredMode specified in the following table. These filling items other than the DBV mode are corresponding values given exemplarily, and it is not that they must be filled with these values. Table 12 shows an example of deriving the chroma prediction mode. In Table 12, 0 represents a Planar mode, 1 represents DC, 18 represents a horizontal prediction mode, 50 represents a vertical prediction mode, and 81 to 83 represent a CCLM prediction mode.

TABLE 12

| | | | lumaIntraPredMode | | | | | |
|---|---|---|---|---|---|---|---|---|
| | | | (intra_dbv_flag == 0) | | | | | |
| cclm_mode_{—} | cclm_mode_{—} | intra_chroma_{—} | | | | | X | intra_dbv_{—} |
| flag | idx | pred_mode | 0 | 50 | 18 | 1 | (0 <= X <= 66) | flag == 1 |
| 0 | — | 0 | 66 | 0 | 0 | 0 | 0 | 0 |
| 0 | — | 1 | 50 | 66 | 50 | 50 | 50 | 50 |
| 0 | — | 2 | 18 | 18 | 66 | 18 | 18 | 18 |
| 0 | — | 3 | 1 | 1 | 1 | 66 | 1 | 1 |
| 0 | — | 4 | 0 | 50 | 18 | 1 | X | DBV |
| 1 | 0 | — | 81 | 81 | 81 | 81 | 81 | 81 |
| 1 | 1 | — | 82 | 82 | 82 | 82 | 82 | 82 |
| 1 | 2 | — | 83 | 83 | 83 | 83 | 83 | 83 |

It may be seen from Table 12 that in the DM mode, if intra_ibc_flag==1, that is, information acquired from the block at the center position of the co-located luma area includes the BV, the chroma intra prediction mode IntraPredModeC[xCb][yCb] uses the DBV mode.

In some embodiments, the method may further include that: a first co-located area corresponding to the current block is determined; and if any position in the first co-located area has BV information, it is determined that the second color component of the current block is allowed to use the DBV mode.

In the embodiments of the disclosure, a determination condition of the DM manner may be that there is BV information at any position in the entire corresponding luma area, which is described as follows.

In the DM mode, if the prediction information of the corresponding luma area includes the BV information, the current chroma block is coded in the DBV mode. For example:

If for x=xCb . . . xCb+cbWidth−1, y=yCb . . . yCb+cbHeight−1, there is any pair of (x, y) making CuPredMode[0][x][y] equal to MODE_IBC, then Intra_DBV_flag is set to 1, and the chroma intra prediction mode IntraPredModeC[xCb][yCb] uses the DBV mode in such a case.

If for x=xCb . . . xCb+cbWidth−1, y=yCb . . . yCb+cbHeight−1, there is any pair of (x, y) making CuPredMode[0][x][y] equal to MODE_INTRA, and IntraTmpFlag[x][y] is equal to 1, then Intra_DBV_flag is set to 1, and the chroma intra prediction mode IntraPredModeC[xCb][yCb] uses the DBV mode in such a case. The flag IntraTmpFlag is used to indicate whether the IntraTmp mode is used.

In some embodiments, the operation of determining the target BV parameter of the current block may include that: a bitstream is decoded to determine the target BV parameter of the current block. That is, the target BV parameter (such as the chroma BV) of the current block may also be written into the bitstream by the coding side, such that the decoding side may obtain the target BV parameter by parsing the bitstream.

In some embodiments, the operation of determining the target symmetric relationship may include that: a bitstream is decoded to determine the target symmetric relationship. That is, the determined target symmetric relationship may also be written into the bitstream by the coding side, such that the decoding side may obtain the target symmetric relationship by parsing the bitstream.

In some embodiments, the method may further include that: sub-block division is performed on the current block, to obtain at least one sub-block; and the sub-block is taken as the current block, and operations of the decoding method shown in FIG. 6 are performed, to determine the reconstructed value of the second color component of the sub-block.

It should be noted that in the embodiments of the disclosure, when processing is performed in unit of the sub-block of the current block, processing may also be performed according to the symmetric relationship of the embodiments of the disclosure, except that all of determination and processing in the operations are performed on the sub-block.

It should also be noted that in the embodiments of the disclosure, when a corresponding residual of the current block for which chroma prediction is performed in the DBV mode is transformed and inversely transformed, it includes but is not limited to the following manners: only one transformation may be performed (for example, only the DCT transformation is performed without performing LFNST), or two transformations may be performed (a primary transformation and a secondary transformation, for example, the coding side performs the DCT transformation and then performs the LFNST transformation). Forward transformation manners implemented by the decoding side and the coding side are kept consistent in a reverse order.

The embodiments of the disclosure provides a decoding method, in which a first color component block for a current block is determined; when a prediction mode for the first color component block meets a first condition, a target BV parameter of the current block is determined, and a target symmetric relationship is determined according to the target BV parameter of the current block; a second color component of the current block is predicted according to the target BV parameter, to determine a predicted value of the second color component of the current block; and a reconstructed value of the second color component of the current block is determined according to the predicted value of the second color component of the current block and the target symmetric relationship. That is, in the disclosure, available information such as reconstructed luma, BV or the like are fully considered, and chroma is predicted according to these information, which improves singleness of chroma prediction. Further, the symmetric relationship is considered and the predicted value is processed in more detail. This not only improves accuracy of the chroma prediction and saves the bit rate, but also improves coding and decoding performance and improves coding efficiency effectively.

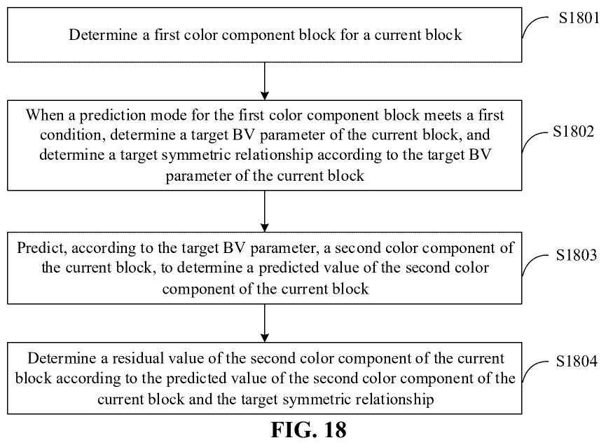

In another implementation of the disclosure, with reference to FIG. 18, a schematic flowchart of an encoding method according to embodiments of the disclosure. As shown in FIG. 18, the method may include the following operations S1801 to S1804.

In operation S1801, a first color component block for a current block is determined.

It should be noted that the encoding method of the embodiments of the disclosure is applied to an encoder. Furthermore, the encoding method may specifically refer to an intra prediction method, and more specifically, refer to a method of performing prediction by using a DBV mode. The video picture may be divided into multiple coding blocks. Each of the coding blocks may include a first color component, a second color component and a third color component, The current block in the embodiments of the disclosure refers to a coding block to be intra predicted currently from the video picture.

It should also be noted that in the embodiments of the disclosure, in a dual-tree partition, for a DM mode, when a prediction mode for a co-located luma block meets a first condition, in the embodiments of the disclosure, BV parameters applied to chroma may be derived according to BV parameters of the co-located luma block, thereby improving the coding efficiency.

In operation S1802, when a prediction mode for the first color component block meets a first condition, a target BV parameter of the current block is determined, and a target symmetric relationship is determined according to the target BV parameter of the current block.

In the embodiments of the disclosure, the prediction mode for the first color component block meeting the first condition may include that: it is determined that the prediction mode for the first color component block is a first prediction mode with BV information.

In the embodiments of the disclosure, the first prediction mode includes at least one of an IBC mode or an IntraTMP mode.

In some embodiments, the method may further include that: when the prediction mode for the first color component block does not meet the first condition, a target prediction mode for the current block is not coded.

In the embodiments of the disclosure, the prediction mode for the first color component block not meeting the first condition may include that: it is determined that the prediction mode for the first color component block is a second prediction mode without BV information. The second prediction mode does not include an IBC mode and an IntraTMP mode. That is, the second prediction mode is another mode other than the IBC mode and the IntraTMP mode, such as a PLANAR mode, a DM mode, a DC mode, etc.

In some embodiments, the operation of determining the first color component block for the current block may include that: a first co-located area corresponding to the current block is determined; and the first color component block for the current block is determined from multiple blocks divided from the first co-located area.

In some embodiments, the operation of determining the first color component block for the current block may include that: a target block is selected from these multiple blocks divided from the first co-located area, and the target block is taken as the first color component block for the current block.

In some embodiments, the operation of determining the first color component block for the current block may include that: position information of the current block is determined; the position information of the current block is scaled according to a preset sampling format, to obtain position information of a co-located area corresponding to the current block; and target position information is determined according to the position information of the co-located area, and a target block including the target position information is taken as the first color component block for the current block.

In some embodiments, the operation of determining the target position information according to the position information of the co-located area may include that: a center position is calculated according to the position information of the co-located area, and information of an obtained center position is taken as the target position information; or, a top-left position is calculated according to the position information of the co-located area, and information of an obtained top-left position is taken as the target position information; or, a lower-right position is calculated according to the position information of the co-located area, and information of an obtained lower-right position is taken as the target position information.

In the embodiments of the disclosure, the target block used as the first color component block may be a block at any position in the first co-located area. For example, it may be the block at the center position of the co-located luma area (the block filled with black) shown in FIG. 3, the block at the top-left position of the co-located luma area (the block filled with black) shown in FIG. 7, the block at the lower-right position of the co-located luma area (the block filled with black) shown in FIG. 8, or may even be a block at a top-right position of the co-located luma area, a block at a lower-left position of the co-located luma area, or may even be a block at a center position of a top-left area, or the like, which is not specifically limited here.

In some embodiments, the operation of determining the first color component block for the current block may include that: at least one candidate block at a preset position is determined from these multiple blocks divided from the first co-located area; and a target candidate block meeting a preset determination condition is determined from the at least one candidate block, and the target candidate block is taken as the first color component block for the current block.

In some embodiments, the operation of determining the target BV parameter of the current block may include that: a first BV parameter of the first color component block is determined; and the first BV parameter of the first color component block is adjusted, to determine the target BV parameter of the current block.

In some embodiments, the operation of adjusting the first BV parameter of the first color component block, to determine the target BV parameter of the current block may include that: the first BV parameter of the first color component block is scaled according to a preset sampling format, to determine the target BV parameter of the current block.

In some embodiments, the operation of adjusting the first BV parameter of the first color component block, to determine the target BV parameter of the current block may include that: the first BV parameter of the first color component block is scaled according to a preset sampling format, to obtain an initial BV parameter of the current block; and the initial BV parameter of the current block is corrected, to determine the target BV parameter of the current block.

In some embodiments, the method may further include that: after determining the target BV parameter of the current block, whether the target BV parameter meets an availability condition is determined; and when the target BV parameter meets the availability condition, the operation of determining the target symmetric relationship of the current block according to the target BV parameter of the current block is performed.

In some embodiments, whether the target BV parameter meets the availability condition may be determined according to at least the following:
an offset position indicated according to position information of the current block and the target BV parameter does not exceed an picture boundary;
the offset position indicated according to the position information of the current block and the target BV parameter does not cover the current block;
the offset position indicated according to the position information of the current block and the target BV parameter does not exceed a preset available area; and
the offset position indicated according to the position information of the current block and the target BV parameter has been reconstructed.

In a possible implementation, the operation of determining the target symmetric relationship according to the target BV parameter of the current block may include that: a first co-located area corresponding to the current block is determined; a reference block is determined according to the target BV parameter, and a second co-located area corresponding to the reference block is determined; error calculation for at least one symmetric relationship is performed according to the first co-located area and the second co-located area, to obtain at least one error value for the at least one symmetric relationship; and the target symmetric relationship is determined from the at least one symmetric relationship according to the at least one error value for the at least one symmetric relationship.

In some embodiments, the operation of performing, according to the first co-located area and the second co-located area, the error calculation for the at least one symmetric relationship, to obtain the at least one error value for the at least one symmetric relationship may include that: transformation about a first symmetric relationship is performed on the second co-located area, to determine a transformed second co-located area; and a symmetric error between the transformed second co-located area and the first co-located area is calculated according to a preset error criterion, to determine an error value for the first symmetric relationship. The first symmetrical relationship is any one of the at least one symmetrical relationship.

In another possible implementation, the operation of determining the target symmetric relationship according to the target BV parameter of the current block may include that: a first adjacent area corresponding to the current block is determined; a reference block is determined according to the target BV parameter, and a second adjacent area corresponding to the reference block is determined; error calculation for at least one symmetric relationship is performed according to the first adjacent area and the second adjacent area, to obtain at least one error value for the at least one symmetric relationship; and the target symmetric relationship is determined from the at least one symmetric relationship according to the at least one error value for the at least one symmetric relationship.

In some embodiments, the operation of performing, according to the first adjacent area and the second adjacent area, the error calculation for the at least one symmetric relationship, to obtain the at least one error value for the at least one symmetric relationship may include that: transformation about a first symmetric relationship is performed on the second adjacent area, to determine a transformed second adjacent area; and a symmetric error between the transformed second adjacent area and the first adjacent area is calculated according to a preset error criterion, to determine an error value for the first symmetric relationship. The first symmetrical relationship is any one of the at least one symmetrical relationship.

In the embodiments of the disclosure, the at least one symmetric relationship includes at least one of no symmetric relationship, a vertical symmetric relationship, or a horizontal symmetric relationship. Furthermore, in the embodiments of the disclosure, the preset error criterion may include at least one of a SAD, a SATD, a SSE, a MAD, a MAE, a MSE, or a RDO.

In some embodiments, the operation of determining the target symmetric relationship from the at least one symmetric relationship according to the at least one error value for the at least one symmetric relationship may include that: a minimum error value is selected from the at least one error value for the at least one symmetric relationship, and a symmetric relationship corresponding to the minimum error value is taken as the target symmetric relationship.

It should be noted that in the embodiments of the disclosure, after determining the target symmetric relationship, the method may further include that: the target symmetric relationship is stored in a preset buffer, such that the target symmetric relationship may be directly acquired later, without re-deriving the symmetric relationship.

In yet another possible implementation, the operation of determining the target symmetric relationship according to the target BV parameter of the current block may include that: a target symmetric relationship of the first color component block is acquired from a preset buffer, to determine the target symmetric relationship. The target symmetric relationship is used to indicate a symmetric relationship between a first co-located area where the first color component block is located and a second co-located area indicated by the target BV parameter.

It should be noted that in the embodiments of the disclosure, specific processes of determining the target BV parameter and the target symmetric relationship are similar at the coding side and the decoding side, and are not described in detail here.

In operation S1803, a second color component of the current block is predicted according to the target BV parameter, to determine a predicted value of the second color component of the current block.

It should be noted that in the embodiments of the disclosure, the DBV mode may refer to a prediction mode newly introduced in the embodiments of the disclosure, and may be represented by DBV In this prediction mode, the second color component of the current block is predicted according to the determined target BV parameter, thereby determining the predicted value of the second color component of the current block.

In some embodiments, the operation of predicting, according to the target BV parameter, the second color component of the current block, to determine the predicted value of the second color component of the current block may include that: an offset position of the current block is determined according to the target BV parameter and position information of the current block; block copy is performed according to the offset position of the current block, to obtain a first prediction block; and the predicted value of the second color component of the current block is determined according to the first prediction block.

Further, in some embodiments, the operation of determining the predicted value of the second color component of the current block according to the first prediction block may include that: a correction operation is performed on the first prediction block, to determine the predicted value of the second color component of the current block.

That is, in the embodiments of the disclosure, a position (xCb, yCb) of the current chroma block is acquired, a chroma BV=(BVCₕₒᵣ, BVCᵥₑᵣ) is acquired, a corresponding offset position (xCb+BVCₕₒᵣ, yCb+BVCᵥₑᵣ) is found, and then block copy is directly performed to determine the predicted value; or, after performing block copy, it also needs to correct the copied value to obtain a final predicted value, the correction operation here includes but is not limited to an operation of weighting with predicted values obtained in a CCLM-type mode or other modes, etc.

In operation S1804, a residual value of the second color component of the current block is determined according to the predicted value of the second color component of the current block and the target symmetric relationship.

In the embodiments of the disclosure, for determination of the residual value, in a possible implementation, the operation of determining the residual value of the second color component of the current block according to the predicted value of the second color component of the current block and the target symmetric relationship may include that: an original value of the second color component of the current block is determined; the original value of the second color component of the current block is transformed according to the target symmetric relationship, to determine an initial value of the second color component of the current block; and the residual value of the second color component of the current block is determined according to the initial value of the second color component of the current block and the predicted value of the second color component of the current block.

It should be noted that the operation of determining the residual value of the second color component of the current block according to the initial value of the second color component of the current block and the predicted value of the second color component of the current block may include that: a subtraction operation is performed according to the initial value of the second color component of the current block and the predicted value of the second color component of the current block, to determine the residual value of the second color component of the current block.

Further, in some embodiments, the method may further include that: the residual value of the second color component of the current block is coded, and obtained coded bits are written into a bitstream. In this way, after the residual value is written into the bitstream by the encoding side, such that the decoding side may directly obtain the residual value by parsing the bitstream subsequently.

Exemplarily, determination of the residual value (that is, the residual sample) may specifically include the following operations.

<1> Original samples are acquired.

The original samples are acquired according to the target symmetric relationship, which includes but is not limited to the following manners.

First manner: the original samples are operated at a block level according to the symmetric relationship. Here, explanations are made by taking three symmetric relationships as examples.

If the target symmetric relationship is no symmetry, and copy is performed directly, then

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; and a variable cIdx, which specifies an index of a color component of the current block.

Output is: an array of original samples of the current block, orgSamples.

A derivation process is as follows.

$$For x = xCb … xCb + c b W i d t h - 1 and y = yCb … yCb + cbHeight - 1 : \\ xVb = x \& ( orgBufWidthC - 1 ) \\ yVb = y \& ( orgBufHeightC - 1 ) \\ orgSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

If the target symmetric relationship is horizontal symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; and a variable cIdx, which specifies an index of a color component of the current block.

Output is: an array of original samples of the current block, orgSamples.

A derivation process is as follows.

$$For x = xCb … xCb + c b W i d t h - 1 , y = yCb … yCb + c b H e i g h t - 1 , and xTemp = xCb + cbWidth - 1 … xCb : \\ xVb = xTemp \& ( orgBufWidthC - 1 ) \\ yVb = y \& ( orgBufHeightC - 1 ) \\ orgSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; and a variable cIdx, which specifies an index of a color component of the current block.

Output is: an array of original samples of the current block, orgSamples.

A derivation process is as follows.

$$For x = xCb … xCb + c b W i d t h - 1 , y = yCb … yCb + c b H e i g h t - 1 , and yTemp = yCb + c b H e i g h t - 1 … yCb : \\ xVb = x \& ( orgBufWidthC - 1 ) \\ yVb = yTemp \& ( orgBufHeightC - 1 ) \\ orgSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

### Second Manner:

First step: according to predefined symmetric relationships which include but are not limited to the following symmetric relationships: no symmetry, horizontal symmetry, vertical symmetry, or the like, transformation about all of symmetric relationships is performed on original samples at a picture level. Here, explanations are made by taking three symmetric relationships as examples.

First group: an array of original samples is not symmetrically transformed.

Inputs are: a variable picWidth, which specifies a width of the current picture in the chroma samples; a variable picHeight, which specifies a height of the current picture in the chroma samples; and a variable cIdx, which specifies an index of a color component of the current block.

Output is an array of original samples without symmetry, orgPicSamples.

$$For x = 0 … picWidth - 1 and y = 0 … picHeight - 1 : \\ xVb = x \& ( orgBufWidthC - 1 ) \\ yVb = y \& ( orgBufHeightC - 1 ) \\ orgPicSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf, The orgBufHeightC is a height of the chroma pixels in the stored original pixel buffer, that is, a height of the orgChromaBuf.

It should be noted that operations in this group are simple copy operations and may be omitted. If the operations are omitted, orgPicSamples in the following description corresponds to the orgChromaBuf.

Second group: horizontal symmetry is performed on the array of original samples.

Inputs are: a variable picWidth, which specifies a width of the current picture in the chroma samples; a variable picHeight, which specifies a height of the current picture in the chroma samples; and a variable cIdx, which specifies an index of a color component of the current block.

Output is: an array of original samples after horizontal symmetry, orgHorPicSamples.

$$For x = 0 … picWidth - 1 , y = 0 … picHeight - 1 , and xTemp = picWidth - 1 … 0 : \\ xVb = xTemp \& ( orgBufWidthC - 1 ) \\ yVb = y \& ( orgBufHeightC - 1 ) \\ orgHorPicSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

Third group: vertical symmetry is performed on the array of original samples.

Inputs are: a variable picWidth, which specifies a width of the current picture in the chroma samples; a variable picHeight, which specifies a height of the current picture in the chroma samples; and a variable cIdx, which specifies an index of a color component of the current block.

Output is: an array of original samples, orgVerPicSamples.

$$For x = 0 … picWidth - 1 , y = 0 … picHeight - 1 , and yTemp = picHeight - 1 … 0 : \\ xVb = x \& ( orgBufWidthC - 1 ) \\ yVb = yTemp \& ( orgBufHeightC - 1 ) \\ orgVerPicSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

Second step: an array of original samples of the current block is acquired according to the target symmetric relationship.

If the target symmetric relationship is no symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; and a variable cIdx, which specifies an index of a color component of the current block.

Output is: an array of original samples of the current block, orgSamples.

A derivation process is as follows.

$$For x = xCb … xCb + cbWidth - 1 and y = yCb … yCb + cbHeight - 1 : \\ xVb = x \& ( orgPicBufWidthC - 1 ) \\ yVb = y \& ( orgPicBufHeightC - 1 ) \\ orgSamples [ cIdx ] [ x ] [ y ] = orgPicSamples [ cIdx ] [ xVb ] [ yVb ]$$

The orgPicSamples is stored chroma pixels without symmetry after transformation in the first step while. The orgPicBufWidthC is a width of chroma pixels in a stored transformed pixel buffer, that is, a width of the orgPicSamples. The orgPicBufHeightC is a height of the chroma pixels in the stored transformed pixel buffer, that is, a height of the orgPicSamples.

If the target symmetric relationship is horizontal symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable picWidth, which specifies a width of the current picture in the chroma samples; a variable picHeight, which specifies a height of the current picture in the chroma samples; and a variable cIdx, which specifies an index of a color component of the current block.

Output is: an array of original samples of the current block, orgSamples.

A derivation process is as follows.

$$For x = xCb … xCb + c b W i d t h - 1 , y = yCb … yCb + c b H e i g h t - 1 , and xTemp = picWidth - xCb - cbWidth … picWidth - xCb - 1 : \\ xVb = xTemp \& ( orgHorPicBufWidthC - 1 ) \\ yVb = y \& ( orgHorPicBufHeightC - 1 ) \\ orgSamples [ cIdx ] [ x ] [ y ] = orgHorPicSamples [ cIdx ] [ xVb ] [ yVb ]$$

The orgHorPicSamples is stored chroma pixels after transformation of horizontal symmetry in the first step. The orgHorPicBufWidthC is a width of chroma pixels in a stored transformed pixel buffer, that is, a width of the orgHorPicSamples. The orgHorPicBufHeightC is a height of the chroma pixels in the stored transformed pixel buffer, that is, a height of the orgHorPicSamples.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable picWidth, which specifies a width of the current picture in the chroma samples; a variable picHeight, which specifies a height of the current picture in the chroma samples; and a variable cIdx, which specifies an index of a color component of the current block.

Output is: an array of original samples of the current block, orgSamples.

A derivation process is as follows.

$$For x = xCb … xCb + c b W i d t h - 1 , y = yCb … yCb + c b H e i g h t - 1 , and yTemp = picHeight - yCb - cbHeight … picHeight - yCb - 1 : \\ xVb = x \& ( orgVerPicBufWidthC - 1 ) \\ yVb = yTemp \& ( orgVerPicBufHeightC - 1 ) \\ orgSamples [ cIdx ] [ x ] [ y ] = orgVerPicSamples [ cIdx ] [ xVb ] [ yVb ]$$

The orgVerPicSamples is stored chroma pixels after transformation of vertical symmetry in the first step. The orgVerPicBufWidthC is a width of chroma pixels in a stored transformed pixel buffer, that is, a width of the orgVerPicSamples. The orgVerPicBufHeightC is a height of the chroma pixels in the stored transformed pixel buffer, that is, a height of the orgVerPicSamples.

<2> Residual samples are acquired.

The residual samples are derived according to the predicted samples obtained above and the original samples acquired in <1>.

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and the original samples orgSamples acquired in the operation S7 and the predicted samples predSamples acquired in the operation S6.

Output is: an array of residual samples of the current block, resiSamples.

A derivation process is as follows.

$$For x = xCb … xCb + c b W i d t h - 1 and y = yCb … yCb + cbHeight - 1 : \\ resiSamples [ cIdx ] [ x ] [ y ] = FuncSub ( o r g S a m p l e s [ cIdx ] [ x ] [ y ] , predSamples [ cIdx ] [ x ] [ y ] )$$

The function FuncSub( ) may perform subtraction between two parameters directly, or may further transform a difference between the two parameters, etc.

In another possible implementation, predicted samples may be symmetrically transformed according to the target symmetric relationship, and then subtracted from original samples, to obtain residual samples.

Exemplarily, determination of the residual values (that is, the residual samples) may further include the following manners.

First manner: a symmetric operation is directly performed on the predicted samples, and then the original samples are acquired to obtain residuals.

<1> Transformed predicted samples are acquired.

The transformed predicted samples are obtained according to the target symmetric relationship and the predicted samples acquired above in a manner which includes but is not limited to the following manners.

If the target symmetric relationship is no symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and an array of predicted samples of the current block, predSamples.

Output is: an array of transformed predicted samples of the current block, predTrsSamples.

A derivation process is as follows.

$$For x = xCb … xCb + cbWidth - 1 and y = yCb … yCb + cbHeight - 1 :$$

$$xVb = x \& ( predSamplesWidthC - 1 )$$

$$yVb = y \& ( predSamplesHeightC - 1 )$$

predTrsSamples[cIdx][x][y]=predSamples[cIdx][xVb][yVb]

The predSamples is stored predicted chroma pixels, the predSamplesWidthC is a width of the predSamples, and the predSamplesHeightC is a height of the predSamples.

If the target symmetric relationship is horizontal symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and an array of predicted samples of the current block, predSamples.

Output is: an array of transformed predicted samples of the current block, predTrsSamples.

A derivation process is as follows.

$$For x = xCb … xCb + cbWidth - 1 , y = yCb … yCb + cbHeight - 1 , and xTemp = xCb + cbWidth - 1 … xCb :$$

$$xVb = xTemp \& ( predSamplesWidthC - 1 )$$

$$yVb = y \& ( predSamplesHeightC - 1 )$$

$$predTrsSamples [ cIdx ] [ x ] [ y ] = predSamples [ cIdx ] [ xVb ] [ yVb ]$$

The predSamples is stored predicted chroma pixels, the predSamplesWidthC is a width of the predSamples, and the predSamplesHeightC is a height of the predSamples.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and an array of predicted samples of the current block, predSamples.

Output is: an array of transformed predicted samples of the current block, predTrsSamples.

A derivation process is as follows.

$$For x = xCb … xCb + cbWidth - 1 , y = yCb … yCb + cbHeight - 1 , and yTemp = yCb + cbHeight - 1 … yCb :$$

$$xVb = x \& ( predSamplesWidthC - 1 )$$

$$yVb = yTemp \& ( predSamplesHeightC - 1 )$$

$$predTrsSamples [ cIdx ] [ x ] [ y ] = predSamples [ cIdx ] [ xVb ] [ yVb ]$$

The predSamples is stored predicted chroma pixels, the predSamplesWidthC is a width of the predSamples, and the predSamplesHeightC is a height of the predSamples.

<2> Original samples are acquired.

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; and a variable cIdx, which specifies an index of a color component of the current block.

Output is: an array of original samples of the current block, orgSamples.

A derivation process is as follows.

$$For x = xCb … xCb + cbWidth - 1 and y = yCb … yCb + cbHeight - 1 :$$

$$xVb = x \& ( orgBufWidthC - 1 )$$

$$yVb = y \& ( orgBufHeightC - 1 )$$

$$orgSamples [ cIdx ] [ x ] [ y ] = orgChroma Buf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

<3> Residual samples are acquired.

The residual samples are derived according to the predicted samples acquired in <1> and the original samples acquired in <2>.

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and the original samples orgSamples acquired in <2> of the operation S7 and the predicted samples predTrsSamples acquired in <1> of the operation S7.

Output is: an array of residual samples of the current block, resiSamples.

A derivation process is as follows.

$$For x = xCb … xCb + cbWidth - 1 and y = yCb … yCb + cbHeight - 1 :$$

$$resiSamples [ cIdx ] [ x ] [ y ] = funcSub ( orgSamples [ cIdx ] [ x ] [ y ] , predTrsSamples [ cIdx ] [ x ] [ y ] )$$

The function funcSub( ) may perform subtraction between two parameters directly, or may perform operations after subtraction between the two parameters, such as further transformation, etc.

### Second Manner:

The residual samples are derived according to the predicted samples obtained from the above prediction and the original samples.

The original samples are acquired directly.

$$For x = xCb … xCb + cbWidth - 1 and y = yCb … yCb + cbHeight - 1 :$$

$$xVb = x \& ( orgVerPicBufWidthC - 1 )$$

$$yVb = y \& ( orgVerPicBufHeightC - 1 )$$

$$orgSamples [ cIdx ] [ xVb ] [ yVb ] = orgChroma Buf [ cIdx ] [ x ] [ y ]$$

If the target symmetric relationship is no symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and the original samples orgSamples acquired in the operation S7 and the predicted samples predSamples acquired in the operation S6.

Output is: an array of residual samples of the current block, resiSamples.

A derivation process is as follows.

$$For x = xCb … xCb + cbWidth - 1 and y = yCb … yCb + cbHeight - 1 :$$

$$resiSamples [ cIdx ] [ x ] [ y ] = funcSub ( orgSamples [ cIdx ] [ x ] [ y ] , predTrsSamples [ cIdx ] [ x ] [ y ] )$$

The function funcSub( ) may perform subtraction between two parameters directly, or may perform operations after subtraction between the two parameters, such as further transformation, etc.

If the target symmetric relationship is horizontal symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and the original samples orgSamples acquired in the operation S7 and the predicted samples predSamples acquired in the operation S6.

Output is: an array of residual samples of the current block, resiSamples.

A derivation process is as follows.

$$For x = xCb … xCb + cbWidth - 1 , y = yCb … yCb + cbHeight - 1 , and xTemp = xCb + cbWidth - 1 … xCb :$$

$$resiSamples [ cIdx ] [ x ] [ y ] = funcSub ( orgSamples [ cIdx ] [ x ] [ y ] , predSamples [ cIdx ] [ xTemp ] [ y ] )$$

The function funcSub( ) may perform subtraction between two parameters directly, or may perform operations after subtraction between the two parameters, such as further transformation, etc.

If the target symmetric relationship is vertical symmetry:

Inputs are: a chroma position (xCb, yCb), which specifies a position of a top-left sample of the current block relative to a top-left chroma sample of the current picture; a variable cbWidth, which specifies a width of the current block in the chroma samples; a variable cbHeight, which specifies a height of the current block in the chroma samples; a variable cIdx, which specifies an index of a color component of the current block; and the original samples orgSamples acquired in the operation S7 and the predicted samples predSamples acquired in the operation S6.

Output is: an array of residual samples of the current block, resiSamples.

A derivation process is as follows.

$$For x = xCb … xCb + cbWidth - 1 , y = yCb … yCb + cbHeight - 1 , and yTemp = yCb + cbHeight - 1 … yCb :$$

$$resiSamples [ cIdx ] [ x ] [ y ] = funcSub ( orgSamples [ cIdx ] [ x ] [ y ] , predSamples [ cIdx ] [ x ] [ yTemp ] )$$

The function funcSub( ) may perform subtraction between two parameters directly, or may perform operations after subtraction between the two parameters, such as further transformation, etc.

Further, in some embodiments, the method may further include that: a target prediction mode for the current block is determined; and when the target prediction mode indicates that the second color component of the current block is allowed to use a DBV mode, a target prediction mode for the current block is coded, and obtained coded bits are written into a bitstream.

Further, in some embodiments, the method may further include that: a value of identification information of a first syntax element is determined; and the value of identification information of the first syntax element is coded, and obtained coded bits are written into the bitstream.

Further, in some embodiments, the method may further include that: a first co-located area corresponding to the current block is determined; and if any position in the first co-located area has BV information, it is determined that the second color component of the current block is allowed to use the DBV mode.

It should also be noted that in the embodiments of the disclosure, the operation of determining the value of identification information of the first syntax element may include that: if the target prediction mode for the current block is the DBV mode, it is determined that the value of identification information of the first syntax element is a first value; if the target prediction mode for the current block is another prediction mode other than the DBV mode, it is determined that the value of identification information of the first syntax element is a second value.

In the embodiments of the disclosure, for identification information of different syntax elements (such as identification information of the first syntax element), the first value and the second value corresponding thereto may be the same or different, which is not specifically limited here. Furthermore, in the embodiments of the disclosure, the first value and the second value may be in a parameter form or in a digital form. Specifically, identification information of each syntax element may be a parameter written in a profile, or may be a value of a flag/identifier, which is not specifically limited here, either.

Exemplarily, the first value may be set to 1, and the second value may be set to 0; or, the first value may be set to 0, and the second value may be set to 1; or, the first value may be set to true, and the second value may be set to false; or, the first value may be set to false, and the second value may be set to true. In the embodiments of the disclosure, the first value may be set to 1, and the second value may be set to 0, however, the first value and the second value are not specifically limited.

Further, in order to accelerate a processing speed of the decoding side, the encoding side may directly write the target BV parameter into a bitstream. Therefore, in some embodiments, the method may further include that: the target BV parameter of the current block is coded, and obtained coded bits are written into a bitstream.

Further, in order to accelerate a processing speed of the decoding side, the encoding side may also directly write the target symmetric relationship into a bitstream. Therefore, in some embodiments, the method may further include that: the target symmetric relationship is coded, and obtained coded bits are written into a bitstream.

Further, in some embodiments, the method may further include that: sub-block division is performed on the current block, to obtain at least one sub-block; and the sub-block is taken as the current block, and operations of the encoding method shown in FIG. 18 are performed, to determine the residual value of the second color component of the sub-block.

It should be noted that in the embodiments of the disclosure, when processing is performed in unit of the sub-block of the current block, processing may also be performed according to the symmetric relationship of the embodiments of the disclosure, except that all of determination and processing in the operations are performed on the sub-block.

It should also be noted that in the embodiments of the disclosure, when a corresponding residual of the current block where chroma prediction is performed in the DBV mode is transformed and inversely transformed in a manner which includes but is not limited to the following manners: only one transformation may be performed (for example, only the DCT transformation is performed without performing LFNST), or two transformations may be performed (a primary transformation and a secondary transformation, for example, the encoding side performs the DCT transformation and then performs the LFNST transformation). Forward transformation manners implemented by the decoding side and the coding side are kept consistent in a reverse order.

The embodiments of the disclosure provides an encoding method, in which a first color component block for a current block is determined; when a prediction mode for the first color component block meets a first condition, a target BV parameter of the current block is determined, and a target symmetric relationship is determined according to the target BV parameter of the current block; a second color component of the current block is predicted according to the target BV parameter, to determine a predicted value of the second color component of the current block; and a residual value of the second color component of the current block is determined according to the predicted value of the second color component of the current block and the target symmetric relationship. That is, in the disclosure, available information such as reconstructed luma, BV or the like are fully considered, and chroma is predicted according to these information, which improves singleness of chroma prediction. Further, the symmetric relationship is considered and the predicted value is processed in more detail. This not only improves accuracy of the chroma prediction and saves the bit rate, but also improves coding and decoding performance and improves coding efficiency effectively.

In yet another implementation of the disclosure, based on the encoding method described in the above embodiments, the embodiments of the disclosure introduce a new prediction mode, DBV (that is, first solution). In a process of the first solution, a corresponding luma block is acquired, and whether the corresponding luma block is coded in a mode with BV information is determined, and then the following processing manners may be used.

If the corresponding luma block is not coded in the mode with BV information, no syntax element for this mode is transmitted in a bitstream.

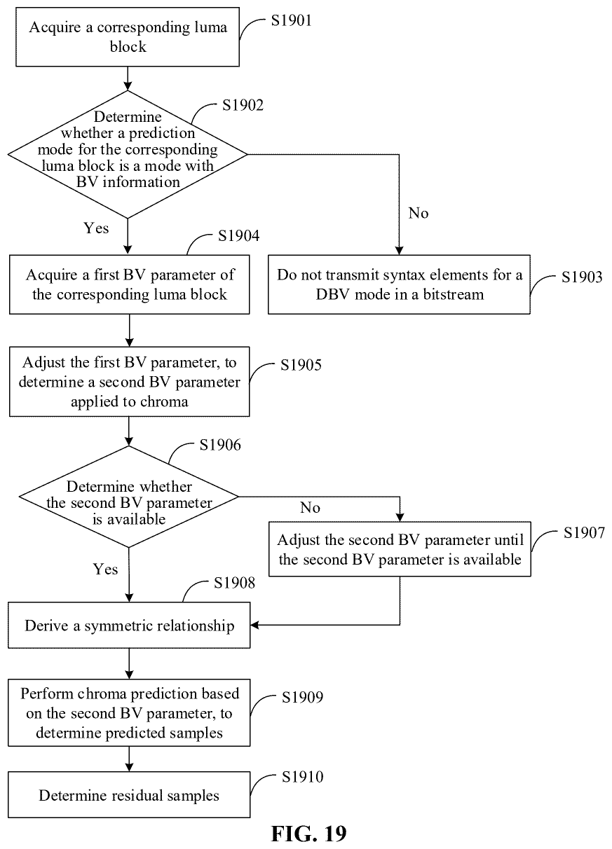

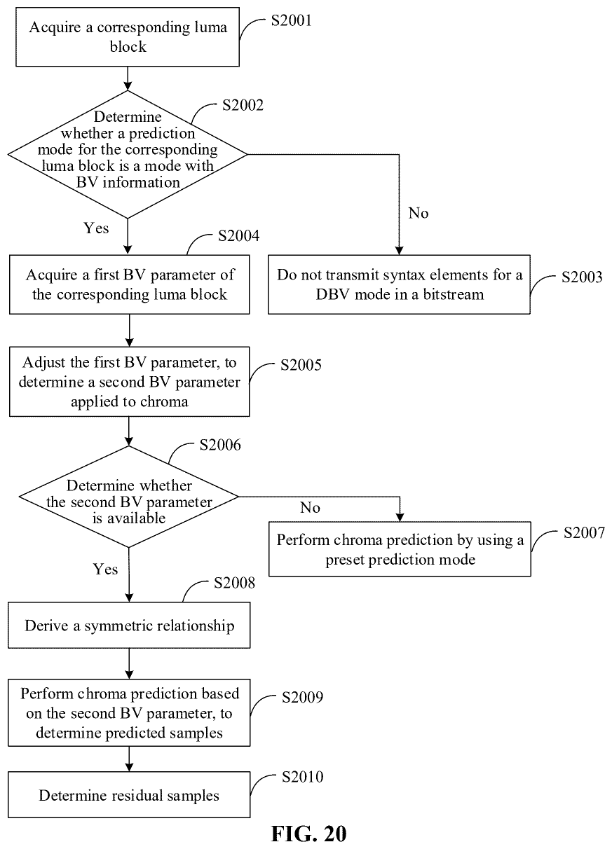

If the corresponding luma block is coded in the mode with BV information, a BV of the corresponding luma block is acquired, the BV is adjusted to be applied to chroma, and whether the adjusted BV is available is determined. If the adjusted BV is available, a symmetric relationship is derived directly, chroma prediction is performed, and residual samples are derived. If the adjusted BV is not available, the BV is adjusted until it is available, then the symmetric relationship is derived, the chroma prediction is performed, and the residual samples are derived, or prediction is performed by using a PLANAR mode or other chroma prediction modes. Different processing flowcharts in a situation where the BV is not available are shown in FIG. 19 and FIG. 20.

With reference to FIG. 19, a detailed schematic flowchart of an encoding method according to embodiments of the disclosure is shown. As shown in FIG. 19, the detailed flow may include the following operations S1901 to S1910.

In operation S1901, a corresponding luma block is acquired.

In operation S1902, whether a prediction mode for the corresponding luma block is a mode with BV information is determined.

In operation S1903, syntax elements of a DBV mode are not transmitted in a bitstream.

In operation S1904, a first BV parameter of the corresponding luma block is acquired.

In operation S1905, the first BV parameter is adjusted, to determine a second BV parameter to be applied to chroma.

In operation S1906, whether the second BV parameter is available is determined.

In operation S1907, if the second BV parameter is not available, the second BV parameter is adjusted until the second BV parameter is available.

In operation S1908, if the second BV parameter is available, a symmetric relationship is derived.

In operation S1909, chroma prediction is performed based on the second BV parameter, to determine predicted samples.

In operation S1910, residual samples are determined.

With reference to FIG. 20, a detailed schematic flowchart of another coding method according to embodiments of the disclosure is shown. As shown in FIG. 20, the detailed flow may include the following operations S2001 to S2010.

In operation S2001, a corresponding luma block is acquired.

In operation 52002, whether a prediction mode for the corresponding luma block is a mode with BV information is determined.

In operation 52003, syntax elements of a DBV mode are not transmitted in a bitstream.

In operation 52004, a first BV parameter of the corresponding luma block is acquired.

In operation 52005, the first BV parameter is adjusted, to determine a second BV parameter to be applied to chroma.

In operation 52006, whether the second BV parameter is available is determined.

In operation 52007, if the second BV parameter is not available, chroma prediction is performed by using a preset prediction mode.

In operation 52008, if the second BV parameter is available, a symmetric relationship is derived.

In operation 52009, chroma prediction is performed based on the second BV parameter, to determine predicted samples.

In operation S2010, residual samples are determined.

In a specific embodiment, the encoding method of the embodiments of the disclosure may specifically include the following operations S1 to S8.

In operation S1, a corresponding luma block is acquired.

Position of the acquired block may be any position, which includes but is not limited to the following positions.
(1) The center block of the co-located luma area is acquired, as shown in FIG. 3.
(2) The top-left block of the co-located luma area is acquired, as shown in FIG. 7.
(3) The lower-right block of the co-located luma area is acquired, as shown in FIG. 8.
(4) Blocks at five luma pixel positions shown in FIG. 9 (they include but are not limited to the five positions, and may be multiple different positions), are acquired sequentially until it is determined that an acquired block is coded in a mode with BV information, that is, a first block which is predictively coded in the mode with BV information is found from the luma pixel positions. Orders for sequential acquisition include but are not limited to the following order: C->TL->TR->BL->BR.

In operation S2, whether the corresponding luma block is coded in a mode with BV information is determined.

A block at a corresponding position is acquired, and whether the corresponding luma block is coded in the mode with BV information is determined, the mode with BV information includes but is not limited to the IBC mode or the IntraTMP mode. If the corresponding luma block is coded in the mode with BV information, a BV of the corresponding luma block is acquired; if the corresponding luma block is not coded in the mode with BV information, syntax elements of this mode are not transmitted in a bitstream.

In operation S3, the BV is adjusted to be applied to chroma.

After acquiring the BV of the corresponding luma block, the BV is adjusted to be applied to the chroma. It is assumed that a luma BV=(BVLₕₒᵣ, BVLᵥₑᵣ), and a chroma BV=(BVCₕₒᵣ, BVCᵥₑᵣ). The Adjustment manner includes but is not limited to the following adjustment manners: scaling according to the chroma sampling format shown in Table 9.

In operation S4, whether the BV is available is determined.

A position (xCb, yCb) of the current chroma block is acquired, a chroma BVC=(BVCₕₒᵣ, BVCᵥₑᵣ) is acquired, a corresponding offset position (xCb+BVCₕₒᵣ, yCb+BVCᵥₑᵣ) is found, the following conditions are determined, and if all of them are true, the chroma BV is available:
Whether an obtained offset position does not exceed a Picture boundary;
Whether the obtained offset position does not cover the current block, as shown in FIG. 10;
Whether the obtained offset position does not exceed an available area, as shown in FIG. 11; and
Whether the obtained offset position has been reconstructed.

Here, if the BV is available, the method proceeds to operation S5, to derive a symmetric relationship. If the BV is not available, the BV is adjusted until it is available, and then the method proceeds to operation S5, to derive the symmetric relationship. Adjustment manners include but are not limited to clipping, scaling, etc. If the BV is not available, modes which include but are not limited to a PLANAR mode or a CCLM-type mode or another angular prediction mode may also be used, to acquire reference pixels and mode parameters to perform chroma mode prediction.

In operation S5, a symmetric relationship is derived.

Simply speaking, when it is considered from the perspective of data operation, it may be used directly without flipping; or it may be flipped. There may be two types of flipping: horizontal flipping and vertical flipping. In a derivation process of the chroma intra prediction mode, if an intra prediction mode based on BV parameters is used to the corresponding luma block, the decoding side may further determine whether the luma information is flipped. There are two implementations of flipping.

First implementation: the original block is flipped during encoding, then the reconstructed block of the current block is flipped during decoding, to obtain a final reconstructed block.

Second implementation: the reference block is flipped during encoding, then the reference block is flipped during decoding, to obtain a reconstructed block.

For the second implementation, in a BV search process at the decoding side and in a template matching process for the BV parameters, the reference block needs to be flipped once for each to-be-detected point, which introduces additional complexity. In an actual application, there may be the following symmetric operations.

First symmetric operation: a separate buffer is used to store symmetrically processed data, that is, aRef[x]=aOrg[N−1−x], here N is a number of data.

Second symmetric operation: according to the used symmetric operation, position coordinates are operated when the data is read.

In case of the first implementation, at the coding side, residual[x]=input[N−1−x]−ref[x]; then at the decoding side, recon[N−1−x]=residual[x]+ref[x];

In case of the second implementation, at the coding side, residual[x]=input[x]−ref[N−1−x]; then at the decoding side, recon[x]=residual[x]+ref[N−1−x], here recon is the reconstructed block.

Here, derivation of the symmetric relationship may refer to contents of the above embodiments for the details, which is not limited in any way here.

In operation S6, chroma prediction based on the BV is performed.

It includes but is not limited to the following manners.

### First Manner:

A position (xCb, yCb) of the current chroma block is acquired, a chroma BV=(BVCₕₒᵣ, BVCᵥₑᵣ) is acquired, to find a corresponding offset position (xCb+BVCₕₒᵣ, yCb+BVCᵥₑᵣ), so as to perform block copy, as shown in FIG. 17.

A variable cbWidth specifies a width of the current coding block in the chroma samples, a variable cbHeight specifies a height of the current coding block in the chroma samples, and a variable cIdx specifies an index of a color component of the current block.

$$For x = xCb … xCb + cbWidth - 1 and y = yCb … yCb + cbHeight - 1 :$$

$$xVb = ( x + {BVC}_{hor} ) \& ( BufWidthC - 1 )$$

$$yVb = ( y + {BVC}_{ver} ) \& ( CtbSizeC - 1 )$$

$$predSamples [ cIdx ] [ x ] [ y ] = function ( VirChroma Buf [ cIdx ] [ xVb ] [ yVb ] )$$

The BufWidthC is a width of chroma pixels in a stored reconstructed buffer, the CtbSizeC is a size of chroma pixels of the CTU, and the VirChromaBuf is stored reconstructed chroma pixels. The function( ) is a processing function for pixel values, which may be direct copy, or a shift operation to ensure calculation accuracy, or a filtering operation, etc.

### Second Manner:

A position (xCb, yCb) of the current chroma block is acquired, a chroma BV=(BVCₕₒᵣ, BVCᵥₑᵣ) is acquired, to find a corresponding offset position (xCb+BVCₕₒᵣ, yCb+BVCᵥₑᵣ), and perform block copy. Then the copied value is corrected to obtain a final predicted value in a manner which includes but is not limited to an operation of weighting with predicted values obtained in a CCLM-type mode or other modes.

In operation S7, residual samples are derived.

<1> Original samples are acquired.

The original samples are acquired according to the symmetric relationship derived in the operation S5 in a manner which includes but is not limited to the following manners.

First manner: the original samples are operated at a block level according to the symmetric relationship. Here, explanations are made by taking three symmetric relationships as examples.

If the symmetric relationship derived in the operation S5 is no symmetry, copy is performed directly.

Inputs are: a chroma position (xCb, yCb), which specifies a position of a top-left sample of the current block relative to a top-left chroma sample of the current picture; a variable cbWidth, which specifies a width of the current coding block in the chroma samples; a variable cbHeight, which specifies a height of the current coding block in the chroma samples; and a variable cIdx, which specifies an index of a color component of the current block.

Output is: an array of original samples of the current CB, orgSamples.

A derivation process is as follows.

$$For x = xCb … xCb + cbWidth - 1 and y = yCb … yCb + cbHeight - 1 :$$

$$xVb = x \& ( orgBufWidthC - 1 )$$

$$yVb = y \& ( orgBufHeightC - 1 )$$

$$orgSamples [ cIdx ] [ x ] [ y ] = orgChroma Buf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

If the symmetric relationship derived in the operation S5 is horizontal symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; and a variable cIdx, which specifies an index of a color component of the current block.

Output is: an array of original samples of the current CB, orgSamples.

A derivation process is as follows.

$$For x = xCb … xCb + cbWidth - 1 , y = yCb … yCb + cbHeight - 1 , and xTemp = xCb + cbWidth - 1 … xCb :$$

$$xVb = xTemp \& ( orgBufWidthC - 1 )$$

$$yVb = y \& ( orgBufHeightC - 1 )$$

$$orgSamples [ cIdx ] [ x ] [ y ] = orgChroma Buf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

If the symmetric relationship derived in the operation S5 is vertical symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; and a variable cIdx, which specifies an index of a color component of the current block.

Output is: an array of original samples of the current CB, orgSamples.

A derivation process is as follows.

$$For x = xCb … xCb + cbWidth - 1 , y = yCb … yCb + cbHeight - 1 , and yTemp = yCb + cbHeight - 1 … yCb :$$

$$xVb = x \& ( orgBufWidthC - 1 )$$

$$yVb = yTemp \& ( orgBufHeightC - 1 )$$

$$orgSamples [ cIdx ] [ x ] [ y ] = orgChroma Buf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

### Second Manner:

First step: according to predefined symmetric relationships which include but are not limited to the following symmetric relationships: no symmetry, horizontal symmetry, vertical symmetry, or the like, transformation about all of symmetric relationships is performed on original samples at a picture level. Here, explanations are made by taking three symmetric relationships as examples.

First group: an array of original samples is not symmetrically transformed.

Inputs are: a variable picWidth, which specifies a width of the current picture in the chroma samples; a variable picHeight, which specifies a height of the current picture in the chroma samples; and a variable cIdx, which specifies an index of a color component of the current block.

Output is: an array of original samples without symmetry, orgPicSamples.

$$For x = 0 … picWidth - 1 and y = 0 … picHeight - 1 :$$

$$xVb = x \& ( orgBufWidthC - 1 )$$

$$yVb = y \& ( orgBufHeightC - 1 )$$

$$orgPicSamples [ cIdx ] [ x ] [ y ] = orgChroma Buf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

It should be noted that operations in this group are simple copy operations and may be omitted. If the operations are omitted, orgPicSamples in the following description corresponds to the orgChromaBuf.

Second group: horizontal symmetry is performed on the array of original samples.

Inputs are: a variable picWidth, which specifies a width of the current picture in the chroma samples; a variable picHeight, which specifies a height of the current picture in the chroma samples; and a variable cIdx, which specifies an index of a color component of the current block.

Output is: an array of original samples after horizontal symmetry, orgHorPicSamples.

$$For x = 0 … picWidth - 1 , y = 0 … picHeight - 1 , and xTemp = picWidth - 1 … 0 :$$

$$xVb = xTemp \& ( orgBufWidthC - 1 )$$

$$yVb = y \& ( orgBufHeightC - 1 )$$

$$orgHorPicSamples [ cIdx ] [ x ] [ y ] = orgChroma Buf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

Third group: vertical symmetry is performed on the array of original samples.

Inputs are: a variable picWidth, which specifies a width of the current picture in the chroma samples; a variable picHeight, which specifies a height of the current picture in the chroma samples; and a variable cIdx, which specifies an index of a color component of the current block.

Output is: an array of original samples with vertical symmetry, orgVerPicSamples.

$$For x = 0 … picWidth - 1 , y = 0 … picHeight - 1 , and yTemp = picHeight - 1 …0 :$$

$$xVb = x \& ( orgBufWidthC - 1 )$$

$$yVb = yTemp \& ( orgBufHeightC - 1 )$$

$$orgVerPicSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

Second step: an array of original samples of the current CB is acquired according to the symmetric relationship derived in the operation S5.

If the symmetric relationship derived in the operation S5 is no symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; and a variable cIdx, which specifies an index of a color component of the current block.

Output is: an array of original samples of the current CB, orgSamples.

A derivation process is as follows.

$$For x = xCb … xCb + cbWidth - 1 and y = yCb … yCb + cbHeight - 1 :$$

$$xVb = x \& ( orgPicBufWidthC - 1 )$$

$$yVb = y \& ( orgPicBufHeightC - 1 )$$

$$orgSamples [ cIdx ] [ x ] [ y ] = orgPicSamples [ cIdx ] [ xVb ] [ yVb ]$$

The orgPicSamples is stored chroma pixels for which symmetry transformation is not performed in the first step. The orgPicBufWidthC is a width of chroma pixels in a stored transformed pixel buffer, that is, a width of the orgPicSamples. The orgPicBufHeightC is a height of the chroma pixels in the stored transformed pixel buffer, that is, a height of the orgPicSamples.

If the symmetric relationship derived in the operation S5 is horizontal symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable picWidth, which specifies a width of the current picture in the chroma samples; a variable picHeight, which specifies a height of the current picture in the chroma samples; and a variable cIdx, which specifies an index of a color component of the current block.

Output is: an array of original samples of the current CB, orgSamples.

A derivation process is as follows.

$$For x = xCb … xCb + cbWidth - 1 , y = yCb … yCb + cbHeight - 1 , and xTemp = picWidth - xCb - cbWidth … picWidth - xCb - 1 :$$

$$xVb = xTemp \& ( orgHorPicBufWidthC - 1 )$$

$$yVb = y \& ( orgHorPicBufHeightC - 1 )$$

$$orgSamples [ cIdx ] [ x ] [ y ] = orgHorPicSamples [ cIdx ] [ xVb ] [ yVb ]$$

The orgHorPicSamples is stored chroma pixels after transformation of horizontal symmetry in the first step. The orgHorPicBufWidthC is a width of chroma pixels in a stored transformed pixel buffer, that is, a width of the orgHorPicSamples. The orgHorPicBufHeightC is a height of the chroma pixels in the stored transformed pixel buffer, that is, a height of the orgHorPicSamples.

If the symmetric relationship derived in the operation S5 is vertical symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable picWidth, which specifies a width of the current picture in the chroma samples; a variable picHeight, which specifies a height of the current picture in the chroma samples; and a variable cIdx, which specifies an index of a color component of the current block.

Output is: an array of original samples of the current CB, orgSamples.

A derivation process is as follows.

$$For x = xCb … xCb + cbWidth - 1 , y = yCb … yCb + cbHeight - 1 , and yTemp = picHeight - yCb - cbHeight … picHeight - yCb - 1 :$$

$$xVb = x \& ( orgVerPicBufWidthC - 1 )$$

$$yVb = yTemp \& ( orgVerPicBufHeightC - 1 )$$

$$orgSamples [ cIdx ] [ x ] [ y ] = orgVerPicSamples [ cIdx ] [ xVb ] [ yVb ]$$

The orgVerPicSamples is stored chroma pixels after transformation of vertical symmetry in the first step, The orgVerPicBufWidthC is a width of chroma pixels in a stored transformed pixel buffer, that is, a width of the orgVerPicSamples. The orgVerPicBufHeightC is a height of the chroma pixels in the stored transformed pixel buffer, that is, a height of the orgVerPicSamples.

<2> Residual samples are acquired.

The residual samples are derived according to the predicted samples derived in the operation S6 and the original samples acquired in <1> of the operation S7.

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; and the original samples orgSamples acquired in the operation S7 and the predicted samples predSamples acquired in the operation S6.

Output is: an array of residual samples of the current CB, resiSamples.

A derivation process is as follows.

$$For x = xCb … xCb + cbWidth - 1 and y = yCb … yCb + cbHeight - 1 :$$

$$resiSamples [ cIdx ] [ x ] [ y ] = FuncSub ( orgSamples [ cIdx ] [ x ] [ y ] , predSamples [ cIdx ] [ x ] [ y ] )$$

The function FuncSub( ) may perform subtraction between two parameters directly, or may further transform a difference between the two parameters, etc.

In operation S8, there are other situations.

If it is a PLANAR mode or a CCLM-type mode or another angular mode, reference pixels and mode parameters are acquired to perform chroma mode prediction.

In another embodiment, an improvement in which the DM mode is modified (that is, second solution) is provided. In the dual-tree partition, in the DM mode, if a corresponding luma area has BV information, the current chroma block is predicted by using the DBV mode. For example:

If CuPredMode[0][xCb+cbWidth/2][yCb+cbHeight/2] is equal to MODE_IBC, intra_dbv_flag=1 is set, then DBV is used for the chroma intra prediction mode IntraPredModeC[xCb][yCb].

If CuPredMode[0][xCb+cbWidth/2][yCb+cbHeight/2] is equal to MODE_INTRA and IntraTmpFlag[xCb+cbWidth/2][yCb+cbHeight/2] is equal to 1, intra_dbv_flag=1 is set, then the DBV is used for the chroma intra prediction mode IntraPredModeC[xCb][yCb].

Here, derivation of the chroma prediction mode refers to Table 12 for the details. In the DM mode, if intra_ibc_flag==1, that is, information acquired from the block at the center position of the co-located luma area includes the BV, then the DBV is used for the chroma intra prediction mode IntraPredModeC[xCb][yCb].

Prediction is performed and residuals are acquired by using the improved process of the DBV mode in the above embodiments, and operations thereof are the same as operations S1, S2, S3, S4, S5, S6 and S7 in the above embodiments. In the operation S1, the block at the center position of the co-located luma area is acquired. In the operation S2, the BV of the corresponding luma block is acquired directly. If the chroma BV in the operation S8 is not available, a luma prediction mode corresponding thereto is acquired.

Based on the decoding method described in the above embodiments, the embodiments of the disclosure introduce a new prediction mode (the DBV mode). In the process, a corresponding luma block is acquired, and whether the corresponding luma block is decoded in a mode with BV information is determined, and then the following processing manners may be used.

If the corresponding luma block is not decoded in the mode with BV information, syntax elements of this mode are not parsed.

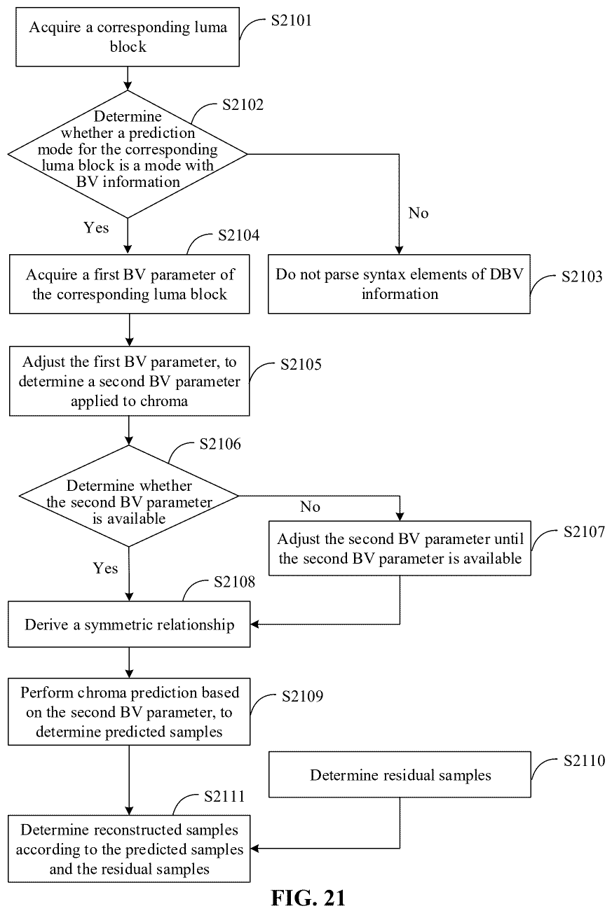

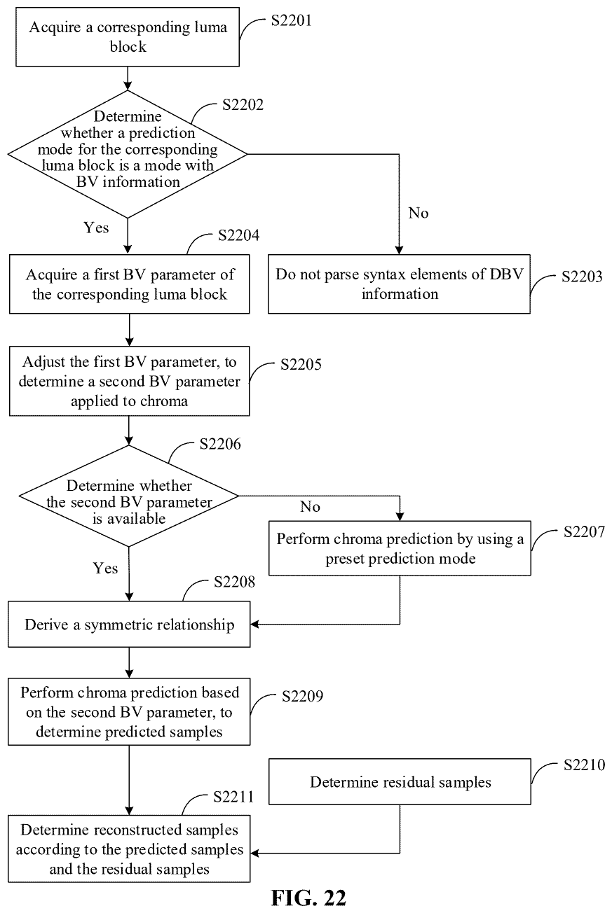

If the corresponding luma block is decoded in the mode with BV information, a BV of the corresponding luma block is acquired, the BV is adjusted to be applied to chroma, and whether the adjusted BV is available is determined. If the adjusted BV is available, a symmetric relationship is derived directly, chroma prediction is performed, residual samples are derived, and reconstructed samples are derived. If the adjusted BV is not available, the BV is adjusted until it is available, then the symmetric relationship is derived, the chroma prediction is performed, the residual samples are derived, and the reconstructed samples are derived, or prediction is performed by using a PLANAR mode or other chroma prediction modes. Different processing flowcharts in a situation where the BV is not available are shown in FIG. 21 and FIG. 22.

With reference to FIG. 21, a detailed schematic flowchart of a decoding method according to embodiments of the disclosure is shown. As shown in FIG. 21, the detailed flow may include the following operations S2101 to S2111.

In operation S2101, a corresponding luma block is acquired.

In operation S2102, whether a prediction mode for the corresponding luma block is a mode with BV information is determined.

In operation S2103, syntax elements of DBV information are not parsed.

In operation S2104, a first BV parameter of the corresponding luma block is acquired.

In operation S2105, the first BV parameter is adjusted, to determine a second BV parameter to be applied to chroma.

In operation S2106, whether the second BV parameter is available is determined.

In operation S2107, if the second BV parameter is not available, the second BV parameter is adjusted until the second BV parameter is available.

In operation S2108, if the second BV parameter is available, a symmetric relationship is derived.

In operation S2109, chroma prediction is performed based on the second BV parameter, to determine predicted samples.

In operation S2110, residual samples are determined.

In operation S2111, reconstructed samples are determined according to the predicted samples and the residual samples.

With reference to FIG. 22, a detailed schematic flowchart of another decoding method according to embodiments of the disclosure is shown. As shown in FIG. 22, the detailed flow may include the following operations S2201 to S2211.

In operation S2201, a corresponding luma block is acquired.

In operation S2202, whether a prediction mode for the corresponding luma block is a mode with BV information is determined.

In operation S2203, syntax elements of DBV information are not parsed.

In operation S2204, a first BV parameter of the corresponding luma block is acquired.

In operation S2205, the first BV parameter is adjusted, to determine a second BV parameter to be applied to chroma.

In operation S2206, whether the second BV parameter is available is determined.

In operation S2207, if the second BV parameter is not available, chroma prediction is performed by using a preset prediction mode.

In operation S2208, if the second BV parameter is available, a symmetric relationship is derived.

In operation S2209, chroma prediction is performed based on the second BV parameter, to determine predicted samples.

In operation S2210, residual samples are determined.

In operation S2211, reconstructed samples are determined according to the predicted samples and the residual samples.

In the embodiments of the disclosure, in operation S1, a corresponding luma block is acquired; in operation S2, whether it is an available mode is determined; in operation S3, the BV is adjusted to be applied to chroma; in operation S4, whether the BV is available is determined; in operation S5, a symmetric relationship is derived; in operation S6, a BV-based chroma prediction is performed: processes at the decoding side are the same as those at the encoding side, and are not described in detail here.

In operation S7, residual samples are derived.

Residual coefficient samples are parsed from the bitstream, and inverse quantization and inverse transform processes, etc. are performed on the residual coefficient samples, to obtain real residual samples.

In operation S8, reconstructed samples are derived by using the predicted samples and the residual samples.

The predicted samples obtained in the operation S6 and the residual samples obtained in the operation S7 are added together, to obtain the reconstructed samples, and then the reconstructed samples are processed according to the symmetric relationship derived in the operation S5, to obtain real reconstructed samples. Specific processing includes but is not limited to the following manners.

First manner: residual data in the bitstream is data after a symmetric operation, and it needs to perform the symmetric operation on reconstructed pixels during reconstruction.

If the symmetric relationship derived in the operation S5 is no symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies predicted samples of the current CB; and an array resiSamples, which specifies prediction residual samples of the current CB.

Output is: an array of reconstructed samples of the current CB, recChromaBuf.

A derivation process is as follows.

$$For x = xCb … xCb + cbWidth - 1 and y = yCb … yCb + cbHeight - 1 :$$

$$xVb = x \& ( orgBufWidthC - 1 )$$

$$yVb = y \& ( recBufHeightC - 1 )$$

$$recChromaBuf [ cIdx ] [ xVb ] [ yVb ] = funcAdd ( predSamples [ cIdx ] [ x ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf Processing of special situations such as LMCS or the like is considered, then the function funcAdd( ) may perform addition directly, or may perform addition after processing data therein, or may perform further processing after the addition is completed, etc.

If the symmetric relationship derived in the operation S5 is horizontal symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: an array of reconstructed samples of the current CB, recChromaBuf.

A derivation process is as follows.

$$For x = xCb … xCb + cbWidth - 1 , y = yCb … yCb + cbHeight - 1 , and xTemp = xCb + cbWidth - 1 … xCb :$$

$$xVb = xTemp \& ( recBufWidthC - 1 )$$

$$yVb = y \& ( recBufHeightC - 1 )$$

recChromaBuf[cIdx][xVb][yVb]=funcAdd(predSamples[cIdx][x][y], resiSamples[x][y])

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

If the symmetric relationship derived in the operation S5 is vertical symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: an array of reconstructed samples of the current CB, recChromaBuf.

A derivation process is as follows.

$$For x = xCb … xCb + cbWidth - 1 , y = yCb … yCb + cbHeight - 1 , and yTemp = yCb + cbHeight - 1 … yCb :$$

$$xVb = x \& ( recBufWidthC - 1 )$$

$$yVb = yTemp \& ( recBufHeightC - 1 )$$

$$recChromaBuf [ cIdx ] [ xVb ] [ yVb ] = funcAdd ( predSamples [ cIdx ] [ x ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

Second manner: it needs to perform the symmetric operation on reconstructed values during reconstruction, which is divided into two steps.

A two-step transformation is performed. A temporary buffer is used to store reconstructed samples of the CB after symmetry, and then the temporary buffer is written into the reconstructed buffer.

First step: the reconstructed samples after symmetry are stored in the temporary buffer.

If the symmetric relationship derived in the operation S5 is no symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: a temporary buffer of reconstructed chroma pixels, tempBuf.

A derivation process is as follows.

$$For x = xCb … xCb + cbWidth - 1 and y = yCb … yCb + cbHeight - 1 :$$

$$xVb = x \& ( tempBufWidthC - 1 )$$

$$yVb = y \& ( tempBufHeightC - 1 )$$

$$tempBuf [ cIdx ] [ xVb ] [ yVb ] = funcAdd ( predSam ples [ cIdx ] [ x ] [ y ] , resiSamples [ x ] [ y ] )$$

The tempBuf is a temporary buffer created to store the reconstructed chroma pixels of the current CB. The tempBufWidthC is a width of the tempBuf. The tempBufHeightC is a height of the tempBuf. The function funcAdd( ) may perform addition directly, or may perform addition after processing data therein, or may perform further processing after the addition is completed, etc.

If the symmetric relationship derived in the operation S5 is horizontal symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: a temporary buffer of reconstructed chroma pixels, tempBuf.

A derivation process is as follows.

$$For x = xCb … xCb + cbWidth - 1 , y = yCb … yCb + cbHeight - 1 , and xTemp = xCb + cbWidth - 1 … xCb :$$

$$xVb = xTemp \& ( tempBufWidthC - 1 )$$

$$yVb = y \& ( tempBufHeightC - 1 )$$

$$tempBuf [ cIdx ] [ xVb ] [ yVb ] = funcAdd ( predSam ples [ cIdx ] [ x ] [ y ] , resiSamples [ x ] [ y ] )$$

The tempBuf is a temporary buffer created to store the reconstructed chroma pixels of the current CB, the tempBufWidthC is a width of the tempBuf, and the tempBufHeightC is a height of the tempBuf. The function funcAdd( ) may perform addition directly, or may perform addition after processing data therein, or may perform further processing after the addition is completed, etc.

If the symmetric relationship derived in the operation S5 is vertical symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: a temporary buffer of reconstructed chroma pixels, tempBuf.

A derivation process is as follows.

$$For x = xCb … xCb + cbWidth - 1 , y = yCb … yCb + cbHeight - 1 , and yTemp = yCb + cbHeight - 1 … yCb :$$

$$xVb = x \& ( tempBufWidthC - 1 )$$

$$yVb = yTemp \& ( tempBufHeightC - 1 )$$

$$tempBuf [ cIdx ] [ xVb ] [ yVb ] = func ( predSamples [ cIdx ] [ x ] [ y ] , resiSamples [ x ] [ y ] )$$

The tempBuf is a temporary buffer created to store the reconstructed chroma pixels of the current CB, the tempBufWidthC is a width of the tempBuf, and the tempBufHeightC is a height of the tempBuf. The function funcAdd( ) may perform addition directly, or may perform addition after processing data therein, or may perform further processing after the addition is completed, etc.

Second step: the temporary buffer is written into the reconstructed buffer.

Inputs are: a variable picWidth, which specifies a width of the current picture in the chroma samples; a variable picHeight, which specifies a height of the current picture in the chroma samples; a variable cIdx, which specifies an index of a color component of the current block; and a temporary buffer of reconstructed chroma pixels, tempBuf.

Output is: an array of reconstructed samples, recPicChromaBuf.

$$For x = 0 … picWidth - 1 and y = 0 … picHeight - 1 :$$

$$xVb = x \& ( recBufWidthC - 1 )$$

$$yVb = y \& ( recBufHeightC - 1 )$$

$$recPicChromaBuf [ cIdx ] [ xVb ] [ yVb ] = tempBuf [ cIdx ] [ x ] [ y ]$$

The recPicChromaBuf is stored reconstructed chroma pixels. The recBufWidthC is a width of chroma pixels in a stored reconstructed pixel buffer, that is, a width of the recPicChromaBuf. The recBufHeightC is a height of the chroma pixels in the stored reconstructed pixel buffer, that is, a height of the recPicChromaBuf.

In operation S9, there are other situations.

If it is a PLANAR mode or a CCLM-type mode or another angular mode, reference pixels and mode parameters are acquired to perform chroma mode prediction.

In another embodiment, for the bitstream, the coding side plays a role of generating the bitstream, and the decoding side plays a role of parsing the bitstream. For a bitstream organization method:

### First Solution:

First manner: it is coded within MODE_INTRA.

Here, only one bitstream parsing position is listed for explanation:

It is added at a position before intra_chroma_pred_mode. Specific syntax elements are described in Table 13.

TABLE 13

| | |
|---|---|
| if(!cu_act_enabled_flag){ | |
| if(cbWidth/SubWidthC<=MaxTsSize&&cbHeight/ | |
| SubHeightC<=MaxTsSize&&sps_bdpcm_enabled_flag) | |
| intra_bdpcm_chroma_flag | ae(v) |
| if(intra_bdpcm_chroma_flag) | |
| intra_bdpcm_chroma_dir_flag | ae(v) |
| else{ | |
| if(CclmEnabled) | |
| cclm_mode_flag | ae(v) |
| if(cclm_mode_flag) | |
| cclm_mode_idx | ae(v) |
| else | |
| if(DbvEnabled) | |
| dbv_flag | ae(v) |
| if(!dbv_flag) | |
| intra_chroma_pred_mode | ae(v) |
| } | |
| } | |

If sps_ibc_enabled_flag is equal to 0 and sps_intratmp_enabled_flag is equal to 0, DbvEnabled is equal to 0. Otherwise, a variable ModeIncludeBv is set, if all corresponding luma blocks are not coded in the mode with BV information, the ModeIncludeBv is equal to 0; otherwise, the ModeIncludeBv is equal to 1.

The DbvEnabled is equal to 1 if all of the following multiple conditions are true (they include but are not limited to the following conditions):

ModeIncludeBv is equal to 1.

sh_slice_type is equal to I.

CtbLog2SizeC is less than or equal to MaxChromaIbcSize.

The MaxChromaIbcSize may be determined according to a size of the chroma CTU or a preset value.

Otherwise, the DbvEnabled is equal to 0.

If the DbvEnabled is equal to 0, dbv_flag is inferred to be FALSE.

When the dbv_flag is TRUE, it indicates that the current chroma prediction mode is the DBV, which includes but is not limited to the following binarization manners, and encoding may be performed by using a context model or a bypass model. Exemplarily, it is shown in Table 14, Table 15 and Table 16. Here, FL represents a fixed length.

TABLE 14

| | | |
|---|---|---|
| dbv_flag | FL | cMax = 1 |

TABLE 15

| Value of intra_chroma_pred_mode | Bin string |
|---|---|
| 0 | 100 |
| 1 | 101 |
| 2 | 110 |
| 3 | 111 |
| 4 | 0 |

TABLE 16

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| dbv_flag | 0 | na | na | na | na | na |
| intra_chroma_pred_mode | 0 | bypass | bypass | na | na | na |

or:

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| dbv_flag | bypass | na | na | na | na | na |
| intra_chroma_pred_mode | 0 | bypass | bypass | na | na | na |

Second manner: it is coded in MODE_IBC. Specific syntax elements are described in Table 17.

TABLE 17

| | |
|---|---|
| if(sh_slice_type!=I∥sps_ibc_enabled_flag){ | |
| if(treeType!=DUAL_TREE_CHROMA&& | |
| ((!(cbWidth==4&&cbHeight==4)&& | |
| modeType!=MODE_TYPE_INTRA)∥ | |
| (sps_ibc_enabled_flag&&cbWidth<=64&&cbHeight<=64))) | |
| cu_skip_flag[x0][y0] | ae(v) |
| if(cu_skip_flag[x0][y0]==0&&sh_slice_type!=I&& | |
| !(cbWidth==4&&cbHeight==4)&&modeType==MODE_TYPE_ALL) | |
| pred_mode_flag | ae(v) |
| if(((sh_slice_type==I&&cu_skip_flag[x0][y0]==0)∥ | |
| (sh_slice_type!=I&&(CuPredMode[chType][x0][y0]!=MODE_INTRA∥(((cb | |
| Width==4&&cbHeight==4)∥modeType==MODE_TYPE_INTRA) | |
| &&cu_skip_flag[x0][y0]==0))))&&cbWidth<=64&&cbHeight<=64&&mode | |
| Type!=MODE_TYPE_INTER&&sps_ibc_enabled_flag [symbol] | |
| [symbol] | |
| if(treeType!=DUAL_TREE_CHROMA∥ | |
| (treeType==DUAL_TREE_CHROMA&&DbvEnabled)){ | |
| pred_mode_ibc_flag | ae(v) |
| } | |
| } | |

If sps_ibc_enabled_flag is equal to 0 and sps_intratmp_enabled_flag is equal to 0, DbvEnabled is equal to 0. Otherwise, a variable ModeIncludeBv is set, if all the corresponding luma blocks are not coded in the mode with BV information, the ModeIncludeBv is equal to 0; otherwise, the ModeIncludeBv is equal to 1.

The DbvEnabled is equal to 1 if all the following multiple conditions are true (they include but are not limited to the following conditions):

ModeIncludeBv is equal to 1.

sh_slice_type is equal to I.

CtbLog2SizeC is less than or equal to MaxChromaIbcSize.

The MaxChromaIbc Size may be determined according to a size of the chroma CTU or a preset value.

Otherwise, the DbvEnabled is equal to 0.

When treeType==DUAL_TREE_CHIROMA, the DbvEnabled is equal to 0, then pred_mode_ibc_flag is inferred to be FALSE.

When treeType==DUAL_TREE_CHIROMA, pred_mode_ibc_flag being TRUE indicates that the current chroma prediction mode is the DBV mode. Exemplarily, it is shown in Table 18 and Table 19.

TABLE 18

| | | |
|---|---|---|
| pred_mode_ibc_flag | FL | cMax = 1 |

TABLE 19

| | ctxIdx of pred_mode_ibc_flag | | | | | | | | |
|---|---|---|---|---|---|---|---|---|---|
| Initialization variable | 0 | 1 | 2 | 3 | 4 | 5 | 6 | 7 | 8 |
| initValue | 17 | 42 | 36 | 0 | 57 | 44 | 0 | 43 | 45 |
| shiftIdx | 1 | 5 | 8 | 1 | 5 | 8 | 1 | 5 | 8 |

Second solution: the DM mode is modified, and specific syntax elements are described in Table 20. Furthermore, it includes but is not limited to the following binarization manners, and encoding may be performed by using a context model or a bypass model. Exemplarily, it is shown in Table 21 and Table 22.

TABLE 20

| | |
|---|---|
| if(!cu_act_enabled_flag){ | |
| if(cbWidth/SubWidthC<=MaxTsSize&&cbHeight/ | |
| SubHeightC<=MaxTsSize&&sps_bdpcm_enabled_flag) | |
| intra_bdpcm_chroma_flag | ae(v) |
| if(intra_bdpcm_chroma_flag) | |
| intra_bdpcm_chroma_dir_flag | ae(v) |
| else{ | |
| if(CclmEnabled) | |
| cclm_mode_flag | ae(v) |
| if(cclm_mode_flag) | |
| cclm_mode_idx | ae(v) |
| else | |
| intra_chroma_pred_mode | ae(v) |
| } | |
| } | |

TABLE 21

| | binIdx | | | | | |
|---|---|---|---|---|---|---|
| Syntax element | 0 | 1 | 2 | 3 | 4 | >=5 |
| cclm_mode_flag | 0 | na | na | na | na | na |
| cclm_mode_idx | 0 | bypass | na | na | na | na |
| intra_chroma_pred_mode | 0 | bypass | bypass | na | na | na |

TABLE 22

| Value of intra_chroma_pred_mode | Bin string |
|---|---|
| 0 | 100 |
| 1 | 101 |
| 2 | 110 |
| 3 | 111 |
| 4 | 0 |

A 0th bin of the intra_chroma_pred_mode represents the DM mode, and encoding manner is the same as VVC.

A derivation process of the DbvEnabled is as follows.

If sps_ibc_enabled_flag is equal to 0 and sps_intratmp_enabled_flag is equal to 0, the DbvEnabled is equal to 0.

Otherwise, the DbvEnabled is equal to 1 if all the following multiple conditions are true (they include but are not limited to the following conditions):

sh_slice_type is equal to I.

CtbLog2SizeC is less than or equal to MaxChromaIbcSize.

The MaxChromaIbcSize may be determined according to a size of the chroma CTU or a preset value.

If the DbvEnabled is equal to 1:

When intra_chroma_pred_mode is equal to four chroma prediction modes of 0, 1, 2 or 3, the four chroma prediction modes are kept unchanged; when intra_chroma_pred_mode is equal to 4, the second solution is implemented.

Otherwise, the chroma prediction process in the H.266 standard is kept unchanged.

Furthermore, in some embodiments, it is unnecessary to flip the residual data in the bitstream, and it needs to perform a symmetric flipping operation on the reference pixels during reconstruction. Specifically, a supplementary solution for deriving the residual samples in the operation S7 at the coding side and deriving the reconstructed samples in the operation S8 at the decoding side is provided.

In an implementation, in the operation S7 at the encoding side, predicted samples are symmetrically transformed according to the symmetric relationship in the operation S5, and then are subtracted from original samples, to obtain residual samples.

First manner: modification starts from the operation S5, a symmetric operation is directly performed on the predicted samples, and then the original samples are acquired to obtain residuals.

<1> Transformed predicted samples are acquired.

The transformed predicted samples are obtained according to the symmetric relationship derived in the operation S5 and the predicted samples acquired in the operation S6 in a manner which includes but is not limited to the following manners.

If the symmetric relationship derived in the operation S5 is no symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the currentCB in the chroma sample; a variable cIdx, which specifies an index of a color component of the current block; and an array of predicted samples of the current CB, predSamples.

Output is: an array of transformed predicted samples of the current CB, predTrsSamples.

A derivation process is as follows.

$$For x = xCb … xCb + cbWidth - 1 and y = yCb … yCb + cbHeight - 1 :$$

$$xVb = x \& ( predSamplesWidthC - 1 )$$

$$yVb = y \& ( predSamplesHeightC - 1 )$$

$$predTrsSamples [ cIdx ] [ x ] [ y ] = predSamples [ cIdx ] [ xVb ] [ yVb ]$$

The predSamples is stored predicted chroma pixels, the predSamplesWidthC is a width of the predSamples, and the predSamplesHeightC is a height of the predSamples.

If the symmetric relationship derived in the operation S5 is horizontal symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; and an array of predicted samples of the current CB, predSamples.

Output is: an array of transformed predicted samples of the current CB, predTrsSamples.

A derivation process is as follows.

$$For x = xCb … xCb + cbWidth - 1 , y = yCb … yCb + cbHeight - 1 , and xTemp = xCb + cbWidth - 1 … xCb :$$

$$xVb = xTemp \& ( predSamplesWidthC - 1 )$$

$$yVb = y \& ( predSamplesHeightC - 1 )$$

$$predTrsSamples [ cIdx ] [ x ] [ y ] = predSamples [ cIdx ] [ xVb ] [ yVb ]$$

The predSamples is stored predicted chroma pixels, the predSamplesWidthC is a width of the predSamples, and the predSamplesHeightC is a height of the predSamples.

If the symmetric relationship derived in the operation S5 is vertical symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; and an array of predicted samples of the current CB, predSamples.

Output is: an array of transformed predicted samples of the current CB, predTrsSamples.

A derivation process is as follows.

$$For x = xCb … xCb + cbWidth - 1 , y = yCb … yCb + cbHeight - 1 , and yTemp = yCb + cbHeight - 1 … yCb :$$

$$xVb = x \& ( predSamplesWidthC - 1 )$$

$$yVb = yTemp \& ( predSamplesHeightC - 1 )$$

$$predTrsSamples [ cIdx ] [ x ] [ y ] = predSamples [ cIdx ] [ xVb ] [ yVb ]$$

The predSamples is stored predicted chroma pixels, the predSamplesWidthC is a width of the predSamples, and the predSamplesHeightC is a height of the predSamples.

<2> Original samples are acquired.

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; and a variable cIdx, which specifies an index of a color component of the current block.

Output is: an array of original samples of the current CB, orgSamples.

A derivation process is as follows.

$$For x = xCb … xCb + cbWidth - 1 and y = yCb … yCb + cbHeight - 1 :$$

$$xVb = x \& ( orgBufWidthC - 1 )$$

$$yVb = y \& ( orgBufHeightC - 1 )$$

$$orgSamples [ cIdx ] [ x ] [ y ] = orgChromaBuf [ cIdx ] [ xVb ] [ yVb ]$$

The orgChromaBuf is stored original chroma pixels. The orgBufWidthC is a width of chroma pixels in a stored original pixel buffer, that is, a width of the orgChromaBuf. The orgBufHeightC is a height of the chroma pixels in the stored original pixel buffer, that is, a height of the orgChromaBuf.

<3> Residual samples are acquired.

The residual samples are derived according to the predicted samples acquired in <1> and the original samples acquired in <2>.

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; and the original samples orgSamples acquired in <2> of the operation S7 and the predicted samples predTrsSamples acquired in <1> of the operation S7.

Output is: an array of residual samples of the current CB, resiSamples.

A derivation process is as follows.

$$For x = xCb … xCb + cbWidth - 1 and y = yCb … yCb + cbHeight - 1 :$$

$$resiSamples [ cIdx ] [ x ] [ y ] = funcSub ( orgSamples [ cIdx ] [ x ] [ y ] , predTrsSamples [ cIdx ] [ x ] [ y ] )$$

The function funcSub( ) may perform subtraction between two parameters directly, or may perform operations after subtraction between the two parameters, such as further transformation, etc.

### Second Manner:

Similar to the operations S5 and S6 in the above embodiments, the residual samples are derived according to the predicted samples derived in the operation S6 and the original samples.

The original samples are acquired directly.

$$For x = xCb … xCb + cbWidth - 1 and y = yCb … yCb + cbHeight - 1 :$$

$$xVb = x \& ( orgVerPicBufWidthC - 1 )$$

$$yVb = y \& ( orgVerPicBufHeightC - 1 )$$

$$orgSamples [ cIdx ] [ xVb ] [ yVb ] = orgChromaBuf [ cIdx ] [ x ] [ y ]$$

If the symmetric relationship derived in the operation S5 is no symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; and the original samples orgSamples acquired in the operation S7 and the predicted samples predSamples acquired in the operation S6.

Output is: an array of residual samples of the current CB, resiSamples.

A derivation process is as follows.

$$For x = xCb … xCb + cbWidth - 1 and y = yCb … yCb + cbHeight - 1 :$$

$$resiSamples [ cIdx ] [ x ] [ y ] = funcSub ( orgSamples [ cIdx ] [ x ] [ y ] , predSamples [ cIdx ] [ x ] [ y ] )$$

The function funcSub( ) may perform subtraction between two parameters directly, or may perform operations after subtraction between the two parameters, such as further transformation, etc.

If the symmetric relationship derived in the operation S5 is horizontal symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; and the original samples orgSamples acquired in the operation S7 and the predicted samples predSamples acquired in the operation S6.

Output is: an array of residual samples of the current CB, resiSamples.

A derivation process is as follows.

$$For x = xCb … xCb + cbWidth - 1 , y = yCb … yCb + cbHeight - 1 , and xTemp = xCb + cbWidth - 1 … xCb :$$

$$resiSamples [ cIdx ] [ x ] [ y ] = funcSub ( orgSamples [ cIdx ] [ x ] [ y ] ,$$

$$predSamples [ cIdx ] [ xTemp ] [ y ] )$$

The function funcSub( ) may perform subtraction between two parameters directly, or may perform operations after subtraction between the two parameters, such as further transformation, etc.

If the symmetric relationship derived in the operation S5 is vertical symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; and the original samples orgSamples acquired in the operation S7 and the predicted samples predSamples acquired in the operation S6.

Output is: an array of residual samples of the current CB, resiSamples.

A derivation process is as follows.

$$For x = xCb … xCb + cbWidth - 1 , y = yCb … yCb + cbHeight - 1 , and yTemp = yCb + cbHeight - 1 … yCb :$$

$$resiSamples [ cIdx ] [ x ] [ y ] = funcSub ( orgSamples [ cIdx ] [ x ] [ y ] ,$$

$$predSamples [ cIdx ] [ x ] [ yTemp ] )$$

The function funcSub( ) may perform subtraction between two parameters directly, or may perform operations after subtraction between the two parameters, such as further transformation, etc.

In another implementation, in the operation S8 at the decoding side, predicted samples are transformed according to the symmetric relationship in the operation S5, and then are added to residual samples, to obtain reconstructed samples.

First manner: the predicted samples after the symmetric operation are acquired, and then the reconstructed samples are acquired.

<1> Transformed predicted samples are acquired.

<2> The reconstructed samples are acquired.

The transformed predicted samples and the residual samples obtained in the operation S7 are added together, to obtain the reconstructed samples recSamples, and then real reconstructed samples recChromaBuf are obtained.

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: an array of reconstructed samples of the current CB, recChromaBuf.

A derivation process is as follows.

$$For x = xCb … xCb + cbWidth - 1 and y = yCb … yCb + cbHeight - 1 :$$

$$xVb = x \& ( recBufWidthC - 1 )$$

$$yVb = y \& ( recBufHeightC - 1 )$$

$$recChromaBuf [ cIdx ] [ xVb ] [ yVb ] = funcAdd ( predSamples [ cIdx ] [ x ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

Second manner: the predicted samples are acquired directly, and then the reconstructed samples are acquired after the symmetric operation.

<1> The predicted samples are acquired.

<2> The reconstructed samples are acquired.

If the symmetric relationship derived in the operation S5 is no symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: an array of reconstructed samples of the current CB, recChromaBuf.

A derivation process is as follows.

$$For x = xCb … xCb + cbWidth - 1 and y = yCb … yCb + cbHeight - 1 :$$

$$xVb = x \& ( recBufWidthC - 1 )$$

$$yVb = y \& ( recBufHeightC - 1 )$$

$$recChromaBuf [ cIdx ] [ xVb ] [ yVb ] = funcAdd ( predSamples [ cIdx ] [ x ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

If the symmetric relationship derived in the operation S5 is horizontal symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: an array of reconstructed samples of the current CB, recChromaBuf.

A derivation process is as follows.

$$For x = xCb … xCb + cbWidth - 1 , y = yCb … yCb + cbHeight - 1 , and xTemp = xCb + cbWidth - 1 … xCb :$$

$$xVb = x \& ( recBufWidthC - 1 )$$

$$yVb = y \& ( recBufHeightC - 1 )$$

$$recChromaBuf [ cIdx ] [ xVb ] [ yVb ] = funcAdd ( predSamples [ cIdx ] [ xTemp ] [ y ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

If the symmetric relationship derived in the operation S5 is vertical symmetry:

Inputs are: a chroma position (xCb, yCb), which specifies a position of a top-left sample of the current CB relative to a top-left chroma sample of the current picture; a variable cbWidth, which specifies a width of the current coding block in the chroma samples; a variable cbHeight, which specifies a height of the current coding block in the chroma samples; a variable cIdx, which specifies an index of a color component of the current block; an array predSamples, which specifies reconstructed predicted samples of the current CB; and an array resiSamples, which specifies prediction residual samples of the current CB.

Output is: an array of reconstructed samples of the current CB, recChromaBuf.

A derivation process is as follows.

$$For x = xCb … xCb + cbWidth - 1 , y = yCb … yCb + cbHeight - 1 , and yTemp = yCb + cbWidth - 1 … yCb :$$

$$xVb = x \& ( recBufWidthC - 1 )$$

$$yVb = y \& ( recBufHeightC - 1 )$$

$$recChromaBuf [ cIdx ] [ xVb ] [ yVb ] = funcAdd ( predSamples [ cIdx ] [ x ] [ yTemp ] , resiSamples [ x ] [ y ] )$$

The recChromaBuf is stored reconstructed chroma pixels. The recBufWidthC is a width of chroma pixels in a stored reconstructed pixel buffer, that is, a width of the recChromaBuf. The recBufHeightC is a height of the chroma pixels in the stored reconstructed pixel buffer, that is, a height of the recChromaBuf. The function funcAdd( ) may perform addition directly, or may perform addition after processing data therein, or may perform further processing after the addition is completed, etc.

Further, in some embodiments, the BV is adjusted to be applied to chroma expansion. The chroma BV is corrected to obtain a corrected available BV.

After the chroma BV scaled according to the chroma sampling format is obtained, the chroma BV is further corrected. Before correction, it needs to determine whether the BV is available first. If the BV is available, the BV is corrected. Or, If the BV is not available, the BV is adjusted until it is available, and then the BV is corrected.

Determination manners are as follows.

A position (xCb, yCb) of the current chroma block is acquired, a chroma BVC=(BVCₕₒᵣ, BVCᵥₑᵣ) is acquired, to find a corresponding offset position (xCb+BVCₕₒᵣ, yCb+BVCᵥₑᵣ), the following conditions are determined, and if all of them are true, the chroma BV is available:
Whether an obtained offset position does not exceed a Picture boundary;
Whether the obtained offset position does not cover the current block, as shown in FIG. 10;
Whether the obtained offset position does not exceed an available area, as shown in FIG. 11; and
Whether the obtained offset position has been reconstructed.

Here, the correction includes but is not limited to the following manners. The correction is performed by using template search. That is, after obtaining the chroma BV, an offset position is found by using the position of the chroma block and the obtained chroma BV, and then a fine search is performed in the vicinity of the offset position by using a template, a range of the fine search needs to meet a defined available area, such as FIG. 11. Finally, an optimal chroma BV is obtained, and a reference block at an optimal offset position obtained after the fine search is copied, to obtain a predicted pixel, as shown in FIG. 12.

In this way, after obtaining the available BV, the method may skip the operation S4 and may enter the operation S5 directly.

Further, in some embodiments, a determination condition of the DM manner may be that there is BV information at any position in the entire corresponding luma area, which is described as follows.

In the DM mode, if the prediction information of the corresponding luma area includes the BV information, the current chroma block is coded in the DBV mode. For example:

If for x=xCb . . . xCb+cbWidth−1, y=yCb . . . yCb+cbHeight−1, there is any pair of (x, y) making CuPredMode[0][x][y] equal to MODE_IBC, then Intra_DBV_flag is set to 1, in such a case, the chroma intra prediction mode IntraPredModeC[xCb][yCb] uses the DBV mode.

If for x=xCb . . . xCb+cbWidth−1, y=yCb . . . yCb+cbHeight−1, there is any pair of (x, y) making CuPredMode[0][x][y] equal to MODE_INTRA, and IntraTmpFlag[x][y] is equal to 1, then Intra_DBV_flag is set to 1, in such a case, the chroma intra prediction mode IntraPredModeC[xCb][yCb] uses the DBV mode (The flag IntraTmpFlag is used to indicate whether the IntraTmp mode is used).

Further, in some embodiments, luma blocks at five luma pixel positions shown in FIG. 9 (they include but are not limited to the five positions, and may be multiple different positions) are sequentially acquired in an order which includes but is not limited to the following order: C->TL->TR->BL->BR.

At first, whether the acquired luma blocks at the five positions are coded in a mode with BV information is determined. If all the acquired luma blocks are not coded in the mode with BV information, the luma blocks are not acquired, and identifier of the DBV mode is not transmitted in a bitstream. If one or more luma blocks at the five positions are coded in the mode with BV information, the five positions may be re-acquired sequentially, until a first luma block meeting the following conditions is found: whether the luma block is coded in the mode with BV information is determined. Whether the BV is available is determined through the operation S3 and then the operation S4.

If the BV is available, this luma block may be selected as the luma block for acquiring the BV finally.

If the BV is not available, the luma block may not be acquired. And the next operation includes but is not limited to prediction by using a PLANAR mode or a CCLM-type mode or another angular prediction mode; or a first luma block coded in the mode with BV information is found, a BV of the first luma block is adjusted until it is available, and then this luma block is selected as the luma block for acquiring the BV finally.

Further, in some embodiments, when a corresponding residual of the current block where chroma prediction is performed in the DBV mode is transformed and inversely transformed in a manner which includes but is not limited to the following manners: only one transformation may be performed (for example, only the DCT transformation is performed without performing the LFNST transformation), or two transformations may be performed (a primary transformation and a secondary transformation, for example, the encoding side performs the DCT transformation and then performs the LFNST transformation). Forward transformation manners implemented by the decoding side and the encoding side are kept consistent in a reverse order.

It may be understood that in the embodiments of the disclosure, since in the original DBV prediction process, operations of chroma IBC prediction are to locate a reference chroma block and simply perform a block copy process. At this time, for a video with screen content, when the reference chroma block and the current prediction block are in a symmetrical relationship, existing information such as BV, reconstructed luma or the like cannot be effectively used to process this part of the content, such that a good prediction is not achieved. Furthermore, whether the luma CU is in the IBC mode is determined only, which does not fully use BV information of the related art such as Intra TMP or the like to perform prediction, losing coding efficiency. Based on this, the embodiments of the disclosure propose a new chroma prediction manner. On one hand, advantages of existing technologies are fully used, which improves singleness of chroma prediction. Further, information of the co-located luma area is fully used, which effectively improves accuracy of the chroma prediction. On the other hand, the available information such as reconstructed luma, BV or the like are fully considered, and the predicted value is processed in more detail according to these information, and the operation related to the symmetrical relationship improves accuracy of the predicted value.

According to the encoding method and the decoding method shown in the embodiments of the disclosure, their test data are shown in Table 23. It may be seen from the test data that the main technical solution improves coding performance.

TABLE 23

| | AllIntraMain10 | | | | |
|---|---|---|---|---|---|
| | Y | U | V | EncT | DecT |
| ClassF | −0.31% | −0.66% | −0.38% | | |
| ClassTGM | −1.86% | −2.05% | −2.56% | | |

In short, specific implementations of the above embodiments are described in detail through this embodiment, from which it may be seen that the chroma block may be predicted effectively and accurately. This solution fully considers available information such as reconstructed luma, BV or the like, and predicts chroma according to these information, which improves singleness of chroma prediction. Further, this solution considers the symmetric relationship, and processes the predicted value in more detail. Existing technologies and information of the co-located luma area are fully used, improving coding efficiency effectively.

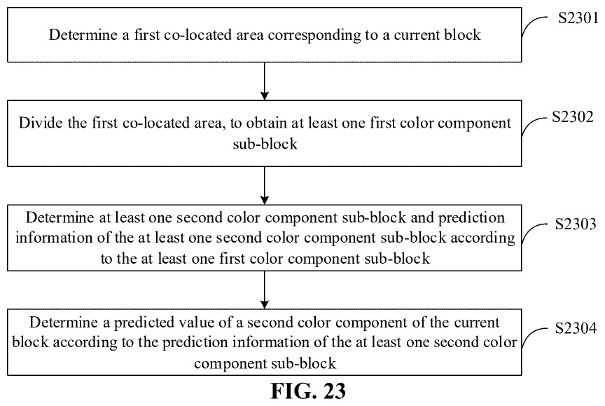

In yet another implementation of the disclosure, with reference to FIG. 23, a schematic flowchart of another decoding method according to embodiments of the disclosure is shown. As shown in FIG. 23, the method may include the following operations S2301 to S2304.

In operation S2301, a first co-located area corresponding to a current block is determined.

It should be noted that the decoding method of the embodiments of the disclosure is applied to a decoder. Furthermore, the decoding method may specifically refer to an intra prediction method, and more specifically, refer to a method which performs prediction by using a DBV mode and is applied to a sub-block. The video picture may be divided into multiple decoded blocks. Each of the decoded blocks may include a first color component, a second color component and a third color component. The current block in the embodiments of the disclosure refers to a decoding block to be intra predicted currently from the video picture. Here, the current block may be divided into at least one sub-block, and then prediction processing of the DBV mode is performed in unit of the sub-block.

It should also be noted that in the embodiments of the disclosure, if the at least one sub-block is only one sub-block, the technical solution at this time is the same as that of the above embodiments. If the first color component is a luma component and the second color component is a chroma component, BV parameters applied to chroma are still determined according to the luma BV in the embodiments of the disclosure.

In some embodiments, the operation of determining the first co-located area corresponding to the current block may include that: position information of the current block and size information of the current block are determined; the position information of the current block is scaled according to a preset sampling format, to obtain position information of a co-located area corresponding to the current block; the size information of the current block is scaled according to the preset sampling format, to obtain size information of the co-located area corresponding to the current block; and the first co-located area corresponding to the current block is determined according to the position information of the co-located area and the size information of the co-located area corresponding to the current block.

It should be noted that in the embodiments of the disclosure, the first co-located area may refer to a first color component area located at the same position as the current block. For example, if the current block is the chroma component, the first co-located area refers to a co-located luma area corresponding to the current block. For the current block, in the first co-located area, block division may be performed on the current block, for example, by using a binary tree structure, a ternary tree structure, a quadtree structure, or the like, to obtain multiple blocks. Each of the blocks may be considered as a CU, a sub-block, or a transform block, or the like, to obtain at least one first color component sub-block.

It should also be noted that in the embodiments of the disclosure, the preset sampling format here may be as shown in the above Table 8 or Table 9. Exemplarily, a position of the current chroma block, chromaPos=(xCb, yCb) is acquired, the chromaPos is scaled according to the chroma sampling format shown in Table 8, to obtain a position of the co-located luma area corresponding to the current chroma block, lumaPos=(xCb_Y, yCb_Y). A size of the current chroma block, chromaSize=(cbWidth, cbHeight) is acquired, and the chromaSize is scaled according to the chroma sampling format shown in Table 9, to obtain a size of the co-located luma area corresponding to the current chroma block, lumaSize=(cbWidth_Y, cbHeight Y). Therefore, the first co-located area corresponding to the current block may be determined.

In operation S2302, the first co-located area is divided, to obtain at least one first color component sub-block.

It should be noted that in the embodiments of the disclosure, the block division here may also refer to performing area division on the first co-located area, to obtain at least one first color component sub-area. Exemplarily, the co-located luma area corresponding to the current block is divided into luma sub-areas, which is specifically as follows.

Inputs are: a luma position (xCb, yCb), which specifies a position of a position of a top-left luma sample of the co-located luma area corresponding to the current chroma block relative to a top-left luma sample of the current picture; a variable cbWidth, which specifies a width of the current CB in the luma samples; a variable cbHeight, which specifies a height of the current CB in the luma samples; a variable SbWidth, which specifies a width of the luma sub-area; and a variable SbHeight, which specifies a height of the luma sub-area.

Output is: the luma sub-area.

A number numSbX of luma coding sub-blocks in a horizontal direction and a number numSbY of luma coding sub-blocks in a vertical direction are derived as follows:

$$numSbX = cbWidth / SbWidth$$

$$numSbY = cbHeight / SbHeight$$

$$For xSbIdx = 0 … numSbX - 1 and ySbIdx = 0 … numSbY - 1 :$$

$$xCbY = xCb + xSbIdx * SbWidth$$

$$yCbY = yCb + ySbIdx * SbHeight$$

The luma sub-area is a luma area with a position of (xCbY, yCbY) and a size of (SbWidth, SbHeight).

In operation S2303, at least one second color component sub-block and prediction information of the at least one second color component sub-block are determined according to the at least one first color component sub-block.

In the embodiments of the disclosure, the operation of determining at least one second color component sub-block according to the at least one first color component sub-block may include that: a horizontal sampling factor and a vertical sampling factor are determined according to a preset sampling format; and position information of the first color component sub-block is adjusted according to the horizontal sampling factor and the vertical sampling factor, to determine the second color component sub-block.

In some embodiments, the operation of adjusting the position information of the first color component sub-block according to the horizontal sampling factor and the vertical sampling factor, to determine the second color component sub-block may include that: a horizontal coordinate of the first color component sub-block is adjusted according to the horizontal sampling factor, to obtain a horizontal coordinate of the second color component sub-block; a vertical coordinate of the first color component sub-block is adjusted according to the vertical sampling factor, to obtain a vertical coordinate of the second color component sub-block; and the second color component sub-block is determined according to the horizontal coordinate of the second color component sub-block and the vertical coordinate of the second color component sub-block.

Exemplarily, prediction information of a chroma sub-area is derived from the luma sub-area, and the chroma sub-area is derived as follows.

A variable SubWidthC, which specifies a horizontal sampling ratio of the chroma; and a variable SubHeightC, which specifies a vertical sampling ratio of the chroma. A derivation process of the SubWidthC and the SubHeightC is shown in Table 24.

TABLE 24

| | color sampling | | |
|---|---|---|---|
| sps_chroma_format_idc | format | SubWidthC | SubHeightC |
| 0 | monochrome | 1 | 1 |
| 1 | 4:2:0 | 2 | 2 |
| 2 | 4:2:2 | 2 | 1 |
| 3 | 4:4:4 | 1 | 1 |

A luma position (xCb, yCb), which specifies a position of a position of a top-left luma sample of the co-located luma area corresponding to the current chroma block relative to a top-left luma sample of the current picture; numSbX, which specifies a number of luma coding sub-blocks in the horizontal direction; numSbY, which specifies a number of luma coding sub-blocks in the vertical direction; a variable SbWidth, which specifies a width of the luma sub-area; a variable SbHeight, which specifies a height of the luma sub-area.

### Chroma Position:

$$For xSbIdx = 0 … numSbX - 1 and ySbIdx = 0 … numSbY - 1 :$$

$$xCbC = xCb / SubWidthC + xSbIdx * ( SbWidth / SubWidthC )$$

$$yCbC = yCb / SubHeightC + ySbIdx * ( SbHeight / SubHeightC )$$

The chroma sub-area is a chroma area with a position of (xCbC, yCbC) and a size of ((SbWidth/SubWidthC), (SbHeight/SubHeightC)).

In some embodiments, the operation of determining the prediction information of the at least one second color component sub-block may include that: prediction information of the at least one first color component sub-block is determined; and the prediction information of the at least one second color component sub-block is determined according to the prediction information of the at least one first color component sub-block.

In some embodiments, the method may further include that: when the prediction information of the first color component sub-block includes BV information, a first BV parameter of the first color component sub-block is determined; the first BV parameter of the first color component sub-block is adjusted, to determine a second BV parameter of the second color component sub-block; and the prediction information of the second color component sub-block is determined according to the second BV parameter of the second color component sub-block.

In some embodiments, the method may further include that: when the prediction information of the first color component sub-block does not include the BV information, a preset prediction mode is acquired, and the preset prediction mode is determined as the prediction information of the second color component sub-block; or, when the prediction information of the first color component sub-block does not include the BV information, additional information of the second color component sub-block is determined, and the prediction information of the second color component sub-block is determined according to the additional information.

In some embodiments, the method may further include the operation of adjusting the first BV parameter of the first color component sub-block, to determine the second BV parameter of the second color component sub-block, which may include that: the first BV parameter of the first color component sub-block is scaled according to a preset sampling format, to determine the second BV parameter of the second color component sub-block.

In some embodiments, the operation of adjusting the first BV parameter of the first color component sub-block, to determine the second BV parameter of the second color component sub-block may include that: the first BV parameter of the first color component sub-block is scaled according to a preset sampling format, to obtain an initial BV parameter of the second color component sub-block; and the initial BV parameter of the second color component sub-block is corrected, to determine the second BV parameter of the second color component sub-block.

In some embodiments, the method may further include that: after determining the second BV parameter of the second color component sub-block, whether the second BV parameter meets an availability condition is determined; and when the second BV parameter meets the availability condition, the second BV parameter is determined as the prediction information of the second color component sub-block.

In some embodiments, whether the second BV parameter meets the availability condition may be determined according to at least the following:
an offset position indicated according to position information of the current block and the second BV parameter does not exceed an picture boundary;
the offset position indicated according to the position information of the current block and the second BV parameter does not cover the current block;
the offset position indicated according to the position information of the current block and the second BV parameter does not exceed a preset available area; and
the offset position indicated according to the position information of the current block and the second BV parameter has been reconstructed.

In some embodiments, whether the second BV parameter meets the availability condition may be determined according to at least the following:
an offset position indicated according to position information of the second color component sub-block and the second BV parameter does not exceed an picture boundary;
the offset position indicated according to the position information of the second color component sub-block and the second BV parameter does not cover the current block;
the offset position indicated according to the position information of the second color component sub-block and the second BV parameter does not exceed a preset available area; and
the offset position indicated according to the position information of the second color component sub-block and the second BV parameter has been reconstructed.

It should be noted that in the embodiments of the disclosure, whether the second BV parameter is available may be determined according to the position of the current block and the second BV parameter, or may be determined according to the position of the current chroma sub-area and the second BV parameter, which is not limited in any way in the embodiments of the disclosure.

In some embodiments, the method may further include that: when the second BV parameter does not meet the availability condition, additional information of the second color component sub-block is determined; and the prediction information of the second color component sub-block is determined according to the additional information.

In some embodiments, the method may further include that: after determining the additional information of the second color component sub-block, whether the additional information is a BV parameter is determined; and if the additional information is the BV parameter, the BV parameter is determined as the prediction information of the second color component sub-block.

In some embodiments, the method may further include that: if the additional information is a non-BV parameter, a preset prediction mode is acquired, and the preset prediction mode is determined as the prediction information of the second color component sub-block.

In some embodiments, the operation of determining the additional information of the second color component sub-block may include that: a first color component block for the current block is determined; when a prediction mode for the first color component block meets a first condition, a first BV parameter of the first color component block is determined; the first BV parameter of the first color component block is adjusted, to determine the second BV parameter of the second color component sub-block; and the additional information of the second color component sub-block is determined according to the second BV parameter.

In some embodiments, the method may further include that: after determining the second BV parameter of the second color component sub-block, whether the second BV parameter meets the availability condition is determined; and when the second BV parameter meets the availability condition, the second BV parameter is determined as the additional information of the second color component sub-block.

In some embodiments, the method may further include that: the additional information of the second color component sub-block is stored.

It should be noted that the additional information of the second color component sub-block may refer to a basic additional chroma BV. In the embodiments of the disclosure, a determination manner of the basic additional chroma BV is similar to determination of the second BV parameter in the above embodiments, and is not described in detail here.

It should also be noted that in the embodiments of the disclosure, if the prediction mode for the first color component block does not meet the first condition, a preset prediction mode may be acquired, such as an intra prediction mode other than IntraTMP, and then chroma prediction is performed according to the preset prediction mode.

In some embodiments, the method may further include that: when the prediction mode for the first color component block does not meet the first condition, an operation of decoding a bitstream to determine a target prediction mode for the current block is not performed.

In operation S2304, a predicted value of a second color component of the current block is determined according to the prediction information of the at least one second color component sub-block.

In some embodiments, the operation of determining the predicted value of the second color component of the current block according to the prediction information of the at least one second color component sub-block may include that: the at least one second color component sub-block is predicted according to the prediction information of the at least one second color component sub-block respectively, to determine a predicted value of the at least one second color component sub-block; and the predicted value of the second color component of the current block is determined according to the predicted value of the at least one second color component sub-block.

In some embodiments, the operation of predicting, according to the prediction information of the at least one second color component sub-block, the at least one second color component sub-block respectively, to determine the predicted value of the at least one second color component sub-block may include that: a second BV parameter of the second color component sub-block is determined according to the prediction information of the second color component sub-block; an offset position of the second color component sub-block is determined according to the second BV parameter and position information of the second color component sub-block; block copy is performed according to the offset position of the second color component sub-block, to obtain a first prediction sub-block; and the predicted value of the second color component sub-block is determined according to the first prediction sub-block.

In some embodiments, the method may further include that: a correction operation is performed on the first prediction sub-block, to determine the predicted value of the second color component sub-block.

It should be noted that in the embodiments of the disclosure, for each second color component sub-block, prediction information of a corresponding second color component sub-block is determined according to the prediction information of the first color component sub-block; then, the second color component sub-block is predicted according to the determined prediction information, to obtain a predicted value of the second color component sub-block; and after obtaining the predicted value of each second color component sub-block, the predicted value of the second color component of the current block may be determined.

It should also be noted that in the embodiments of the disclosure, the correction operation here may include a clip operation, a filtering operation, an operation of weighting with predicted values obtained in other prediction modes, or the like, which is not limited in any way.

It should also be noted that in the embodiments of the disclosure, after determining the predicted value of the second color component of the current block, a reconstructed value of the second color component of the current block may also be determined according to the predicted value of the second color component of the current block.

In a possible implementation, for determination of the reconstructed value, the method may further include that: a bitstream is parsed to determine a residual value of the at least one second color component sub-block; and a reconstructed value of the at least one second color component sub-block is determined according to the predicted value of the at least one second color component sub-block and the residual value of the at least one second color component sub-block.

In another possible implementation, for determination of the reconstructed value, the method may further include that: a target symmetric relationship is determined; an initial reconstructed value of the second color component sub-block is determined according to the predicted value of the second color component sub-block and the residual value of the second color component sub-block; and the initial reconstructed value is transformed according to the target symmetric relationship, to determine the reconstructed value of the second color component sub-block.

In yet another possible implementation, for determination of the reconstructed value, the method may further include that: a target symmetric relationship is determined; the predicted value of the second color component sub-block is transformed according to the target symmetric relationship, to determine a transformed predicted value of the second color component sub-block; and the reconstructed value of the second color component sub-block is determined according to the transformed predicted value of the second color component sub-block and the residual value of the second color component sub-block.

It should be noted that in the embodiments of the disclosure, the target symmetric relationship may be obtained by parsing the bitstream, or may be determined according to derivation of the symmetric relationship described in the above embodiments.

It should also be noted that in the embodiments of the disclosure, the decoding method is applied to prediction processing in unit of the sub-block, and the decoding method shown in FIG. 6 may also be applied to the sub-block. Similarly, the decoding method shown in FIG. 23 may also be used to determine the symmetric relationship and perform prediction processing according to the symmetric relationship, which is not limited in any way here.

This embodiments provide a decoding method, in which a first co-located area corresponding to a current block is determined; the first co-located area is divided, to obtain at least one first color component sub-block; at least one second color component sub-block and prediction information of the at least one second color component sub-block are determined according to the at least one first color component sub-block; and a predicted value of a second color component of the current block is determined according to the prediction information of the at least one second color component sub-block. In this way, the current block is predicted by dividing the current block into sub-areas, to adaptively provide multiple options according to different contents and luma prediction information, such that DBV prediction is more effective, thereby further improving coding efficiency.

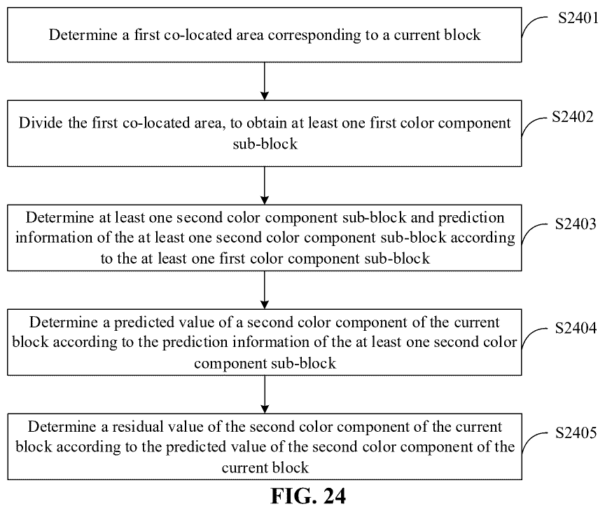

In yet another implementation of the disclosure, with reference to FIG. 24, a schematic flowchart of another encoding method according to embodiments of the disclosure is shown. As shown in FIG. 24, the method may include the following operations S2401 to S2405.

In operation S2401, a first co-located area corresponding to a current block is determined.

It should be noted that the encoding method of the embodiments of the disclosure is applied to an encoder. Furthermore, the encoding method may specifically refer to an intra prediction method, and more specifically, refer to a method which performs prediction by using a DBV mode and is applied to a sub-block. The video picture may be divided into multiple CBs. Each of the CBs may include a first color component, a second color component and a third color component. The current block in the embodiments of the disclosure refers to a CB to be intra predicted currently from the video picture. Here, the current block may be divided into at least one sub-block, and then prediction processing of the DBV mode is performed in unit of the sub-block.

In some embodiments, the operation of determining the first co-located area corresponding to the current block may include that: position information of the current block and size information of the current block are determined; the position information of the current block is scaled according to a preset sampling format, to obtain position information of a co-located area corresponding to the current block; the size information of the current block is scaled according to the preset sampling format, to obtain size information of the co-located area corresponding to the current block; and the first co-located area corresponding to the current block is determined according to the position information of the co-located area and the size information of the co-located area corresponding to the current block.

In operation S2402, the first co-located area is divided, to obtain at least one first color component sub-block.

In operation S2403, at least one second color component sub-block and prediction information of the at least one second color component sub-block are determined according to the at least one first color component sub-block.

It should be noted that in the embodiments of the disclosure, it needs to divide the first co-located area, to obtain at least one first color component sub-block, which may be referred to as at least one first color component sub-area. Then at least one second color component sub-block and prediction information of the at least one second color component sub-block are derived according to the at least one first color component sub-area.

In some embodiments, the operation of determining at least one second color component sub-block according to the at least one first color component sub-block may include that: a horizontal sampling factor and a vertical sampling factor are determined according to a preset sampling format; and position information of the first color component sub-block is adjusted according to the horizontal sampling factor and the vertical sampling factor, to determine the second color component sub-block.

In some embodiments, the operation of adjusting the position information of the first color component sub-block according to the horizontal sampling factor and the vertical sampling factor, to determine the second color component sub-block may include that: a horizontal coordinate of the first color component sub-block is adjusted according to the horizontal sampling factor, to obtain a horizontal coordinate of the second color component sub-block; a vertical coordinate of the first color component sub-block is adjusted according to the vertical sampling factor, to obtain a vertical coordinate of the second color component sub-block; and the second color component sub-block is determined according to the horizontal coordinate of the second color component sub-block and the vertical coordinate of the second color component sub-block.

In some embodiments, the operation of determining the prediction information of the at least one second color component sub-block may include that: prediction information of the at least one first color component sub-block is determined; and the prediction information of the at least one second color component sub-block is determined according to the prediction information of the at least one first color component sub-block.

In some embodiments, the method may further include that: when the prediction information of the first color component sub-block includes BV information, a first BV parameter of the first color component sub-block is determined; the first BV parameter of the first color component sub-block is adjusted, to determine a second BV parameter of the second color component sub-block; and the prediction information of the second color component sub-block is determined according to the second BV parameter of the second color component sub-block.

In some embodiments, the method may further include that: when the prediction information of the first color component sub-block does not include the BV information, a preset prediction mode is acquired, and the preset prediction mode is determined as the prediction information of the second color component sub-block; or, when the prediction information of the first color component sub-block does not include the BV information, additional information of the second color component sub-block is determined, and the prediction information of the second color component sub-block is determined according to the additional information.

In some embodiments, the operation of adjusting the first BV parameter of the first color component sub-block, to determine the second BV parameter of the second color component sub-block may include that: the first BV parameter of the first color component sub-block is scaled according to a preset sampling format, to determine the second BV parameter of the second color component sub-block.

In some embodiments, the operation of adjusting the first BV parameter of the first color component sub-block, to determine the second BV parameter of the second color component sub-block may include that: the first BV parameter of the first color component sub-block is scaled according to a preset sampling format, to obtain an initial BV parameter of the second color component sub-block; and the initial BV parameter of the second color component sub-block is corrected, to determine the second BV parameter of the second color component sub-block.

In some embodiments, the method may further include that: after determining the second BV parameter of the second color component sub-block, whether the second BV parameter meets an availability condition is determined; and when the second BV parameter meets the availability condition, the second BV parameter is determined as the prediction information of the second color component sub-block.

In some embodiments, whether the second BV parameter meets the availability condition may be determined according to at least the following:
an offset position indicated according to position information of the current block and the second BV parameter does not exceed an picture boundary;
the offset position indicated according to the position information of the current block and the second BV parameter does not cover the current block;
the offset position indicated according to the position information of the current block and the second BV parameter does not exceed a preset available area; and
the offset position indicated according to the position information of the current block and the second BV parameter has been reconstructed.

In some embodiments, whether the second BV parameter meets the availability condition may be determined according to at least the following:
an offset position indicated according to position information of the second color component sub-block and the second BV parameter does not exceed an picture boundary;
the offset position indicated according to the position information of the second color component sub-block and the second BV parameter does not cover the current block;
the offset position indicated according to the position information of the second color component sub-block and the second BV parameter does not exceed a preset available area; and
the offset position indicated according to the position information of the second color component sub-block and the second BV parameter has been reconstructed.

In some embodiments, the method may further include that: when the second BV parameter does not meet the availability condition, additional information of the second color component sub-block is determined; and the prediction information of the second color component sub-block is determined according to the additional information.

In some embodiments, the method may further include that: after determining the additional information of the second color component sub-block, whether the additional information is a BV parameter is determined; and if the additional information is the BV parameter, the BV parameter is determined as the prediction information of the second color component sub-block.

In some embodiments, the method may further include that: if the additional information is a non-BV parameter, a preset prediction mode is acquired, and the preset prediction mode is determined as the prediction information of the second color component sub-block.

In some embodiments, the operation of determining the additional information of the second color component sub-block may include that: a first color component block for the current block is determined; when a prediction mode for the first color component block meets a first condition, a first BV parameter of the first color component block is determined; the first BV parameter of the first color component block is adjusted, to determine the second BV parameter of the second color component sub-block; and the additional information of the second color component sub-block is determined according to the second BV parameter.

In some embodiments, the method may further include that: after determining the second BV parameter of the second color component sub-block, whether the second BV parameter meets the availability condition is determined; and when the second BV parameter meets the availability condition, the second BV parameter is determined as the additional information of the second color component sub-block.

In some embodiments, the method may further include that: the additional information of the second color component sub-block is stored.

In some embodiments, the method may further include that: when the prediction mode for the first color component block does not meet the first condition, a target prediction mode for the current block is not coded.

In operation S2404, a predicted value of a second color component of the current block is determined according to the prediction information of the at least one second color component sub-block.

In operation S2405, a residual value of the second color component of the current block is determined according to the predicted value of the second color component of the current block.

It should be noted that in the embodiments of the disclosure, the operation of determining the predicted value of the second color component of the current block according to the prediction information of the at least one second color component sub-block may include that: the at least one second color component sub-block is predicted according to the prediction information of the at least one second color component sub-block respectively, to determine a predicted value of the at least one second color component sub-block; and the predicted value of the second color component of the current block is determined according to the predicted value of the at least one second color component sub-block.

In some embodiments, the operation of predicting, according to the prediction information of the at least one second color component sub-block, the at least one second color component sub-block respectively, to determine the predicted value of the at least one second color component sub-block may include that: a second BV parameter of the second color component sub-block is determined according to the prediction information of the second color component sub-block; an offset position of the second color component sub-block is determined according to the second BV parameter and position information of the second color component sub-block; block copy is performed according to the offset position of the second color component sub-block, to obtain a first prediction sub-block; and the predicted value of the second color component sub-block is determined according to the first prediction sub-block.

In some embodiments, the method may further include that: a correction operation is performed on the first prediction sub-block, to determine the predicted value of the second color component sub-block.

It should also be noted that in the embodiments of the disclosure, the operation of determining the residual value of the second color component of the current block according to the predicted value of the second color component of the current block may include that: an original value of the second color component sub-block is determined; and a residual value of the second color component sub-block is determined according to the original value of the second color component sub-block and a predicted value of the second color component sub-block.

Further, in some embodiments, the operation of determining the residual value of the second color component sub-block according to the original value of the second color component sub-block and the predicted value of the second color component sub-block may include that: a target symmetric relationship is determined; the original value of the second color component sub-block is transformed according to the target symmetric relationship, to determine an initial value of the second color component sub-block; and the residual value of the second color component sub-block is determined according to the initial value of the second color component sub-block and the predicted value of the second color component sub-block.

Further, in some embodiments, the operation of determining the residual value of the second color component sub-block according to the original value of the second color component sub-block and the predicted value of the second color component sub-block may include that: a target symmetric relationship is determined; the predicted value of the second color component sub-block is transformed according to the target symmetric relationship, to determine a transformed predicted value of the second color component sub-block; and the residual value of the second color component sub-block is determined according to the original value of the second color component sub-block and the transformed predicted value of the second color component sub-block.

Further, in some embodiments, the method may further include that: the residual value of the second color component sub-block is coded, and obtained coded bits are written into a bitstream.

It should also be noted that in the embodiments of the disclosure, the encoding method is applied to prediction processing in unit of the sub-block, and the encoding method shown in FIG. 18 may also be applied to the sub-block. Similarly, the encoding method shown in FIG. 24 may also determine the symmetric relationship and perform prediction processing according to the symmetric relationship, which is not limited in any way here.

This embodiments provide an encoding method, in which a first co-located area corresponding to a current block is determined; the first co-located area is divided, to obtain at least one first color component sub-block; at least one second color component sub-block and prediction information of the at least one second color component sub-block are determined according to the at least one first color component sub-block; and a predicted value of a second color component of the current block is determined according to the prediction information of the at least one second color component sub-block. In this way, the current block is predicted by dividing the current block into sub-areas, to adaptively provide multiple options according to different contents and luma prediction information, such that DBV prediction is more effective, thereby further improving coding efficiency.

In yet another embodiments of the disclosure, based on the encoding method and the decoding method described in the above embodiments, the embodiments of the disclosure also adds a new prediction mode, DBV (that is, third solution). In a process of the third solution, a co-located luma area corresponding to a current chroma block is acquired, luma sub-areas are divided, then prediction information of each luma sub-area is acquired, then prediction information of each chroma sub-area is acquired, and finally chroma prediction is performed.

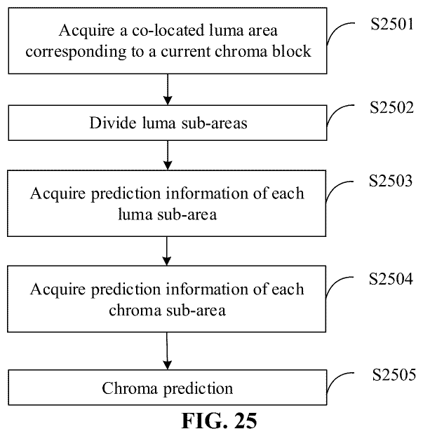

With reference to FIG. 25, a detailed schematic flowchart of yet another encoding/decoding method according to embodiments of the disclosure is shown. As shown in FIG. 25, the detailed flow may include the following operations S2501 to S2505.

In operation S2501, a co-located luma area corresponding to a current chroma block is acquired.

In operation S2502, luma sub-areas are divided.

In operation S2503, prediction information of each luma sub-area is acquired.

In operation S2504, prediction information of each chroma sub-area is acquired.

In operation S2505, chroma prediction is performed.

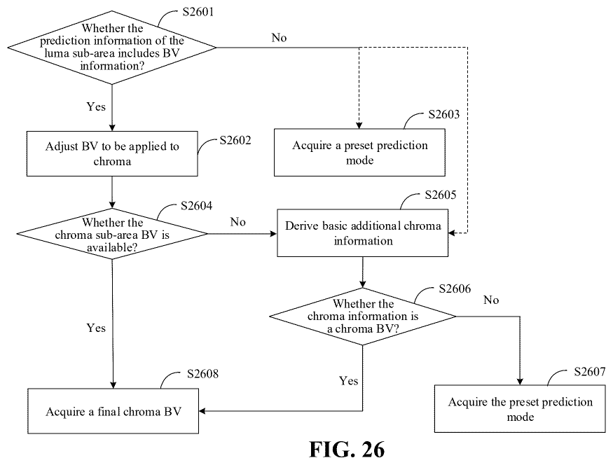

Further, for acquisition of the prediction information of each luma sub-area, specifically, as shown in FIG. 26, the detailed flow may include the following operations S2601 to S2608.

In operation S2601, whether the prediction information of the luma sub-area includes BV information is determined.

In operation S2602, if yes in the operation S2601, BVs are adjusted to determine a chroma sub-area BV applied to chroma.

In operation S2603, if no in the operation S2601, a preset prediction mode is acquired.

In operation S2604, whether the chroma sub-area BV is available is determined.

In operation S2605, if no in the operation S2604, basic additional chroma information is derived.

In operation S2606, whether the additional chroma information is a chroma BV is determined.

In operation S2607, if no in the operation S2606, the preset prediction mode is acquired.

In operation S2608, if yes in the operation S2604 or if yes in S2606, a final chroma BV is acquired.

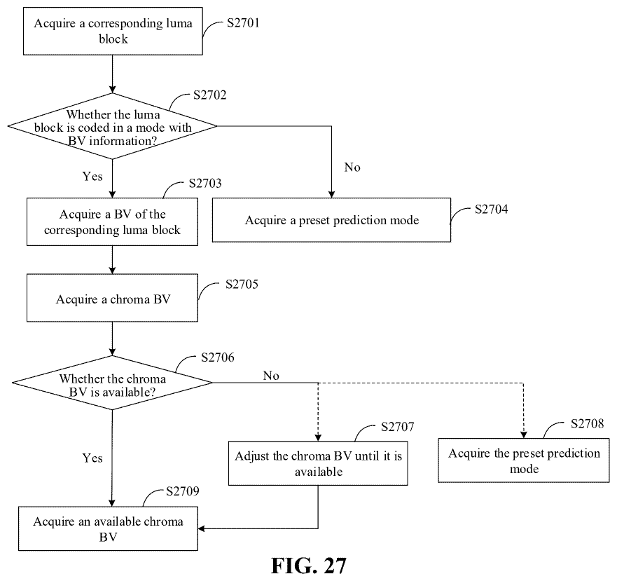

Further, for derivation of the basic additional chroma information, specifically, as shown in FIG. 27, the detailed flow may include the following operations S2701 to S2709.

In operation S2701, a corresponding luma block is acquired.

In operation S2702, whether the corresponding luma block is coded in a mode with BV information is determined.

In operation S2704, if no in the operation S2702, a preset prediction mode is acquired.

In operation S2703, if yes in the operation S2702, a BV of the corresponding luma block is acquired.

In operation S2705, a chroma BV is acquired.

In operation S2706, whether the chroma BV is available is determined.

In operation S2707, if no in the operation S2706, the chroma BV is adjusted until it is available.

In operation S2708, if no in the operation S2706, the preset prediction mode is acquired.

In operation S2709, an available chroma BV is acquired.

In a specific embodiment, according to FIG. 25 to FIG. 27, the process may specifically include the following operations S1 to S4.

In operation S1, a co-located luma area corresponding to a current chroma block is acquired.

As shown in the above FIG. 13, a position of the current chroma block, chromaPos=(xCb, yCb) is acquired. The chromaPos is scaled according to the chroma sampling format shown in Table 8, to obtain a position of the co-located luma area corresponding to the current chroma block, lumaPos=(xCb_Y, yCb_Y).

A size of the current chroma block, chromaSize=(cbWidth, cbHeight) is acquired. The chromaSize is scaled according to the chroma sampling format shown in Table 9, to obtain a size of the co-located luma area corresponding to the current chroma block, lumaSize=(cbWidth_Y, cbHeight Y).

In operation S2, luma sub-areas are divided.

The co-located luma area corresponding to the current chroma block is divided into luma sub-areas, which is specifically as follows.

Inputs are: a luma position (xCb, yCb), which specifies a position of a top-left luma sample of the co-located luma area corresponding to the current chroma block relative to a top-left luma sample of the current picture; a variable cbWidth, which specifies a width of the current CB in the luma samples; a variable cbHeight, which specifies a height of the current CB in the luma samples; a variable SbWidth, which specifies a width of the luma sub-area; and a variable SbHeight, which specifies a height of the luma sub-area.

Output is: the luma sub-area.

A number numSbX of luma coding sub-blocks in a horizontal direction and a number numSbY of luma coding sub-blocks in a vertical direction are derived as follows:

$$numSbX = cbWidth / SbWidth$$

$$numSbY = cbHeight / SbHeight$$

$$For xSbIdx = 0 … numSbX - 1 and ySbIdx = 0 … numSbY - 1 :$$

$$xCbY = xCb + xSbIdx * SbWidth$$

$$yCbY = yCb + ySbIdx * SbHeight$$

The luma sub-area is a luma area with a position of (xCbY, yCbY) and a size of (SbWidth, SbHeight).

In operation S3, prediction information of each luma sub-area is acquired.

A process of acquiring luma prediction information is as follows.

For xSbIdx=0 . . . numSbX−1 and ySbIdx=0 . . . numSbY−1, the luma prediction information is derived as follows.

For the luma sub-area (xCbY, yCbY):

If CuPredMode[xCbY][yCbY] is equal to MODE_INTRA and is in an IntraTMP mode, the prediction information of the luma sub-area is acquired as follows.
bvL[xSbIdx][ySbIdx][0]=BvL0[xCbY][yCbY][0],
bvL[xSbIdx][ySbIdx][1]=BvL0[xCbY][yCbY][1], here BvL0 is a BV at a corresponding luma sub-area.

If CuPredMode[xCbY][yCbY] is equal to MODE_INTRA and is in a non-IntraTMP mode:

The prediction information of the luma sub-area is obtained by IntraPredModeY[xCbY][yCbY], here the IntraPredModeY is an intra prediction mode of the corresponding luma sub-area.

Otherwise, if CuPredMode[xCbY][yCbY] is equal to MODE_IBC, the prediction information of the luma sub-area is acquired as follows.
bvL[xSbIdx][ySbIdx][0]=BvL0[xCbY][yCbY][0],
bvL[xSbIdx][ySbIdx][1]=BvL0[xCbY][yCbY][1], here BvL0 is the BV at the corresponding luma sub-area.

In operation S4, prediction information of each chroma sub-area is acquired.

Prediction information of a chroma sub-area is derived from the luma sub-area, and the chroma sub-area is derived as follows.

A variable SubWidthC, which specifies a horizontal sampling ratio of the chroma; and a variable SubHeightC, which specifies a vertical sampling ratio of the chroma. A derivation process of the SubWidthC and the SubHeightC is shown in Table 24.

A luma position (xCb, yCb), which specifies a position of a top-left luma sample of the co-located luma area corresponding to the current chroma block relative to a top-left luma sample of the current picture; numSbX, which specifies a number of luma coding sub-blocks in the horizontal direction; numSbY, which specifies a number of luma coding sub-blocks in the vertical direction; a variable SbWidth, which specifies a width of the luma sub-area; a variable SbHeight, which specifies a height of the luma sub-area.

### Chroma Position:

$$For xSbIdx = 0 … numSbX - 1 and ySbIdx = 0 … numSbY - 1 :$$

$$xCbC = xCb / SubWidthC + xSbIdx * ( SbWidth / SubWidthC )$$

$$yCbC = yCb / SubHeightC + ySbIdx * ( SbHeight / SubHeightC )$$

The chroma sub-area is a chroma area with a position of (xCbC, yCbC) and a size of ((SbWidth/SubWidthC), (SbHeight/SubHeightC)).

In another specific embodiment, for determination of prediction information of the chroma sub-area, the process may include the following operations B1 to B8.

In operation B1, whether prediction information of the luma sub-area includes a BV is determined.

If the prediction information of the luma sub-area includes the BV, the process proceeds to the operation S402. If the prediction information of the luma sub-area does not include the BV, for example, it is in an intra prediction mode other than IntraTMP, the process proceeds to the operation S403 or S405.

In operation B2, the BV is adjusted to be applied to chroma.

The BV of the luma sub-area is adjusted to be applied to the chroma sub-area, a specific process thereof is as follows.

BV information of the luma sub-area is acquired as bvL[xSbIdx][ySbIdx]=(BVLₕₒᵣ, BVLᵥₑᵣ), and BV information of the chroma sub-area is set as bvC[xSbIdx][ySbIdx]=(BVCₕₒᵣ, BVCᵥₑᵣ). The adjustment manner includes but is not limited to the following adjustment manners: scaling luma BV parameters according to the above Table 9, to obtain the adjusted chroma BV and then entering the operation B4.

In operation B3, a preset prediction mode is acquired.

Here, the preset prediction mode may be an intra prediction mode, which is applied to chroma as a final prediction mode.

In operation B4, whether the BV is available is determined.

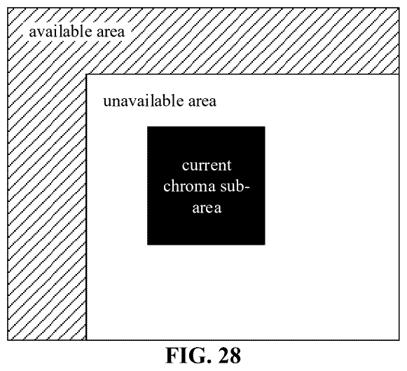

A position (xCbC, yCbC) of the current chroma sub-area is acquired, a chroma bvC[xSbIdx][ySbIdx]=(BVCₕₒᵣ, BVCᵥₑᵣ) is acquired, to find a corresponding offset position (xCbC+BVCₕₒᵣ, yCbC+BVCᵥₑᵣ). Then the following conditions are determined, and if all of them are true, the chroma BV is available:
Whether an obtained offset position does not exceed a Picture boundary;
Whether the obtained offset position does not cover the current chroma sub-area, as shown in FIG. 28;
Whether the obtained offset position does not exceed an available area, as shown in FIG. 11; and
Whether the obtained offset position has been reconstructed.

Here, if the chroma BV is available, the process enters the operation B8; otherwise, the process enters the operation B5.

In operation B5, a basic additional chroma BV is derived.

First step: a corresponding luma block is acquired.

Position of the acquired block may be any position, which includes but is not limited to the following positions.
(1) The center block of the co-located luma area is acquired, as shown in FIG. 3.
(2) The top-left block of the co-located luma area is acquired, as shown in FIG. 7.
(3) The lower-right block of the co-located luma area is acquired, as shown in FIG. 8.
(4) Blocks at five luma pixel positions shown in FIG. 9 (they include but are not limited to the five positions, and may be multiple different positions) are acquired sequentially, until it is determined that an obtained block is coded in a mode with BV information. That is, a first block which is predictively coded in the mode with BV information is found from the luma pixel positions, and orders for sequential acquisition include but are not limited to the following order: C->TL->TR->BL->BR.

Second step: the luma block is coded in a mode with BV information.

Whether the corresponding luma block is coded in the mode with BV information is determined, the mode with BV information includes but is not limited to the IBC mode or the IntraTMP mode.

If the corresponding luma block is coded in the mode with BV information, a BV of the corresponding luma block is acquired. If the corresponding luma block is not coded in the mode with BV information, a preset prediction mode (that is, an intra prediction mode) is acquired.

Third step: the chroma BV is acquired.

After acquiring the BV of the corresponding luma block, the BV is adjusted to be applied to chroma. It is assumed that the luma BV=(BVLₕₒᵣ, BVLᵥₑᵣ), and the chroma BV=(BVCₕₒᵣ, BVCᵥₑᵣ), the adjustment manner includes but is not limited to the following adjustment manners: scaling according to the chroma sampling format shown in Table 9.

Fourth step: whether the BV is available is determined.

First manner: availability of the BV is determined according to information such as a position of the current chroma block.

A position (xCb, yCb) of the current chroma block is acquired, a chroma BVC=(BVCₕₒᵣ, BVCᵥₑᵣ) is acquired, to find a corresponding offset position (xCb+BVCₕₒᵣ, yCb+BVCᵥₑᵣ). Then the following conditions are determined. If all of them are true, the chroma BV is available:
Whether an obtained offset position does not exceed a Picture boundary;
Whether the obtained offset position does not cover the current block, as shown in FIG. 10;
Whether the obtained offset position does not exceed an available area, as shown in FIG. 11; and
Whether the obtained offset position has been reconstructed.

Second manner: availability is determined according to information such as a position of the current chroma sub-area.

A position (xCbC, yCbC) of the current chroma sub-area is acquired, a chroma BVC=(BVCₕₒᵣ, BVCᵥₑᵣ) is acquired, to find a corresponding offset position (xCbC+BVCₕₒᵣ, yCbC+BVCᵥₑᵣ). Then the following conditions are determined. If all of them are true, the chroma BV is available:
Whether an obtained offset position does not exceed a Picture boundary;
Whether the obtained offset position does not cover the current chroma sub-area, as shown in FIG. 28;
Whether the obtained offset position does not exceed an available area, as shown in FIG. 11; and
Whether the obtained offset position has been reconstructed.

If the BV is available, the information is stored. If the BV is not available, the BV is adjusted until it is available, to obtain the chroma BV, and the information is stored. Adjustment manners include but are not limited to clipping, scaling, etc. If the BV is not available, a preset prediction mode which includes but is not limited to a PLANAR mode or a CCLM-type mode or another angular prediction mode may also be acquired, and the information is stored.

In operation B6, whether chroma information is a chroma BV is determined.

If the chroma information is the chroma BV, the process enters the operation B8; otherwise, the process enters the operation B7.

In operation B7, a preset prediction mode is acquired.

The preset prediction mode obtained in the operation B5 which includes but is not limited to a PLANAR mode or a CCLM-type mode or another angular prediction mode, is acquired.

In operation B8, a final chroma BV is acquired.

The chroma BV obtained in the operation B4 or B6 is acquired.

In operation S5, chroma prediction is performed.

First situation: if the acquired prediction information of the chroma sub-area is the chroma BV, the prediction process is as follows.

It includes but is not limited to the following manners.

### Example of First Manner:

A position (xCbC, yCbC) of the current chroma sub-area is acquired, a chroma bvC[xSbIdx][ySbIdx]=(BVCₕₒᵣ, BVCᵥₑᵣ) is acquired, to find a corresponding offset position (xCbC+BVCₕₒᵣ, yCbC+BVCᵥₑᵣ), so as to perform block copy to obtain the predicted value. The copy process is exemplified as follows.

$$For x = 0 … SbWidth / SubWidthC - 1 and y = 0 … SbHeight / SubHeightC - 1 :$$

$$xVb = ( xCuC + x + {BVC}_{hor} ) \& ( BufWidthC - 1 )$$

$$yVb = ( yCuC + y + {BVC}_{ver} ) \& ( CtbSizeC - 1 )$$

$$predSamples [ cIdx ] [ xCuC + x ] [ yCuC + y ] = function ( VirChromaBuf [ xVb ] [ yVb ] )$$

The BufWidthC is a width of chroma pixels in a stored reconstructed buffer. The CtbSizeC is a size of a chroma pixel of the CTU and the VirChromaBuf is stored reconstructed chroma pixels. The variable cIdx specifies an index of a color component of the current block. The function( ) is a processing function for pixel values, which may be direct copy, or a shift operation to ensure calculation accuracy, or a filtering operation, etc.

### Example of Second Manner:

A position (xCuC, yCuC) of the current chroma sub-area is acquired, a chroma bvC[xSbIdx][ySbIdx]=(BVCₕₒᵣ, BVCᵥₑᵣ) is acquired, to find a corresponding offset position (xCuC+BVCₕₒᵣ, yCuC+BVCᵥₑᵣ), so as to perform block copy. Then the copied value is corrected to obtain a final predicted value. The correction operation includes but is not limited to an operation of weighting with values in a CCLM-type mode or other modes.

Second situation: if the acquired prediction information of the chroma sub-area is an intra prediction mode, reference pixels and mode parameters are acquired, to perform chroma prediction of the intra prediction mode.

In another embodiment, the embodiments of the disclosure may also modify the DM mode (that is, fourth solution). In the dual-tree partition, in the DM mode, if a corresponding luma area has BV information, the current chroma block is predicted by using the DBV mode. For example:

If CuPredMode[0][xCb+cbWidth/2][yCb+cbHeight/2] is equal to MODE_IBC, intra_dbv_flag=1 is set, then the chroma intra prediction mode IntraPredModeC[xCb][yCb] uses DBV

If CuPredMode[0][xCb+cbWidth/2][yCb+cbHeight/2] is equal to MODE_INTRA, and if IntraTmpFlag[xCb+cbWidth/2][yCb+cbHeight/2] is equal to 1, intra_dbv_flag=1 is set, in this case, the DBV is used for the chroma intra prediction mode IntraPredModeC[xCb][yCb]. (The flag IntraTmpFlag indicates whether the IntraTmp mode is used.)

Otherwise, DVB is not used for the chroma intra prediction mode IntraPredModeC[xCb][yCb].

The chroma prediction mode is derived as follows.

As shown in the above Table 12, the chroma intra prediction mode IntraPredModeC[xCb][yCb] uses cclm_mode_flag, cclm_mode_idx, intra_chroma_pred_mode, lumaIntraPredMode and lumaTempPredMode specified in the table 12, in which 0 represents a Planar mode, 1 represents DC, 18 represents a horizontal prediction mode, 50 represents a vertical prediction mode, and 81 to 83 represent a CCLM prediction mode. These filling items other than the DBV mode are corresponding values given exemplarily, and it is not that they must be filled with these values.

The operations of performing prediction by using the process of the DBV mode in the embodiments of the disclosure are the same as operations S1, S2, S3, S4 and S5 in the embodiments of the disclosure. Furthermore, in the operation B5, the luma block at the center position of the co-located luma area is acquired, then the BV of the center block of the co-located luma area is acquired directly, and subsequent operations are continued. If the chroma BV in the operation B5 is not available, a luma prediction mode corresponding thereto is acquired.

In another embodiment, for the bitstream, the encoding side plays a role of generating the bitstream, and the decoding side plays a role of parsing the bitstream. For a bitstream organization method:

Here, in the third solution, dbv_flag is transmitted, which corresponds to the above third solution for prediction.

First manner: syntax elements are placed within a syntax structure of MODE_INTRA.

Here, only one bitstream parsing position is listed for explanation:

The syntax elements are added before intra_chroma_pred_mode. The description of specific syntax elements are as shown in Table 13.

Specifically, if sps_ibc_enabled_flag is equal to 0 and sps_intratmp_enabled_flag is equal to 0, DbvEnabled is equal to 0. The DbvEnabled is equal to 1 if all the following multiple conditions are true (they include but are not limited to the following conditions):
sh_slice_type is equal to I.

CtbLog2SizeC is less than or equal to MaxChromaIbcSize.

The MaxChromaIbcSize may be determined according to a size of the chroma CTU or a preset value.

Otherwise, the DbvEnabled is equal to 0.

If the DbvEnabled is equal to 0, dbv_flag is inferred to be FALSE.

The dbv_flag being TRUE indicates that the current chroma prediction mode is the DBV, which includes but is not limited to the following binarization manners. Encoding may be performed by using a context model or a bypass model. Exemplarily, it is shown in Table 14, Table 15 and Table 16.

Second manner: the syntax elements are placed within a syntax structure related to MODE_IBC. The description of specific syntax elements are as shown in Table 17.

Specifically, if sps_ibc_enabled_flag is equal to 0 and sps_intratmp_enabled_flag is equal to 0, DbvEnabled is equal to 0. The DbvEnabled is equal to 1 if all the following multiple conditions are true (they include but are not limited to the following conditions):

sh_slice_type is equal to I.

CtbLog2SizeC is less than or equal to MaxChromaIbcSize.

The MaxChromaIbcSize may be determined according to a size of the chroma CTU or a preset value.

Otherwise, the DbvEnabled is equal to 0.

When treeType==DUAL_TREE_CHROMA, the DbvEnabled is equal to 0, then pred_mode_ibc_flag is inferred to be FALSE.

When treeType==DUAL_TREE_CHROMA, pred_mode_ibc_flag being TRUE, indicates that the current chroma prediction mode is the DBV mode. Exemplarily, it is shown in Table 18 and Table 19.

Fourth solution: a relevant flag is not transmitted, instead, it is considered that a DM prediction mode corresponds to the above fourth solution for prediction. Specific syntax elements are described in Table 20. Furthermore, it includes but is not limited to the following binarization manners. Encoding may be performed by using a context model or a bypass model. Exemplarily, it is shown in Table 21 and Table 22.

Specifically, a 0th bin of the intra_chroma_pred_mode represents the DM mode, and encoding manner is the same as VVC. A derivation process of the DbvEnabled is as follows.

If sps_ibc_enabled_flag is equal to 0 and sps_intratmp_enabled_flag is equal to 0, the DbvEnabled is equal to 0.

Otherwise, the DbvEnabled is equal to 1 if all the following multiple conditions are true (they include but are not limited to the following conditions):

sh_slice_type is equal to I.

CtbLog2SizeC is less than or equal to MaxChromaIbcSize.

The MaxChromaIbcSize may be determined according to a size of the chroma CTU or a preset value.

If the DbvEnabled is equal to 1:

When intra_chroma_pred_mode is equal to four chroma prediction modes of 0, 1, 2 or 3, the four chroma prediction modes are kept unchanged. When intra_chroma_pred_mode is equal to 4, the second solution is implemented.

Otherwise, the chroma prediction process in the H.266 standard is kept unchanged.

Further, in some embodiments, the embodiments of the disclosure also propose a technical solution. Specifically, a corresponding luma block is acquired, and whether the corresponding luma block is coded in a mode with BV information is determined, and then the following processing manners may be used.

If the corresponding luma block is not coded in the mode with BV information, syntax elements of the DBV mode are not transmitted in a bitstream.

If the corresponding luma block is coded in the mode with BV information, a BV of the corresponding luma block is acquired, the BV is adjusted to be applied to chroma, and whether the adjusted BV is available is determined. If the adjusted BV is available, operations S1, S2, S3, S4 and S5 in the embodiments of the disclosure are performed. If the adjusted BV is not available, the BV is adjusted until it is available, and then operations S1, S2, S3, S4 and S5 in the embodiments of the disclosure are performed, or chroma prediction is performed by using a PLANAR mode or other chroma prediction modes.

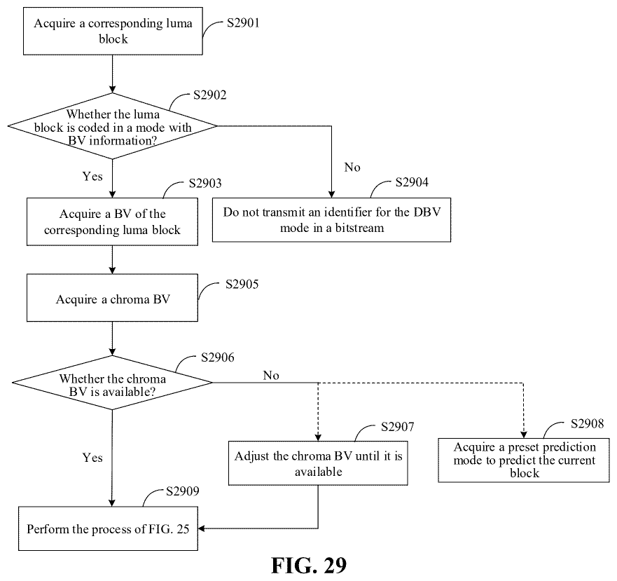

With reference to FIG. 29, a detailed schematic flowchart of yet another encoding/decoding method according to embodiments of the disclosure is shown. As shown in FIG. 29, the detailed flow may include the following operations S2901 to S2709.

In operation S2901, a corresponding luma block is acquired.

In operation S2902, whether the corresponding luma block is coded in a mode with BV information is determined.

In operation S2904, if no in the operation S2902, syntax elements of the DBV mode are not transmitted in a bitstream.

In operation 52903, if yes in the operation S2902, a BV of the corresponding luma block is acquired.

In operation 52905, a chroma BV is acquired.

In operation 52906, whether the chroma BV is available is determined.

In operation 52907, if no in the operation 52906, the chroma BV is adjusted until it is available.

In operation 52908, if no in the operation 52906, a preset prediction mode is acquired to predict the current block.

In operation 52909, the process of FIG. 25 is performed.

In a specific embodiment, according to FIG. 29, for the bitstream, the encoding side plays a role of generating the bitstream, and the decoding side plays a role of parsing the bitstream. For a bitstream organization method:

First manner: corresponding syntax elements are placed within a syntax structure of MODE_INTRA.

Here, only one bitstream parsing position is listed for explanation:

The corresponding syntax elements are added before intra_chroma_pred_mode. Specific syntax elements are described in Table 13.

Specifically, if sps_ibc_enabled_flag is equal to 0 and sps_intratmp_enabled_flag is equal to 0, DbvEnabled is equal to 0. Otherwise, a variable ModeIncludeBv is set. If the corresponding luma block is not coded in the mode with BV information, the ModeIncludeBv is equal to 0; otherwise, the ModeIncludeBv is equal to 1.

The DbvEnabled is equal to 1 if all the following multiple conditions are true (they include but are not limited to the following conditions):

ModeIncludeBv is equal to 1.

sh_slice_type is equal to I.

CtbLog2SizeC is less than or equal to MaxChromaIbcSize.

The MaxChromaIbcSize may be determined according to a size of the chroma CTU or a preset value.

Otherwise, the DbvEnabled is equal to 0.

If the DbvEnabled is equal to 0, dbv_flag is inferred to be FALSE.

The dbv_flag being TRUE indicates that the current chroma prediction mode is the DBV, which includes but is not limited to the following binarization manners. Encoding may be performed by using a context model or a bypass model. Exemplarily, it is shown in Table 14, Table 15 and Table 16.

Second manner: corresponding syntax elements are placed within a syntax structure related to MODE_IBC. Specific syntax elements are described in Table 17.

Specifically, if sps_ibc_enabled_flag is equal to 0 and sps_intratmp_enabled_flag is equal to 0, DbvEnabled is equal to 0. Otherwise, a variable ModeIncludeBv is set. If the corresponding luma block is not coded in the mode with BV information, the ModeIncludeBv is equal to 0; otherwise, the ModeIncludeBv is equal to 1.

The DbvEnabled is equal to 1 if all the following multiple conditions are true (they include but are not limited to the following conditions):

ModeIncludeBv is equal to 1.

sh_slice_type is equal to I.

CtbLog2SizeC is less than or equal to MaxChromaIbcSize.

The MaxChromaIbcSize may be determined according to a size of the chroma CTU or a preset value.

Otherwise, the DbvEnabled is equal to 0.

When treeType==DUAL_TREE_CHROMA, the DbvEnabled is equal to 0, then pred_mode_ibc_flag is inferred to be FALSE.

When treeType==DUAL_TREE_CHROMA, pred_mode_ibc_flag being TRUE indicates that the current chroma prediction mode is the DBV mode. Exemplarily, it is shown in Table 18 and Table 19.

Further, in some embodiments, a determination condition of the DM manner may be that there is BV information at any position in the entire corresponding luma area, which is described as follows.

In the DM mode, if the prediction information of the corresponding luma area includes the BV information, the current chroma block is coded in the DBV mode. For example:

If for x=xCb . . . xCb+cbWidth−1, y=yCb . . . yCb+cbHeight−1, there is any pair of (x, y) making CuPredMode[0][x][y] equal to MODE_IBC, then Intra_DBV_flag is set to 1. In this case, the chroma intra prediction mode IntraPredModeC[xCb][yCb] uses the DBV mode.

If for x=xCb . . . xCb+cbWidth−1, y=yCb . . . yCb+cbHeight−1, there is any pair of (x, y) making CuPredMode[0][x][y] equal to MODE_INTRA, and IntraTmpFlag[x][y] is equal to 1, then Intra_DBV_flag is set to 1. In this case, the chroma intra prediction mode IntraPredModeC[xCb][yCb] uses the DBV (The flag IntraTmpFlag indicates whether the IntraTmp mode is used.)

Further, in some embodiments, a corresponding residual of the chroma block where prediction is performed in the DBV mode is transformed and inversely transformed in a manner which includes but is not limited to the following manners: only one transformation may be performed (for example, only the DCT transformation is performed without performing the LFNST transformation), or two transformations may be performed (a primary transformation and a secondary transformation, for example, the coding side performs the DCT transformation and then performs the LFNST transformation). Forward transformation manners implemented by the decoding side and the coding side are kept consistent in a reverse order.

Further, in some embodiments, luma blocks at five luma pixel positions shown in FIG. 9 (they include but are not limited to the five positions, and may be multiple different positions) are sequentially acquired in an order which includes but is not limited to the following order: C->TL->TR->BL->BR.

At first, whether the acquired corresponding luma blocks at the five positions are coded in a mode with BV information is determined. If the acquired corresponding luma blocks are not coded in the mode with BV information, an intra prediction mode for a luma block corresponding to a C position (or another position) is acquired. If one or more of corresponding luma blocks at the five positions are coded in the mode with BV information, the five positions may be re-acquired sequentially, until a first luma block meeting the following conditions is found: whether the luma block is coded in the mode with BV information is determined, the third step of the operation S405 of the main technical solution is performed to acquire the chroma BV, and the fourth step of the operation S405 of the main technical solution is performed to determine whether the BV is available.

If the BV is available, this chroma BV is selected as basic additional chroma information finally acquired for the sub-block.

If the BV is not available, the BV is adjusted until it is available, and then is used as the basic additional chroma information finally acquired for the sub-block. Or a preset mode is acquired as the basic additional chroma information finally acquired for the sub-block, the preset mode includes but is not limited to a PLANAR mode or a CCLM-type mode or another angular prediction mode.

Simply speaking, in the embodiments of the disclosure, a new chroma prediction manner is proposed here, which may be used to effectively and accurately predict the chroma block. This solution fully considers available information such as reconstructed luma, BV or the like, and predicts chroma according to these information, which improves singleness of chroma prediction. Further this solution considers the symmetric relationship and processes the predicted value in more detail. Existing technologies and information of the co-located luma area are fully used, improving coding efficiency effectively. Furthermore, the current coding chroma block is divided into sub-areas, to adaptively provide multiple possibilities according to different contents and luma prediction information, such that DBV prediction is more effective, thereby further improving the coding efficiency.

Specific implementations of the above embodiments are described in detail through this embodiment, from which it may be seen that the chroma block may be predicted effectively and accurately. This solution may perform prediction by dividing the current coding chroma block into sub-areas, to adaptively provide multiple options according to different contents and luma prediction information. Further, this solution fully uses advantages of existing technologies, such that DBV prediction is more effective, thereby further improving the coding efficiency.

In yet another implementation of the disclosure, the embodiments of the disclosure further provide a bitstream. The bitstream is generated by coding bits according to to-be-coded information. The to-be-coded information includes at least one of: a residual value of a second color component of a current block, a residual value of a second color component sub-block, a target BV parameter of the current block, a target symmetric relationship, or a value of identification information of a first syntax element.

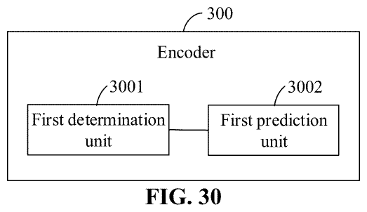

In yet another implementation of the disclosure, based on the same inventive concept as the above embodiments, with reference to FIG. 30, a schematic structural diagram of an encoder according to embodiments of the disclosure is shown. As shown in FIG. 30, the encoder 300 may include, a first determination unit 3001 and a first prediction unit 3002.

In a specific embodiment, the first determination unit 3001 is configured to: determine a first color component block for a current block; and when a prediction mode for the first color component block meets a first condition, determine a target BV parameter of the current block, and determine a target symmetric relationship according to the target BV parameter of the current block.

The first prediction unit 3002 is configured to predict, according to the target BV parameter, a second color component of the current block, to determine a predicted value of the second color component of the current block.

The first determination unit 3001 is further configured to determine a residual value of the second color component of the current block according to the predicted value of the second color component of the current block and the target symmetric relationship.

In some embodiments, the prediction mode for the first color component block meeting the first condition includes that: it is determined that the prediction mode for the first color component block is a first prediction mode with BV information.

In some embodiments, the first prediction mode includes at least one of an IBC mode or an IntraTMP mode.

In some embodiments, the first determination unit 3001 is further configured to: when the prediction mode for the first color component block does not meet the first condition, not code a target prediction mode for the current block.

In some embodiments, the prediction mode for the first color component block not meeting the first condition includes that: it is determined that the prediction mode for the first color component block is a second prediction mode without BV information.

In some embodiments, the second prediction mode does not include an IBC mode and an IntraTMP mode.

In some embodiments, the first determination unit 3001 is further configured to: determine a first co-located area corresponding to the current block; and determine, from multiple blocks divided from the first co-located area, the first color component block for the current block.

In some embodiments, the first determination unit 3001 is further configured to: select a target block from multiple blocks divided from the first co-located area, and take the target block as the first color component block for the current block.

In some embodiments, the first determination unit 3001 is further configured to: determine position information of the current block; scale, according to a preset sampling format, the position information of the current block, to obtain position information of a co-located area corresponding to the current block; and determine target position information according to the position information of the co-located area, and take a target block including the target position information as the first color component block for the current block.

In some embodiments, the first determination unit 3001 is further configured to: calculate a center position according to the position information of the co-located area, and take information of an obtained center position as the target position information; or calculate a top-left position according to the position information of the co-located area, and take information of an obtained top-left position as the target position information; or calculate a lower-right position according to the position information of the co-located area, and take information of an obtained lower-right position as the target position information.

In some embodiments, the first determination unit 3001 is further configured to: determine, from these multiple blocks divided from the first co-located area, at least one candidate block at a preset position; and determine, from the at least one candidate block, a target candidate block meeting a preset determination condition, and take the target candidate block as the first color component block for the current block.

In some embodiments, the first determination unit 3001 is further configured to: determine a first BV parameter of the first color component block; and adjust the first BV parameter of the first color component block, to determine the target BV parameter of the current block.

In some embodiments, the first determination unit 3001 is further configured to: scale, according to a preset sampling format, the first BV parameter of the first color component block, to determine the target BV parameter of the current block.

In some embodiments, the first determination unit 3001 is further configured to: scale, according to a preset sampling format, the first BV parameter of the first color component block, to obtain an initial BV parameter of the current block; and correct the initial BV parameter of the current block, to determine the target BV parameter of the current block.

In some embodiments, the first determination unit 3001 is further configured to: after determining the target BV parameter of the current block, determine whether the target BV parameter meets an availability condition; and when the target BV parameter meets the availability condition, perform the operation of determining the target symmetric relationship of the current block according to the target BV parameter of the current block.

In some embodiments, whether the target BV parameter meets the availability condition is determined according to at least the following:
an offset position indicated according to position information of the current block and the target BV parameter does not exceed an picture boundary;
the offset position indicated according to the position information of the current block and the target BV parameter does not cover the current block;
the offset position indicated according to the position information of the current block and the target BV parameter does not exceed a preset available area; and
the offset position indicated according to the position information of the current block and the target BV parameter has been reconstructed.

In some embodiments, the first determination unit 3001 is further configured to: determine a first co-located area corresponding to the current block; determine a reference block according to the target BV parameter, and determine a second co-located area corresponding to the reference block; perform, according to the first co-located area and the second co-located area, error calculation for at least one symmetric relationship, to obtain at least one error value for the at least one symmetric relationship; and determine the target symmetric relationship from the at least one symmetric relationship according to the at least one error value for the at least one symmetric relationship.

In some embodiments, the first determination unit 3001 is further configured to: perform transformation about a first symmetric relationship on the second co-located area, to determine a transformed second co-located area; and calculate, according to a preset error criterion, a symmetric error between the transformed second co-located area and the first co-located area, to determine an error value for the first symmetric relationship.

The first symmetrical relationship is any one of the at least one symmetrical relationship.

In some embodiments, the first determination unit 3001 is further configured to: determine a first adjacent area corresponding to the current block; determine a reference block according to the target BV parameter, and determine a second adjacent area corresponding to the reference block; perform, according to the first adjacent area and the second adjacent area, error calculation for at least one symmetric relationship, to obtain at least one error value for the at least one symmetric relationship; and determine the target symmetric relationship from the at least one symmetric relationship according to the at least one error value for the at least one symmetric relationship.

In some embodiments, the first determination unit 3001 is further configured to: perform transformation about a first symmetric relationship on the second adjacent area, to determine a transformed second adjacent area; and calculate, according to a preset error criterion, a symmetric error between the transformed second adjacent area and the first adjacent area, to determine an error value for the first symmetric relationship.

The first symmetrical relationship is any one of the at least one symmetrical relationship.

In some embodiments, the at least one symmetric relationship includes at least one of no symmetric relationship, a vertical symmetric relationship, or a horizontal symmetric relationship.

In some embodiments, the first determination unit 3001 is further configured to select a minimum error value from the at least one error value for the at least one symmetric relationship, and take a symmetric relationship corresponding to the minimum error value as the target symmetric relationship.

In some embodiments, the first determination unit 3001 is further configured to store the target symmetric relationship in a preset buffer.

In some embodiments, the preset error criterion includes at least one of a SAD, a SATD, a SSE, a MAD, a MAE, a MSE, or a RDO.

In some embodiments, the first determination unit 3001 is further configured to acquire a target symmetric relationship of the first color component block from a preset buffer, to determine the target symmetric relationship. The target symmetric relationship is used to indicate a symmetric relationship between a first co-located area where the first color component block is located and a second co-located area indicated by the target BV parameter.

In some embodiments, the first prediction unit 3002 is further configured to: determine an offset position of the current block according to the target BV parameter and position information of the current block; perform block copy according to the offset position of the current block, to obtain a first prediction block; and determine the predicted value of the second color component of the current block according to the first prediction block.

In some embodiments, the first prediction unit 3002 is further configured to perform a correction operation on the first prediction block, to determine the predicted value of the second color component of the current block.

In some embodiments, the first determination unit 3001 is further configured to: determine an original value of the second color component of the current block; transform, according to the target symmetric relationship, the original value of the second color component of the current block, to determine an initial value of the second color component of the current block; and determine the residual value of the second color component of the current block according to the initial value of the second color component of the current block and the predicted value of the second color component of the current block.

In some embodiments, the first determination unit 3001 is further configured to code the residual value of the second color component of the current block, and write obtained coded bits into a bitstream.

In some embodiments, the first determination unit 3001 is further configured to: determine a target prediction mode for the current block; and when the target prediction mode indicates that the second color component of the current block is allowed to use a DBV mode, code a target prediction mode for the current block, and write obtained coded bits into a bitstream.

In some embodiments, the first determination unit 3001 is further configured to: determine a value of identification information of a first syntax element; and code the value of identification information of the first syntax element, and write obtained coded bits into the bitstream.

In some embodiments, the first determination unit 3001 is further configured to: if the target prediction mode for the current block is the DBV mode, determine that the value of identification information of the first syntax element is a first value; if the target prediction mode for the current block is another prediction mode other than the DBV mode, determine that the value of identification information of the first syntax element is a second value.

In some embodiments, the first determination unit 3001 is further configured to: determine a first co-located area corresponding to the current block; and if any position in the first co-located area has BV information, determine that the second color component of the current block is allowed to use the DBV mode.

In some embodiments, the first determination unit 3001 is further configured to code the target BV parameter of the current block, and write obtained coded bits into a bitstream.

In some embodiments, the first determination unit 3001 is further configured to code the target symmetric relationship, and write obtained coded bits into a bitstream.

In some embodiments, the first determination unit 3001 is further configured to: perform sub-block division on the current block, to obtain at least one sub-block; and take the sub-block as the current block and perform operations of the encoding method shown in FIG. 18, to determine the residual value of the second color component of the sub-block.

In another specific embodiment, the first determination unit 3001 is configured to: determine a first co-located area corresponding to a current block; divide the first co-located area, to obtain at least one first color component sub-block; and determine at least one second color component sub-block and prediction information of the at least one second color component sub-block according to the at least one first color component sub-block.

The first prediction unit 3002 is configured to determine a predicted value of a second color component of the current block according to the prediction information of the at least one second color component sub-block.

In some embodiments, the first determination unit 3001 is further configured to: determine position information of the current block and size information of the current block; scale, according to a preset sampling format, the position information of the current block, to obtain position information of a co-located area corresponding to the current block; scale, according to the preset sampling format, the size information of the current block, to obtain size information of the co-located area corresponding to the current block; and determine the first co-located area corresponding to the current block according to the position information of the co-located area and the size information of the co-located area corresponding to the current block.

In some embodiments, the first determination unit 3001 is further configured to: determine a horizontal sampling factor and a vertical sampling factor according to a preset sampling format; and adjust position information of the first color component sub-block according to the horizontal sampling factor and the vertical sampling factor, to determine the second color component sub-block.

In some embodiments, the first determination unit 3001 is further configured to: adjust a horizontal coordinate of the first color component sub-block according to the horizontal sampling factor, to obtain a horizontal coordinate of the second color component sub-block; adjust a vertical coordinate of the first color component sub-block according to the vertical sampling factor, to obtain a vertical coordinate of the second color component sub-block; and determine the second color component sub-block according to the horizontal coordinate of the second color component sub-block and the vertical coordinate of the second color component sub-block.

In some embodiments, the first determination unit 3001 is further configured to: determine prediction information of the at least one first color component sub-block; and determine the prediction information of the at least one second color component sub-block according to the prediction information of the at least one first color component sub-block.

In some embodiments, the first determination unit 3001 is further configured to: when the prediction information of the first color component sub-block includes BV information, determine a first BV parameter of the first color component sub-block; adjust the first BV parameter of the first color component sub-block, to determine a second BV parameter of the second color component sub-block; and determine the prediction information of the second color component sub-block according to the second BV parameter of the second color component sub-block.

In some embodiments, the first determination unit 3001 is further configured to: when the prediction information of the first color component sub-block does not include the BV information, acquire a preset prediction mode, and determine the preset prediction mode as the prediction information of the second color component sub-block; or, when the prediction information of the first color component sub-block does not include the BV information, determine additional information of the second color component sub-block, and determine the prediction information of the second color component sub-block according to the additional information.

In some embodiments, the first determination unit 3001 is further configured to scale, according to a preset sampling format, the first BV parameter of the first color component sub-block, to determine the second BV parameter of the second color component sub-block.

In some embodiments, the first determination unit 3001 is further configured to: scale, according to a preset sampling format, the first BV parameter of the first color component sub-block, to obtain an initial BV parameter of the second color component sub-block; and correct the initial BV parameter of the second color component sub-block, to determine the second BV parameter of the second color component sub-block.

In some embodiments, the first determination unit 3001 is further configured to: after determining the second BV parameter of the second color component sub-block, determine whether the second BV parameter meets an availability condition; and when the second BV parameter meets the availability condition, determine the second BV parameter as the prediction information of the second color component sub-block.

In some embodiments, whether the second BV parameter meets the availability condition is determined according to at least the following:
an offset position indicated according to position information of the current block and the second BV parameter does not exceed an picture boundary;
the offset position indicated according to the position information of the current block and the second BV parameter does not cover the current block;
the offset position indicated according to the position information of the current block and the second BV parameter does not exceed a preset available area; and
the offset position indicated according to the position information of the current block and the second BV parameter has been reconstructed.

In some embodiments, whether the second BV parameter meets the availability condition is determined according to at least the following:
an offset position indicated according to position information of the second color component sub-block and the second BV parameter does not exceed an picture boundary;
the offset position indicated according to the position information of the second color component sub-block and the second BV parameter does not cover the current block;
the offset position indicated according to the position information of the second color component sub-block and the second BV parameter does not exceed a preset available area; and
the offset position indicated according to the position information of the second color component sub-block and the second BV parameter has been reconstructed.

In some embodiments, the first determination unit 3001 is further configured to: when the second BV parameter does not meet the availability condition, determine additional information of the second color component sub-block; and determine the prediction information of the second color component sub-block according to the additional information.

In some embodiments, the first determination unit 3001 is further configured to: after determining the additional information of the second color component sub-block, determine whether the additional information is a BV parameter; and if the additional information is the BV parameter, determine the BV parameter as the prediction information of the second color component sub-block.

In some embodiments, the first determination unit 3001 is further configured to: if the additional information is a non-BV parameter, acquire a preset prediction mode, and determine the preset prediction mode as the prediction information of the second color component sub-block.

In some embodiments, the first determination unit 3001 is further configured to: determine a first color component block for the current block; when a prediction mode for the first color component block meets a first condition, determine a first BV parameter of the first color component block; adjust the first BV parameter of the first color component block, to determine the second BV parameter of the second color component sub-block; and determine the additional information of the second color component sub-block according to the second BV parameter.

In some embodiments, the first determination unit 3001 is further configured to: after determining the second BV parameter of the second color component sub-block, determine whether the second BV parameter meets the availability condition; and when the second BV parameter meets the availability condition, determine the second BV parameter as the additional information of the second color component sub-block.

In some embodiments, the first determination unit 3001 is further configured to store the additional information of the second color component sub-block.

In some embodiments, the first determination unit 3001 is further configured to: when the prediction mode for the first color component block does not meet the first condition, not code a target prediction mode for the current block.

In some embodiments, the first prediction unit 3002 is further configured to: predict, according to the prediction information of the at least one second color component sub-block, the at least one second color component sub-block respectively, to determine a predicted value of the at least one second color component sub-block; and determine the predicted value of the second color component of the current block according to the predicted value of the at least one second color component sub-block.

In some embodiments, the first prediction unit 3002 is further configured to: determine a second BV parameter of the second color component sub-block according to the prediction information of the second color component sub-block; determine an offset position of the second color component sub-block according to the second BV parameter and position information of the second color component sub-block; perform block copy according to the offset position of the second color component sub-block, to obtain a first prediction sub-block; and determine the predicted value of the second color component sub-block according to the first prediction sub-block.

In some embodiments, the first prediction unit 3002 is further configured to perform a correction operation on the first prediction sub-block, to determine the predicted value of the second color component sub-block.

In some embodiments, the first determination unit 3001 is further configured to: determine an original value of the second color component sub-block; and determine a residual value of the second color component sub-block according to the original value of the second color component sub-block and a predicted value of the second color component sub-block.

In some embodiments, the first determination unit 3001 is further configured to: determine a target symmetric relationship; transform, according to the target symmetric relationship, the original value of the second color component sub-block, to determine an initial value of the second color component sub-block; and determine the residual value of the second color component sub-block according to the initial value of the second color component sub-block and the predicted value of the second color component sub-block.

In some embodiments, the first determination unit 3001 is further configured to: determine a target symmetric relationship; transform, according to the target symmetric relationship, the predicted value of the second color component sub-block, to determine a transformed predicted value of the second color component sub-block; and determine the residual value of the second color component sub-block according to the original value of the second color component sub-block and the transformed predicted value of the second color component sub-block.

In some embodiments, the first determination unit 3001 is further configured to code the residual value of the second color component sub-block, and write obtained coded bits into a bitstream.

It may be understood that in the embodiments of the disclosure, the “unit” may be a part of a circuit, a part of a processor, a part of a program or software, etc. Of course, the “unit” may be a module, or may be non-modular. Furthermore, various components in the embodiments may be integrated into a processing unit, or each unit may physically exist separately, or two or more than two units may be integrated into a unit. The above integrated unit may be implemented in form of hardware, or may be implemented in form of a software functional module.

If the integrated unit is implemented in form of the software functional module and not sold or used as an independent product, it may be stored in a computer-readable storage medium. Based on such an understanding, the technical solutions of the embodiments substantially or parts making contributions to the related art or all or part of the technical solutions may be embodied in form of a software product. The computer software product is stored in a storage medium, including several instructions to enable a computer device (which may be a personal computer, a server, or a network device, or the like) or a processor to perform all or part of operations of the methods described in the embodiments. The above storage medium includes various media capable of storing program codes such as a U disk, a mobile hard disk, a Read-Only Memory (ROM), a Random Access Memory (RAM), a magnetic disk, or an optical disk, etc.

Therefore, embodiments of the disclosure provide a computer-readable storage medium, the computer-readable storage medium is applied to the encoder 300, and stores a computer program. When the computer program is executed by a first processor, the computer program implements the method described in any one of the above embodiments.

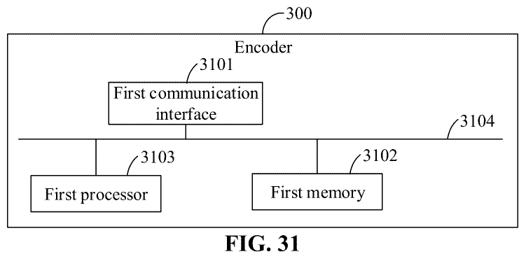

Based on composition of the encoder 300 and the computer-readable storage medium, with reference to FIG. 31, a schematic diagram of specific hardware structures of the encoder 300 according to embodiments of the disclosure is shown. As shown in FIG. 31, the encoder 300 may include a first communication interface 3101, a first memory 3102, and a first processor 3103. Various components are coupled together through a first bus system 3104. It may be understood that the first bus system 3104 is configured to implement connection and communication between these components. The first bus system 3104 includes a power bus, a control bus and a status signal bus. However, for the sake of clear explanation, various buses are marked as the first bus system 3104 in FIG. 31.

The first communication interface 3101 is configured to receive and send signals in a process of receiving or sending information from or to other external network elements.

The first memory 3102 is configured to store a computer program executable on the first processor 3103.

The first processor 3103 is configured to execute the computer program to perform operations of:
determining a first color component block for a current block;
when a prediction mode for the first color component block meets a first condition, determining a target BV parameter of the current block, and determining a target symmetric relationship according to the target BV parameter of the current block;
predicting, according to the target BV parameter, a second color component of the current block, to determine a predicted value of the second color component of the current block; and
determining a residual value of the second color component of the current block according to the predicted value of the second color component of the current block and the target symmetric relationship.

Or, the first processor 3103 is configured to execute the computer program to perform operations of:
determining a first co-located area corresponding to a current block;
dividing the first co-located area, to obtain at least one first color component sub-block;
determining at least one second color component sub-block and prediction information of the at least one second color component sub-block according to the at least one first color component sub-block; and
determining a predicted value of a second color component of the current block according to the prediction information of the at least one second color component sub-block.

It may be understood that the first memory 3102 in the embodiments of the disclosure may be a volatile memory or a non-volatile memory, or may include both the volatile memory and the non-volatile memory. The non-volatile memory may be a ROM, a Programmable ROM (PROM), an Erasable PROM (EPROM), an Electrically EPROM (EEPROM) or a flash memory. The volatile memory may be a RAM which is used as an external high-speed cache. In exemplary but non-limiting descriptions, many forms of RAMs are available, such as a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM) and a Direct Rambus RAM (DR RAM). The first memory 3102 for the system and method described in the disclosure is intended to include but is not limited to these and any other suitable types of memories.

Furthermore, the first processor 3103 may be an integrated circuit chip with a signal processing capability. During implementation, each operation in the above methods may be completed by an integrated logical circuit in form of hardware in the first processor 3103 or an instruction in form of software. The first processor 3103 may be a general purpose processor, a Digital Signal Processor (DSP), an Application Specific Integrated Circuit (ASIC), a Field Programmable Gate Array (FPGA) or other programmable logical devices, a discrete gate or a transistor logical device, a discrete hardware component. Each method, operation and logical block diagram disclosed in the embodiments of the disclosure may be implemented or executed. The general purpose processor may be a microprocessor, or the processor may also be any conventional processor, etc. Operations of the methods disclosed in combination with the embodiments of the disclosure may be directly embodied to be executed and completed by a hardware decoding processor, or executed and completed by a combination of hardware in the decoding processor and software modules. The software module may be located in a mature storage medium in this field such as a random memory a flash memory, a ROM, a PROM, or an EEPROM, a register, etc. The storage medium is located in the first memory 3102, and the first processor 3103 reads information in the first memory 3102, and completes the operations of the above methods in combination with the hardware thereof.

It may be understood that these embodiments described in the disclosure may be implemented in hardware, software, firmware, middleware, microcode or a combination thereof. For implementation in hardware, the processing unit may be implemented in one or more ASICs, DSPs, DSP Devices (DSPDs), Programmable Logic Devices (PLDs), FPGAs, general purpose processors, controllers, microcontrollers, microprocessors, other electronic units configured to perform functions described in the disclosure, or a combination thereof. For implementation in software, the technologies described in the disclosure may be implemented by the modules (such as processes, functions, etc.) performing the functions described in the disclosure. The software codes may be stored in a memory and executed by a processor. The memory may be implemented in or out of the processor.

Optionally, as another embodiment, the first processor 3103 is further configured to execute the computer program to perform the method described in any one of the above embodiments.

The embodiments provide an encoder, in which available information such as reconstructed luma, BV or the like are fully considered, and chroma is predicted according to these information, which improves singleness of chroma prediction. Further, the symmetric relationship is considered and the predicted value is processed in more detail. This not only improves accuracy of the chroma prediction and saves the bit rate, but also improves coding and decoding performance and improves coding efficiency effectively. Furthermore, by dividing the current block into sub-areas of the current block for prediction, multiple options can be adaptively provided according to different contents and luma prediction information, such that DBV prediction is more effective, thereby further improving the coding efficiency.

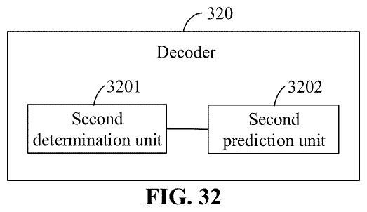

In yet another implementation of the disclosure, based on the same inventive concept as the above embodiments, with reference to FIG. 32, a schematic structural diagram of a decoder according to embodiments of the disclosure is shown. As shown in FIG. 32, the encoder 320 may include a second determination unit 3201 and a second prediction unit 3202.

In a specific embodiment, the second determination unit 3201 is configured to: determine a first color component block for a current block; when a prediction mode for the first color component block meets a first condition, determine a target BV parameter of the current block, and determine a target symmetric relationship according to the target BV parameter of the current block.

The second prediction unit 3202 is configured to predict, according to the target BV parameter, a second color component of the current block, to determine a predicted value of the second color component of the current block.

The second determination unit 3201 is further configured to determine a reconstructed value of the second color component of the current block according to the predicted value of the second color component of the current block and the target symmetric relationship.

In some embodiments, the prediction mode for the first color component block meeting the first condition includes that: it is determined that the prediction mode for the first color component block is a first prediction mode with BV information.

In some embodiments, the first prediction mode includes at least one of an IBC mode or an IntraTMP mode.

In some embodiments, the second determination unit 3201 is further configured to: when the prediction mode for the first color component block does not meet the first condition, not perform an operation of decoding a bitstream to determine a target prediction mode for the current block.

In some embodiments, the prediction mode for the first color component block not meeting the first condition includes that: it is determined that the prediction mode for the first color component block is a second prediction mode without BV information.

In some embodiments, the second prediction mode does not include an IBC mode and an IntraTMP mode.

In some embodiments, the second determination unit 3201 is further configured to: determine a first co-located area corresponding to the current block; and determine, from multiple blocks divided from the first co-located area, the first color component block for the current block.

In some embodiments, the second determination unit 3201 is further configured to select a target block from these multiple blocks divided from the first co-located area, and take the target block as the first color component block for the current block.

In some embodiments, the second determination unit 3201 is further configured to: determine position information of the current block; scale, according to a preset sampling format, the position information of the current block, to obtain position information of a co-located area corresponding to the current block; and determine target position information according to the position information of the co-located area, and take a target block including the target position information as the first color component block for the current block.

In some embodiments, the second determination unit 3201 is further configured to: calculate a center position according to the position information of the co-located area, and take information of an obtained center position as the target position information; or calculate a top-left position according to the position information of the co-located area, and take information of an obtained top-left position as the target position information; or calculate a lower-right position according to the position information of the co-located area, and take information of an obtained lower-left position as the target position information.

In some embodiments, the second determination unit 3201 is further configured to: determine, from these multiple blocks divided from the first co-located area, at least one candidate block at a preset position; and determine, from the at least one candidate block, a target candidate block meeting a preset determination condition, and take the target candidate block as the first color component block for the current block.

In some embodiments, the second determination unit 3201 is further configured to: determine a first BV parameter of the first color component block; and adjust the first BV parameter of the first color component block, to determine the target BV parameter of the current block.

In some embodiments, the second determination unit 3201 is further configured to scale, according to a preset sampling format, the first BV parameter of the first color component block, to determine the target BV parameter of the current block.

In some embodiments, the second determination unit 3201 is further configured to: scale, according to a preset sampling format, the first BV parameter of the first color component block, to obtain an initial BV parameter of the current block; and correct the initial BV parameter of the current block, to determine the target BV parameter of the current block.

In some embodiments, the second determination unit 3201 is further configured to: after determining the target BV parameter of the current block, determine whether the target BV parameter meets an availability condition; and when the target BV parameter meets the availability condition, perform the operation of determining the target symmetric relationship of the current block according to the target BV parameter of the current block.

In some embodiments, whether the target BV parameter meets the availability condition is determined according to at least the following:
an offset position indicated according to position information of the current block and the target BV parameter does not exceed an picture boundary;
the offset position indicated according to the position information of the current block and the target BV parameter does not cover the current block;
the offset position indicated according to the position information of the current block and the target BV parameter does not exceed a preset available area; and
the offset position indicated according to the position information of the current block and the target BV parameter has been reconstructed.

In some embodiments, the second determination unit 3201 is further configured to: determine a first co-located area corresponding to the current block; determine a reference block according to the target BV parameter, and determine a second co-located area corresponding to the reference block; perform, according to the first co-located area and the second co-located area, error calculation for at least one symmetric relationship, to obtain at least one error value for the at least one symmetric relationship; and determine the target symmetric relationship from the at least one symmetric relationship according to the at least one error value for the at least one symmetric relationship.

In some embodiments, the second determination unit 3201 is further configured to: perform transformation about a first symmetric relationship on the second co-located area, to determine a transformed second co-located area; and calculate, according to a preset error criterion, a symmetric error between the transformed second co-located area and the first co-located area, to determine an error value for the first symmetric relationship.

The first symmetrical relationship is any one of the at least one symmetrical relationship.

In some embodiments, the second determination unit 3201 is further configured to: determine a first adjacent area corresponding to the current block; determine a reference block according to the target BV parameter, and determine a second adjacent area corresponding to the reference block; perform, according to the first adjacent area and the second adjacent area, error calculation for at least one symmetric relationship, to obtain at least one error value for the at least one symmetric relationship; and determine the target symmetric relationship from the at least one symmetric relationship according to the at least one error value for the at least one symmetric relationship.

In some embodiments, the second determination unit 3201 is further configured to: perform transformation about a first symmetric relationship on the second adjacent area, to determine a transformed second adjacent area; and calculate, according to a preset error criterion, a symmetric error between the transformed second adjacent area and the first adjacent area, to determine an error value for the first symmetric relationship.

The first symmetrical relationship is any one of the at least one symmetrical relationship.

In some embodiments, the at least one symmetric relationship includes at least one of no symmetric relationship, a vertical symmetric relationship, or a horizontal symmetric relationship.

In some embodiments, the second determination unit 3201 is further configured to select a minimum error value from the at least one error value for the at least one symmetric relationship, and take a symmetric relationship corresponding to the minimum error value as the target symmetric relationship.

In some embodiments, the second determination unit 3201 is further configured to store the target symmetric relationship in a preset buffer.

In some embodiments, the preset error criterion includes at least one of a SAD, a SATD, a SSE, a MAD, a MAE, a MSE, or a RDO.

In some embodiments, the second determination unit 3201 is further configured to acquire a target symmetric relationship of the first color component block from a preset buffer, to determine the target symmetric relationship. The target symmetric relationship is used to indicate a symmetric relationship between a first co-located area where the first color component block is located and a second co-located area indicated by the target BV parameter.

In some embodiments, the second prediction unit 3202 is further configured to: determine an offset position of the current block according to the target BV parameter and position information of the current block; perform block copy according to the offset position of the current block, to obtain a first prediction block; and determine the predicted value of the second color component of the current block according to the first prediction block.

In some embodiments, the second prediction unit 3202 is further configured to perform a correction operation on the first prediction block, to determine the predicted value of the second color component of the current block.

In some embodiments, the second determination unit 3201 is further configured to: decode a bitstream to determine a residual value of the second color component of the current block; determine an initial reconstructed value of the second color component of the current block according to the predicted value of the second color component of the current block and the residual value of the second color component of the current block; and transform, according to the target symmetric relationship, the initial reconstructed value, to determine the reconstructed value of the second color component of the current block.

In some embodiments, the second determination unit 3201 is further configured to: transform, according to the target symmetric relationship, the predicted value of the second color component of the current block, to determine a transformed predicted value of the second color component of the current block; decode a bitstream to determine a residual value of the second color component of the current block; and determine the reconstructed value of the second color component of the current block according to the transformed predicted value of the second color component of the current block and the residual value of the second color component of the current block.

In some embodiments, the second determination unit 3201 is further configured to: decode a bitstream to determine a target prediction mode for the current block; and when the target prediction mode indicates that the second color component of the current block is allowed to use a DBV mode, perform the operation of determining the target BV parameter of the current block.

In some embodiments, the second determination unit 3201 is further configured to: decode the bitstream to determine a value of identification information of a first syntax element; if the value of identification information of the first syntax element is a first value, determine that the target prediction mode for the current block is the DBV mode; if the value of identification information of the first syntax element is a second value, determine that the target prediction mode for the current block is another prediction mode other than the DBV mode.

In some embodiments, the second determination unit 3201 is further configured to: determine a first co-located area corresponding to the current block; and if any position in the first co-located area has BV information, determine that the second color component of the current block is allowed to use the DBV mode.

In some embodiments, the second determination unit 3201 is further configured to decode a bitstream to determine the target BV parameter of the current block.

In some embodiments, the second determination unit 3201 is further configured to decode a bitstream to determine the target symmetric relationship.

In some embodiments, the second determination unit 3201 is further configured to: perform sub-block division on the current block, to obtain at least one sub-block; and take the sub-block as the current block and perform operations of the decoding method shown in FIG. 6, to determine the reconstructed value of the second color component of the sub-block.

In another specific implementation, the second determination unit 3201 is configured to: determine a first co-located area corresponding to a current block; divide the first co-located area, to obtain at least one first color component sub-block; and determine at least one second color component sub-block and prediction information of the at least one second color component sub-block according to the at least one first color component sub-block.

The second prediction unit 3202 is configured to determine a predicted value of a second color component of the current block according to the prediction information of the at least one second color component sub-block.

In some embodiments, the second determination unit 3201 is further configured to: determine position information of the current block and size information of the current block; scale, according to a preset sampling format, the position information of the current block, to obtain position information of a co-located area corresponding to the current block; scale, according to the preset sampling format, the size information of the current block, to obtain size information of the co-located area corresponding to the current block; and determine the first co-located area corresponding to the current block according to the position information of the co-located area and the size information of the co-located area corresponding to the current block.

In some embodiments, the second determination unit 3201 is further configured to: determine a horizontal sampling factor and a vertical sampling factor according to a preset sampling format; and adjust position information of the first color component sub-block according to the horizontal sampling factor and the vertical sampling factor, to determine the second color component sub-block.

In some embodiments, the second determination unit 3201 is further configured to: adjust a horizontal coordinate of the first color component sub-block according to the horizontal sampling factor, to obtain a horizontal coordinate of the second color component sub-block; adjust a vertical coordinate of the first color component sub-block according to the vertical sampling factor, to obtain a vertical coordinate of the second color component sub-block; and determine the second color component sub-block according to the horizontal coordinate of the second color component sub-block and the vertical coordinate of the second color component sub-block.

In some embodiments, the second determination unit 3201 is further configured to: determine prediction information of the at least one first color component sub-block; and determine the prediction information of the at least one second color component sub-block according to the prediction information of the at least one first color component sub-block.

In some embodiments, the second determination unit 3201 is further configured to: when the prediction information of the first color component sub-block includes BV information, determine a first BV parameter of the first color component sub-block; adjust the first BV parameter of the first color component sub-block, to determine a second BV parameter of the second color component sub-block; and determine the prediction information of the second color component sub-block according to the second BV parameter of the second color component sub-block.

In some embodiments, the second determination unit 3201 is further configured to: when the prediction information of the first color component sub-block does not include the BV information, acquire a preset prediction mode, and determine the preset prediction mode as the prediction information of the second color component sub-block; or, when the prediction information of the first color component sub-block does not include the BV information, determine additional information of the second color component sub-block, and determine the prediction information of the second color component sub-block according to the additional information.

In some embodiments, the second determination unit 3201 is further configured to: scale, according to a preset sampling format, the first BV parameter of the first color component sub-block, to determine the second BV parameter of the second color component sub-block.

In some embodiments, the second determination unit 3201 is further configured to: scale, according to a preset sampling format, the first BV parameter of the first color component sub-block, to obtain an initial BV parameter of the second color component sub-block; and correct the initial BV parameter of the second color component sub-block, to determine the second BV parameter of the second color component sub-block.

In some embodiments, the second determination unit 3201 is further configured to: after determining the second BV parameter of the second color component sub-block, determine whether the second BV parameter meets an availability condition; and when the second BV parameter meets the availability condition, determine the second BV parameter as the prediction information of the second color component sub-block.

In some embodiments, whether the second BV parameter meets the availability condition is determined according to at least the following:
an offset position indicated according to position information of the current block and the second BV parameter does not exceed an picture boundary;
the offset position indicated according to the position information of the current block and the second BV parameter does not cover the current block;
the offset position indicated according to the position information of the current block and the second BV parameter does not exceed a preset available area; and
the offset position indicated according to the position information of the current block and the second BV parameter has been reconstructed.

In some embodiments, whether the second BV parameter meets the availability condition is determined according to at least the following:
an offset position indicated according to position information of the second color component sub-block and the second BV parameter does not exceed an picture boundary;
the offset position indicated according to the position information of the second color component sub-block and the second BV parameter does not cover the current block;
the offset position indicated according to the position information of the second color component sub-block and the second BV parameter does not exceed a preset available area; and
the offset position indicated according to the position information of the second color component sub-block and the second BV parameter has been reconstructed.

In some embodiments, the second determination unit 3201 is further configured to: when the second BV parameter does not meet the availability condition, determine additional information of the second color component sub-block; and determine the prediction information of the second color component sub-block according to the additional information.

In some embodiments, the second determination unit 3201 is further configured to: after determining the additional information of the second color component sub-block, determine whether the additional information is a BV parameter; and if the additional information is the BV parameter, determine the BV parameter as the prediction information of the second color component sub-block.

In some embodiments, the second determination unit 3201 is further configured to: if the additional information is a non-BV parameter, acquire a preset prediction mode, and determine the preset prediction mode as the prediction information of the second color component sub-block.

In some embodiments, the second determination unit 3201 is further configured to: determine a first color component block for the current block; when a prediction mode for the first color component block meets a first condition, determine a first BV parameter of the first color component block; adjust the first BV parameter of the first color component block, to determine the second BV parameter of the second color component sub-block; and determine the additional information of the second color component sub-block according to the second BV parameter.

In some embodiments, the second determination unit 3201 is further configured to: after determining the second BV parameter of the second color component sub-block, determine whether the second BV parameter meets the availability condition; and when the second BV parameter meets the availability condition, determine the second BV parameter as the additional information of the second color component sub-block.

In some embodiments, the second determination unit 3201 is further configured to store the additional information of the second color component sub-block.

In some embodiments, the second determination unit 3201 is further configured to: when the prediction mode for the first color component block does not meet the first condition, not perform an operation of decoding a bitstream to determine a target prediction mode for the current block.

In some embodiments, the second prediction unit 3202 is further configured to: predict, according to the prediction information of the at least one second color component sub-block, the at least one second color component sub-block respectively, to determine a predicted value of the at least one second color component sub-block; and determine the predicted value of the second color component of the current block according to the predicted value of the at least one second color component sub-block.

In some embodiments, the second prediction unit 3202 is further configured to: determine a second BV parameter of the second color component sub-block according to the prediction information of the second color component sub-block; determine an offset position of the second color component sub-block according to the second BV parameter and position information of the second color component sub-block; perform block copy according to the offset position of the second color component sub-block, to obtain a first prediction sub-block; and determine the predicted value of the second color component sub-block according to the first prediction sub-block.

In some embodiments, the second prediction unit 3202 is further configured to: perform a correction operation on the first prediction sub-block, to determine the predicted value of the second color component sub-block.

In some embodiments, the second determination unit 3201 is further configured to: parse a bitstream to determine a residual value of the at least one second color component sub-block; and determine a reconstructed value of the at least one second color component sub-block according to the predicted value of the at least one second color component sub-block and the residual value of the at least one second color component sub-block.

In some embodiments, the second determination unit 3201 is further configured to: determine a target symmetric relationship; determine an initial reconstructed value of the second color component sub-block according to the predicted value of the second color component sub-block and the residual value of the second color component sub-block; and transform, according to the target symmetric relationship, the initial reconstructed value, to determine the reconstructed value of the second color component sub-block.

In some embodiments, the second determination unit 3201 is further configured to: determine a target symmetric relationship; transform, according to the target symmetric relationship, the predicted value of the second color component sub-block, to determine a transformed predicted value of the second color component sub-block; and determine the reconstructed value of the second color component sub-block according to the transformed predicted value of the second color component sub-block and the residual value of the second color component sub-block.

It may be understood that in the embodiments of the disclosure, the “unit” may be a part of a circuit, a part of a processor, a part of a program or software, etc. Of course, the “unit” may be a module, or may be non-modular. Furthermore, various components in the embodiments may be integrated into a processing unit, or each unit may physically exist separately, or two or more than two units may be integrated into a unit. The above integrated unit may be implemented in form of hardware, or may be implemented in form of a software functional module.

If the integrated unit is implemented in form of the software functional module and not sold or used as an independent product, it may be stored in a computer-readable storage medium. Based on such an understanding, the embodiments provide a computer-readable storage medium, the computer-readable storage medium is applied to the decoder 320, and stores a computer program. When the computer program is executed by a second processor, the computer program implements the method described in any one of the above embodiments.

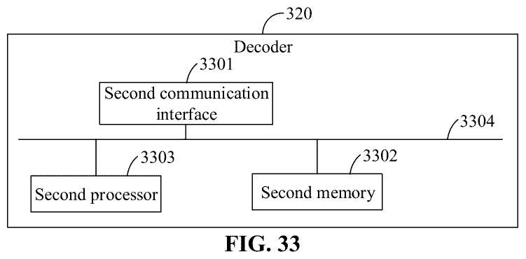

Based on composition of the decoder 320 and the computer-readable storage medium, with reference to FIG. 33, a schematic diagram of specific hardware structures of the decoder 320 according to embodiments of the disclosure is shown. As shown in FIG. 33, the decoder 320 may include a second communication interface 3301, a second memory 3302, and a second processor 3303. Various components are coupled together through a second bus system 3304. It may be understood that the second bus system 3304 is configured to implement connection and communication between these components. The second bus system 3304 includes a data bus, a power bus, a control bus and a status signal bus. However, for the sake of clear explanation, various buses are marked as the second bus system 3304 in FIG. 33.

The second communication interface 3301 is configured to receive and send signals in a process of receiving or sending information from or to other external network elements.

The second memory 3302 is configured to store a computer program executable on the second processor 3303.

The second processor 3303 is configured to execute the computer program to perform operations of:
determining a first color component block for a current block;
when a prediction mode for the first color component block meets a first condition, determining a target BV parameter of the current block, and determining a target symmetric relationship according to the target BV parameter of the current block;
predicting, according to the target BV parameter, a second color component of the current block, to determine a predicted value of the second color component of the current block; and
determining a reconstructed value of the second color component of the current block according to the predicted value of the second color component of the current block and the target symmetric relationship.

Or, the second processor 3303 is configured to execute the computer program to perform operations of:
determining a first co-located area corresponding to a current block;
dividing the first co-located area, to obtain at least one first color component sub-block;
determining at least one second color component sub-block and prediction information of the at least one second color component sub-block according to the at least one first color component sub-block; and
determining a predicted value of a second color component of the current block according to the prediction information of the at least one second color component sub-block.

Optionally, as another embodiment, the second processor 3303 is further configured to execute the computer program to perform the method described in any one of the above embodiments.

It may be understood that hardware functions of the second memory 3302 are similar to those of the first memory 2102, and hardware functions of the second processor 3303 are similar to those of the first processor 2103, which are not described in detail here.

The embodiments provide a decoder, in which available information such as reconstructed luma, BV or the like are fully considered, and chroma is predicted according to these information, which improves singleness of chroma prediction. Further, the symmetric relationship is considered and the predicted value is processed in more detail. This not only improves accuracy of the chroma prediction and saves the bit rate is saved, but also improves coding and decoding performance and improves coding efficiency effectively. Furthermore, by dividing the current block into sub-areas for prediction, multiple options can be adaptively provided according to different contents and luma prediction information, such that DBV prediction is more effective, thereby further improving the coding efficiency.

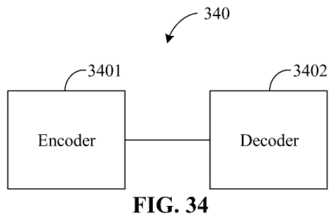

In yet another implementation of the disclosure, with reference to FIG. 34, a schematic diagram of compositional structures of an encoding and decoding system according to embodiments of the disclosure is shown. As shown in FIG. 34, the coding and decoding system 340 may include an encoder 3401 and a decoder 3402.

In the embodiments of the disclosure, the encoder 3401 may be the encoder described in any one of the above embodiments, and the decoder 3402 may be the decoder described in any one of the above embodiments.

It should be noted that in the disclosure, terms “including”, “include” or any other variants thereof are intended to encompass a non-exclusive inclusion, such that a process, method, article or apparatus including a series of elements includes not only those elements, but also other elements which are not explicitly listed, or elements inherent to such process, method, article or apparatus. Without further limitation, an element defined by a statement “including a . . . ” does not preclude presence of additional identical elements in a process, method, article or apparatus including the element.

The above serial numbers of the embodiments of the disclosure are only for the purpose of descriptions, and do not represent advantages and disadvantages of the embodiments.

The methods disclosed in several method embodiments according to the disclosure may be arbitrarily combined without conflict, to obtain new method embodiments.

The features disclosed in several product embodiments according to the disclosure may be arbitrarily combined without conflict, to obtain new product embodiments.

The features disclosed in several method or device embodiments according to the disclosure may be arbitrarily combined without conflict, to obtain new method or device embodiments.

The above descriptions are only specific implementations of the disclosure, however, the scope of protection of the disclosure is not limited thereto. Variation or replacement easily conceived by any technician familiar with this technical field within the technical scope disclosed in the disclosure, should fall within the scope of protection of the disclosure. Therefore, the scope of protection of the disclosure should be subject to the scope of protection of the claims.

### INDUSTRIAL APPLICABILITY

In the embodiments of the disclosure, at both an encoding side and a decoding side, a first color component block for a current block is determined first; then, when a prediction mode for the first color component block meets a first condition, a target BV parameter of the current block is determined, and a target symmetric relationship is determined according to the target BV parameter of the current block; then, a second color component of the current block is predicted according to the target BV parameter, to determine a predicted value of the second color component of the current block. In this way, at the encoding side, a residual value of the second color component of the current block may be determined according to the predicted value of the second color component of the current block and the target symmetric relationship. Also, at the decoding side, a reconstructed value of the second color component of the current block is determined according to the predicted value of the second color component of the current block and the target symmetric relationship. That is, in the disclosure, available information such as reconstructed luma, BV or the like are fully considered, and chroma is predicted according to these information, which improves singleness of chroma prediction. Further, the symmetric relationship is considered, and the predicted value is processed in more detail. This not only improves accuracy of the chroma prediction and saves the bit rate, but also improves coding and decoding performance and improves coding efficiency effectively. Furthermore, at both the encoding side and the decoding side, a first co-located area corresponding to a current block may also be determined; the first co-located area is divided, to obtain at least one first color component sub-block; at least one second color component sub-block and prediction information of the at least one second color component sub-block are determined according to the at least one first color component sub-block; and a predicted value of a second color component of the current block is determined according to the prediction information of the at least one second color component sub-block. In this way, by dividing the current block into sub-areas for prediction, multiple options can be adaptively provided according to different contents and luma prediction information, making DBV prediction more effective, and further improving the coding efficiency.

1. A decoding method, applied to a decoder, comprising:
determining a first color component block for a current block;
when a prediction mode for the first color component block meets a first condition, determining a target Block Vector (BV) parameter of the current block, and determining a target symmetric relationship according to the target BV parameter of the current block;
predicting, according to the target BV parameter, a second color component of the current block, to determine a predicted value of the second color component of the current block; and
determining a reconstructed value of the second color component of the current block according to the predicted value of the second color component of the current block and the target symmetric relationship.

2. The method of claim 1, wherein the prediction mode for the first color component block meeting the first condition comprises: determining that the prediction mode for the first color component block is a first prediction mode with BV information.

3. The method of claim 1, wherein determining the first color component block for the current block comprises:
determining a first co-located area corresponding to the current block; and
determining, from a plurality of blocks divided from the first co-located area, the first color component block for the current block.

4. The method of claim 3, wherein determining the first color component block for the current block comprises:
selecting a target block from the plurality of blocks divided from the first co-located area, and taking the target block as the first color component block for the current block.

5. The method of claim 3, wherein determining the first color component block for the current block comprises:
determining position information of the current block;
scaling, according to a preset sampling format, the position information of the current block, to obtain position information of a co-located area corresponding to the current block; and
determining target position information according to the position information of the co-located area, and taking a target block comprising the target position information as the first color component block for the current block.

6. The method of claim 5, wherein determining the target position information according to the position information of the co-located area comprises:
calculating a center position according to the position information of the co-located area, and taking information of an obtained center position as the target position information; or
calculating a top-left position according to the position information of the co-located area, and taking information of an obtained top-left position as the target position information; or
calculating a lower-right position according to the position information of the co-located area, and taking information of an obtained lower-right position as the target position information.

7. The method of claim 3, wherein determining the first color component block for the current block comprises:
determining, from the plurality of blocks divided from the first co-located area, at least one candidate block at a preset position; and
determining, from the at least one candidate block, a target candidate block meeting a preset determination condition, and taking the target candidate block as the first color component block for the current block.

8. The method of claim 1, wherein determining the target BV parameter of the current block comprises:
determining a first BV parameter of the first color component block; and
adjusting the first BV parameter of the first color component block, to determine the target BV parameter of the current block.

9. The method of claim 8, wherein adjusting the first BV parameter of the first color component block, to determine the target BV parameter of the current block comprises:
scaling, according to a preset sampling format, the first BV parameter of the first color component block, to determine the target BV parameter of the current block.

10. The method of claim 1, further comprising:
after determining the target BV parameter of the current block, determining whether the target BV parameter meets an availability condition; and
when the target BV parameter meets the availability condition, performing the operation of determining the target symmetric relationship of the current block according to the target BV parameter of the current block.

11. The method of claim 10, wherein whether the target BV parameter meets the availability condition is determined according to at least the following:
an offset position indicated according to position information of the current block and the target BV parameter does not exceed a picture boundary;
the offset position indicated according to the position information of the current block and the target BV parameter does not cover the current block;
the offset position indicated according to the position information of the current block and the target BV parameter does not exceed a preset available area; and
the offset position indicated according to the position information of the current block and the target BV parameter has been reconstructed.

12. The method of claim 1, wherein determining the target symmetric relationship according to the target BV parameter of the current block comprises:
acquiring a target symmetric relationship of the first color component block from a preset buffer, to determine the target symmetric relationship, wherein the target symmetric relationship is used to indicate a symmetric relationship between a first co-located area where the first color component block is located and a second co-located area indicated by the target BV parameter.

13. The method of claim 1, wherein predicting, according to the target BV parameter, the second color component of the current block, to determine the predicted value of the second color component of the current block comprises:
determining an offset position of the current block according to the target BV parameter and position information of the current block;
performing block copy according to the offset position of the current block, to obtain a first prediction block; and
determining the predicted value of the second color component of the current block according to the first prediction block.

14. The method of claim 1, wherein determining the reconstructed value of the second color component of the current block according to the predicted value of the second color component of the current block and the target symmetric relationship comprises:
decoding a bitstream to determine a residual value of the second color component of the current block;
determining an initial reconstructed value of the second color component of the current block according to the predicted value of the second color component of the current block and the residual value of the second color component of the current block; and
transforming, according to the target symmetric relationship, the initial reconstructed value, to determine the reconstructed value of the second color component of the current block.

15. The method of claim 1, further comprising:
decoding a bitstream to determine a target prediction mode for the current block; and
when the target prediction mode indicates that the second color component of the current block is allowed to use a Direct Block Vector (DBV) mode, performing the operation of determining the target BV parameter of the current block.

16. The method of claim 15, wherein decoding the bitstream to determine the target prediction mode for the current block comprising:
decoding the bitstream to determine a value of identification information of a first syntax element;
if the value of identification information of the first syntax element is a first value, determining that the target prediction mode for the current block is the DBV mode.

17. The method of claim 15, wherein decoding the bitstream to determine the target prediction mode for the current block comprising:
decoding the bitstream to determine a value of identification information of a first syntax element;
if the value of identification information of the first syntax element is a second value, determining that the target prediction mode for the current block is another prediction mode other than the DBV mode.

18. The method of claim 15, further comprising:
determining a first co-located area corresponding to the current block; and
if the first co-located area has BV information, determining that the second color component of the current block is allowed to use the DBV mode.

19. An encoding method, applied to an encoder, comprising:
determining a first color component block for a current block;
when a prediction mode for the first color component block meets a first condition, determining a target Block Vector (BV) parameter of the current block, and determining a target symmetric relationship according to the target BV parameter of the current block;
predicting, according to the target BV parameter, a second color component of the current block, to determine a predicted value of the second color component of the current block; and
determining a residual value of the second color component of the current block according to the predicted value of the second color component of the current block and the target symmetric relationship.

20. A non-transitory computer-readable storage medium, storing a bitstream, the bitstream is generated by an encoder performing an encoding method, the encoding method comprising the following operations:
determining a first color component block for a current block;
when a prediction mode for the first color component block meets a first condition, determining a target Block Vector (BV) parameter of the current block, and determining a target symmetric relationship according to the target BV parameter of the current block;
predicting, according to the target BV parameter, a second color component of the current block, to determine a predicted value of the second color component of the current block; and
determining a residual value of the second color component of the current block according to the predicted value of the second color component of the current block and the target symmetric relationship.
